(19) United States
(12) Patent Application Publication
(10) Pub. No.: US 2024/0253033 A1
(43) Pub. Date: Aug. 1, 2024

(54) MICROFLUIDIC DETECTION SYSTEM WITH ADJUSTABLE FLOW CONTROL

(71) Applicant: THE ROYAL INSTITUTION FOR THE ADVANCEMENT OF LEARNING/MCGILL UNIVERSITY, Montréal (CA)

(72) Inventors: Sara MAHSHID, Mont Royal (CA); Mahsa JALALI, Montréal (CA); Tamer ABDELWAHAB, Montréal (CA); Sripadh Guptha YEDIRE, Montréal (CA); Seyed Imman Isaac HOSSEINI, Montréal (CA)

(21) Appl. No.: 18/505,601

(22) Filed: Nov. 9, 2023

Related U.S. Application Data
(60) Provisional application No. 63/382,904, filed on Nov. 9, 2022.

(51) Int. Cl. B01L 3/00

(52) U.S. Cl. CPC B01L 3/502715; B01L 3/50273; B01L 2200/027; B01L 2200/0647; B01L 2200/16; B01L 2300/041; B01L 2300/0663; B01L 2300/0681; B01L 2300/1805; B01L 2400/0487

(57) ABSTRACT

There is provided a detection system for detecting an analyte in a sample. The detection system contains a microfluidic chip which has an inlet adapted to receive the sample, an incubation chamber, a sensing chamber, and an outlet. The detection system has a suction membrane in fluid communication with the outlet of the microfluidic chip, and an actuator for applying or relieving pressure from the suction membrane which modifies the air pressure in the microfluidic chip and drives a flow of the sample in the microfluidic chip. Finally, a detection apparatus is also provided for measuring a signal of the analyte in the sensing chamber.

### CROSS-REFERENCE TO A RELATED APPLICATION

This disclosure claims the priority from U.S. provisional application No. 63/382,904 filed Nov. 9, 2022 and incorporated herein by reference in its entirety.

### SEQUENCE LISTING STATEMENT

This disclosure incorporates by reference the sequence listing XML file submitted via the USPTO patent electronic filing system titled “2023-11-09 APP—Sequence Listing.XML” which was created on Nov. 9, 2023 and has a size of 38.4 KB.

### TECHNICAL FIELD

This disclosure relates to the field of microfluidics and detection systems.

### BACKGROUND OF THE ART

Optical signal transduction techniques (e.g. colorimetric, light, spectroscopy) and other detection techniques such as electrical sensing, have been extensively applied for the detection of biological analytes. The developments of point of care devices that utilize these techniques is on the rise. In the case of optical techniques, this can majorly be attributed to key features of colorimetric readouts, such as high sensitivity, ease of analysis and interpretation, minimal training requirements, and affordability. However, one of the major drawbacks with colorimetric or electric readout systems is the challenge with the interpretation of results, the major reason being variability in the sample (e.g. varying saliva compositions), and the requirements for sophisticated instrumentation. To offset these drawbacks, recently, there have been increasing efforts to develop portable setups for interpreting the readout with smartphones and open-source technologies at the core of automation and data transmission units. Implementing smartphone and open-source technologies, can allow miniaturization and would ease the process of data collection and analysis. In the case of colorimetric readouts, most of the previously reported imaging setups were designed for assays where the color change is driven by the assay and imaging setups act as a proxy to the human eye to either reduce user-to-user variability, facilitate quantification and/or enable automation. Improvements in portable detection platforms (e.g. colorimetric, electric and the like) are therefore desired, particularly with respect to user friendliness, user-to-user variability, assay speed, signal quantification and automation.

### SUMMARY

In one aspect, there is provided a detection system for detecting an analyte in a sample, comprising:
a microfluidic chip comprising: an inlet adapted to receive the sample, an incubation chamber having an incubation chamber inlet fluidly connected to the inlet downstream thereof, to incubate the analyte in the sample, a filter barrier fluidly connected to the incubation chamber, downstream of the incubation chamber inlet, a sensing chamber fluidly connected to the incubation chamber, downstream of the filter barrier, and an outlet fluidly connected to the sensing chamber downstream thereof;
a suction membrane in fluid communication with the outlet of the microfluidic chip;
an actuator for applying or relieving pressure from the suction membrane which modifies the air pressure in the microfluidic chip and drives a flow of the sample in the microfluidic chip; and
a detection apparatus for measuring a signal of the analyte in the sensing chamber.

In some embodiments, the detection apparatus is a spectroscopy detection apparatus or an electrical detection apparatus.

In some embodiments, the microfluidic chip further comprises a filter barrier fluidly connected to the incubation chamber, downstream of the incubation chamber inlet. In some embodiments, the detection apparatus is a light detection apparatus and comprises a light source for providing an epi illumination on the sensing chamber of the microfluidic chip, a condensing lens for condensing light from the sensing chamber of the microfluidic chip, and an image sensor receiving the light condensed by the condensing lens, the image sensor adapted to register the light as an electronic signal and to send said electronic signal to a processing device. In some embodiments, the microfluidic chip is part of a microfluidic cartridge comprising an inlet apparatus connected to the microfluidic chip, and covering the inlet, the incubation chamber and the filter barrier of the microfluidic chip, the inlet apparatus comprising: a receptacle in fluid communication with the inlet of the microfluidic chip, the receptacle being adapted to receive the sample, a storage chamber having a rupturable membrane and housing a colorimetric sensor, the storage chamber is in fluid communication with the microfluidic chip upstream of the sensing chamber and the filter barrier of the microfluidic chip, an outlet apparatus connected to the microfluidic chip and covering the outlet, the outlet apparatus is in fluid communication with the outlet of the microfluidic chip, the outlet apparatus comprising: the actuator, wherein the actuator is a screw adapted to be released in order to drive the flow of the sample to the incubation chamber, a second suction membrane adapted to be released in order to flow the sample past the filter barrier and to drive a flow of the colorimetric sensor released from the storage chamber. In some embodiments, the outlet apparatus comprises a second crew, and wherein the screw is adapted to be released in order to drive the flow of the sample to the incubation chamber, and the second screw is adapted to be released in order to flow the sample past the filter barrier and to drive the flow of the colorimetric sensor released from the storage chamber. In some embodiments, a closing lid is provided for closing the receptacle of the inlet apparatus. In some embodiments, a second storage chamber is provided in the inlet apparatus, the second storage chamber housing lysis reagents and having a rupturable membrane. In some embodiments, a second piercing actuator is provided in the inlet apparatus to pierce the rupturable membrane of the second storage chamber, and the second piercing actuator is connected to the actuating motor. In some embodiments, a heating actuator is provided in the inlet apparatus comprising a heating element for a lysis of the sample, and the heating actuator is connected to the actuating motor.

In some embodiments the detection system further comprises an imaging box, wherein the imaging box comprises the suction membrane, the detection apparatus and the actuator, and wherein the suction membrane is positioned below a support which is adapted to releasably bind to the microfluidic chip, and wherein the detection apparatus is a light detection apparatus.

In some embodiments the flow of the sample is bidirectional.

In some embodiments the detection apparatus is a light detection apparatus and wherein the sensing chamber comprises a plasmonic nanosurface, the plasmonic nanosurface including nanostructures protruding from the plasmonic nanosurface, the nanostructures having a size that is smaller than that of the diffraction limit of light, the nanostructures having a metallic layer that is plasmon-supported on top of a back reflector layer.

In some embodiments the detection apparatus is an electrical detection apparatus and wherein the sensing chamber comprises a dimeric DNA aptamer gold nanostructure.

In some embodiments the microfluidic chip comprises a plurality of the sensing chamber and multiple parallel channels each leading to one of the sensing chambers.

In some embodiments the detection system further comprises a motorized platform connected to the detection apparatus for moving the detection apparatus between the plurality of the sensing chamber.

In some embodiments the analyte is selected from nucleic acid, microorganism, a cell of a multicellular organism, or a protein.

In some embodiments the detection system further comprises a heating plate.

In some embodiments the actuating motor is connected to a controller and the controller is coupled to the processing device.

In some embodiments the processing device is selected from a smart phone, a tablet, or a computer.

Many further features and combinations thereof concerning the present improvements will appear to those skilled in the art following a reading of the instant disclosure.

### DESCRIPTION OF THE DRAWINGS

FIG. 1A is a schematic of a colorimetric detection system according to an embodiment of the present disclosure.

FIG. 1B is a schematic showing a top view of a microfluidic chip according to a first embodiment.

FIG. 1C is a schematic showing a top view of a microfluidic chip according to a second embodiment.

FIG. 1D is a schematic of the processing device according to an embodiment of the present disclosure.

FIG. 1E is a schematic of a suction membrane actuated by a screw at the outlet of the microfluidic chip according to an embodiment of the present disclosure.

FIG. 1F is a schematic of a suction membrane position on top of the microfluidic chip according to an embodiment of the present disclosure.

FIG. 1G is a schematic of a suction membrane position below the microfluidic chip according to an embodiment of the present disclosure.

FIG. 1H is a schematic of a suction membrane showing the adhesion of the support of the suction membrane to the microfluidic chip according to an embodiment of the present disclosure.

FIG. 1I is a schematic of a schematic of a suction membrane showing the magnetic adhesion of the support of the suction membrane to the microfluidic chip according to an embodiment of the present disclosure.

FIG. 1J is a schematic cross section showing the filter barrier of the microfluidic chip according to an embodiment of the present disclosure.

FIG. 2A is a schematic of a microfluidic cartridge according to an embodiment of the present disclosure.

FIG. 2B is a schematic of a colorimetric detection system according to an embodiment of the present disclosure.

FIG. 2C is a schematic of the microfluidic cartridge of FIG. 2A positioned in the colorimetric detection system of FIG. 2B.

FIG. 2D is a schematic showing the actuators of the colorimetric detection system according to an embodiment of the present disclosure.

FIG. 3A is a schematic showing the stepwise fabrication of a microfluidic cartridge.

FIG. 3B is a schematic exploded view of the microfluidic cartridge fabricated as per FIG. 3A.

FIG. 3C is a schematic top view of the microfluidic cartridge fabricated as per FIG. 3A.

FIG. 4 is a schematic showing the fabrication of suction membranes.

FIG. 5A is a graph showing a simulation of the surface pressure distribution across the channels for the distribution of lysed sample.

FIG. 5B is a graph showing a simulation of the velocity distribution across the cross-section of the three channels in FIG. 5A (labeled 1 to 3).

FIG. 5C is a graph showing a simulation of the serpentine channel that aids in the mixing of the lysed sample with the reagents to ensure perfect mixing based on channel length.

FIG. 5D is a graph showing the simulated velocity in a cross section of the serpentine channel width (1 LAMP channel and 2 lysed sample channel).

FIG. 6A is a schematic depicting various parameters of the suction membrane employed for the theoretical analysis of the suction membrane behaviour.

FIG. 6B is a graph showing the theoretical volume of suction membrane correlated to the empirically observed volume pumped with the 3D printed screw-nut system.

FIG. 6C is a side view photograph of the 3D printed module employed for the characterization of empirical volume of the suction membranes.

FIG. 6D is a top view photograph of the 3D printed module employed for the characterization of empirical volume of the suction membranes.

FIG. 6E is a graph characterizing the volume of fluid pumped in relation with the angle of the screw turned, for different sizes of suction membranes.

FIG. 6F is a photograph of the microfluidics setup employed for demonstration of fluid manipulation (disassembled).

FIG. 6G is a photograph of the microfluidics setup employed for demonstration of fluid manipulation (assembled).

FIG. 6H is a schematic of photographs demonstrating the volumetric fluid metering based on the angle of the screw rotated in either clockwise (CW) or counter clockwise (CCW) directions.

FIG. 6I is a graph showing the characterization of minimum volume of fluid that can be manipulated for a set degree of screw rotation (300 degrees).

FIG. 6J is a graph showing the volume suctioned in function of the angle rotated.

FIG. 6K is a photograph of the microfluidic cartridge when the sample is loaded.

FIG. 6L is a schematic of the microfluidic cartridge when the sample is loaded.

FIG. 6M is a photograph of the microfluidic cartridge when the first suction membrane is released.

FIG. 6N is a schematic of the microfluidic cartridge when the first suction membrane is released.

FIG. 6O is a photograph of the microfluidic cartridge when the second suction membrane is released.

FIG. 6P is a schematic of the microfluidic cartridge when the second suction membrane is released.

FIG. 7 is a schematic showing the steps from the sample collection to the imaging collection.

FIG. 8A is a graph showing the manual force required to break the membrane at different thicknesses.

FIG. 8B is a graph showing the normal force exerted by the screw-nut system characterized in multiple trails.

FIG. 8C is a computer-aided design (CAD) model depicting the 3D printed nut-screw setup employed for mechanical actuation of the suction membrane.

FIG. 9A is a schematic of a light detection apparatus according to an embodiment of the present disclosure.

FIG. 9B is an exploded view schematic of the light detection apparatus of FIG. 9A.

FIG. 9C shows the characterization of the imaging setup for obtaining the field of view (FoV) using a UASF 1951 target. The bars horizontal bars in Group 6 Element 3 are clearly depicted in the intensity plot. Based the standardized calculation, the resolution obtained for the system was 4.4 μm and a FoV of 298 μm in horizontal direction.

FIG. 9D is an exploded view of an illumination column according to an embodiment of the present disclosure.

FIG. 9E is a cross section view of the illumination column of FIG. 9D.

FIG. 9F is a graph showing the relative intensity distribution in function of the pixels.

FIG. 9G is a graph showing the relative intensity distribution in function of the pixels for a light emitting diode (LED) with no illumination modification.

FIG. 9H is a graph showing the relative intensity distribution in function of the pixels for a LED with a controlled epi-illumination.

FIG. 9I is a CAD depiction of the detection platform placed at the focal plane of the objective and illuminated with the illumination column.

FIG. 10A is a UV-Vis spectroscopy analysis of the detection platform.

FIG. 10B is a graph showing the spectral power distribution of LumilLEDs™ at lighting ratings.

FIG. 10C is a photograph of the benchtop setup employed for visual characterization, in which the collimated light beam is irradiated onto a blue background and subsequently images were captured with a phone camera.

FIG. 10D shows the illumination of a simple LED with no lens setup.

FIG. 10E shows the illumination of a LED-diffusing lens setup.

FIG. 10F shows the illumination of a portable reflected-light imaging setup with controlled epi-illumination (PRICE) illumination column LED.

FIG. 11A is a flow diagram depicting the operation of the microfluidic sample-to-answer pathogen detection platform.

FIG. 11B is a schematic of the electronic CAD layout of the electronic components.

FIG. 12A is an infra-red (IR) image of the heating of a solder tip at 300° C.

FIG. 12B is an infra-red (IR) image of bringing into contact the solder tip of FIG. 12A to a metal insert.

FIG. 12C is an infra-red (IR) image showing the heating of the sample at 95° C. for 3 min.

FIG. 13A is a photograph showing the isometric view of the outer enclosure of the colorimetric detection device.

FIG. 13B is a photograph showing the inner assembly and the wiring setup inside the enclosure of FIG. 13A.

FIG. 13C is a photograph of the microfluidic cartridge with a coin for scale.

FIG. 13D is a photograph showing the insertion of the microfluidic cartridge into the cartridge holder.

FIG. 14 is a process flow of the operation of a mobile application.

FIG. 15A is a photograph of the microfluidic cartridge having received the sample.

FIG. 15B is a photograph of the microfluidic cartridge of FIG. 15A after releasing the first suction membrane.

FIG. 15C is a photograph of the microfluidic cartridge of FIG. 15A after releasing the second suction membrane.

FIG. 16A is a graph showing the variation of the parameter (G²/R*B) in function of time for the platform of the present disclosure.

FIG. 16B is a graph showing the variation of the parameter (G²/R*B) in function of time for a comparative platform with a microscope.

FIG. 16C is a graph of the light signal recorded with buffer or saliva.

FIG. 16D is a graph showing the correlation of the light signal to the logarithm of the viral particle concentration.

FIG. 17A is a schematic of an on-chip plasmonic chamber on the microfluidic cartridge comprising the light-sensitive plasmonic coated self-assembly nanoparticles.

FIG. 17B is a schematic illustration of higher electron emancipation from the plasmonic substrate to the fluidic chamber under illumination.

FIG. 17C is a graph showing the electrochemical validation of the RT-LAMP bioassay progression upon light-dependent generation of excess free electrons.

FIG. 17D is a graph showing the electrochemical impedance spectroscopy validation of the higher effect of electron injection under illumination in mitigation of the interface resistance with active LAMP assay.

FIG. 17E is a graph showing the cyclic voltammetry of the effective increase in the oxidation peak of the RT-LAMP/(amplification) assay reaction as a result of illumination dependant electron generation.

FIG. 17F is graph showing a controlled comparison of the oxidation peak current of RT-LAMP/(amplification) assay reaction in different body fluids.

FIG. 17G is a microscopy image acquired by tapping mode atomic force microscopy (AFM) performed to characterize the morphology of different plasmonic platforms of silicon pieces a self-assembled monolayer (SAM) of nanoparticles of 200 nm.

FIG. 17H is a microscopy image acquired by tapping mode atomic force microscopy (AFM) performed to characterize the morphology of different plasmonic platforms of silicon pieces a self-assembled monolayer (SAM) of nanoparticles of 400 nm.

FIG. 17I is a microscopy image acquired by tapping mode atomic force microscopy (AFM) performed to characterize the morphology of different plasmonic platforms of silicon pieces a self-assembled monolayer (SAM) of nanoparticles of 600 nm.

FIG. 17J is a microscopy image acquired by tapping mode atomic force microscopy (AFM) performed to characterize the morphology of different plasmonic platforms of silicon pieces a self-assembled monolayer (SAM) of nanoparticles of 750 nm.

FIG. 17K is heat map of the theoretical electro-magnetic field generation under white light illumination calculated via finite difference time domain (FDTD) from FIG. 17G.

FIG. 17L is heat map of the theoretical electro-magnetic field generation under white light illumination calculated via FDTD from FIG. 17H.

FIG. 17M is heat map of the theoretical electro-magnetic field generation under white light illumination calculated via FDTD from FIG. 17I.

FIG. 17N is heat map of the theoretical electro-magnetic field generation under white light illumination calculated via FDTD from FIG. 17J.

FIG. 17O is a schematic showing the chemical assay equilibrium shifts according to the excess of the electron at the reaction interface for RT-LAMP.

FIG. 17P is a graph showing the minute-time monitoring of the changes in the color of phenol red at the time of nucleic acid amplification on the plasmonic platforms with different nanoparticle diameters.

FIG. 17Q is a graph showing the quantified color-change gamut based on the defined color-driven analytics for platforms fabricated using different sizes of nanoparticles.

FIG. 17R is a graph showing optical UV-visible study of the white light absorption by the platform/media during the amplification for 60 minutes.

FIG. 18A is a color palette of the detected colorimetric readout for different concentrations of SARS-COV-2 (y-axis) versus time (x-axis).

FIG. 18B is a graph showing the QolorEX_{LAMP} signal readout vs time for different viral loads.

FIG. 18C is a schematic of SARS-COV-2 ORF1ab gene map.

FIG. 18D is a graph showing the magnitude of QolorEX_{COVID}-19 signals for different concentrations of SARS-COV-2 heat-inactivated viral particles in buffer (gray) and saliva (black).

FIG. 18E is graph showing magnitude of QolorEX_{LAMP} signal for different concentrations of SARS-COV-2 RNA in buffer (gray) and saliva (black).

FIG. 18F is a standard qPCR calibration curve for SARS-COV-2 heat-inactivated viral particles and RNA.

FIG. 18G is a graph showing the linear relation of the QolorEX_{COVID}-19 signals as a function of SARS-COV-2 viral particle.

FIG. 18H is standard qPCR calibration curve for SARS-COV-2 heat-inactivated viral particles and RNA.

FIG. 18I is graph showing the quantification of the SARS-COV-2 RNA selective detection versus different viral RNA and negative controls in buffer and saliva.

FIG. 18J is a schematic of influenza A H1N1 segment 4 HA genomic map.

FIG. 18K is a graph showing the magnitude of QolorEX_{LAMP} signal for different concentrations of influenza A H1N1 RNA in buffer and saliva.

FIG. 18L is a correlated linear relation of the QolorEX_{LAMP} signal as a function of Influenza A H1N1 RNA concentration in buffer and saliva.

FIG. 18M is a graph showing a quantification of the Influenza A H1N1 RNA selective detection versus different viral RNA and negative controls in buffer and saliva.

FIG. 19A is a color palette showing the detected colorimetric readout for different concentrations of E. Coli (y-axis) versus time (x-axis).

FIG. 19B is graph of the signal readout vs time for 50 ng/μL of E. coli DNA.

FIG. 19C is a E. coli genomic map.

FIG. 19D is a methicillin-resistant Staphylococcus aureus (MRSA) genomic map.

FIG. 19E is a graph showing the magnitude of QolorEX_{LAMP} signal for different concentrations of E. coli DNA in buffer.

FIG. 19F is a graph showing the correlated linear relation of the QolorEX_{LAMP} signal as a function of E. coli DNA concentration in buffer.

FIG. 19G is a graph showing the quantification of the E. coli DNA selective detection versus different bacterial DNA and negative controls in buffer.

FIG. 19H is a graph showing the magnitude of QolorEX_{LAMP} signal for different concentrations of MRSA DNA in buffer.

FIG. 19I is a graph showing the correlated linear relation of the QolorEX_{LAMP} signal as a function of MRSA DNA concentration in buffer

FIG. 19J is a graph showing the quantification of the MRSA DNA selective detection versus different bacterial DNA and negative controls in buffer.

FIG. 20A is an image of a gel electrophoresis specificity results for SARS-COV-2 wild type (WT) rolling circle amplification (RCA) based padlock probes (PLPs) showing DNA marker ladder (M), SARS-COV-2 WT RNA (WT), and negative control (NC) columns from left to right respectively.

FIG. 20B is an image of a gel electrophoresis specificity results for SARS-COV-2 Delta variant RCA PLPs showing DNA marker ladder (M), L452R-target-Mutation cDNA (Delta), SARS-CoV-2 WT RNA (WT), and negative control (NC) columns from left to right respectively.

FIG. 20C is an image of a gel electrophoresis specificity results for SARS-COV-2 Omicron variant RCA PLPs showing DNA marker ladder (M), P681H-target-Mutation cDNA (Omicron), SARS-COV-2 WT RNA (WT), and negative control (NC) columns from left to right respectively.

FIG. 21A is a color palette showing the detected colorimetric readout for different concentrations of SARS-COV-2 cDNA (y-axis) versus time (x-axis).

FIG. 21B is a graph showing the QolorEX signal in function of the concentration of particles.

FIG. 21C is a SARSCOV-2 variant genomic map.

FIG. 21D is a graph showing the magnitude of QolorEX_{RCA-WT} signal for different concentrations of SARS-COV-2-Wild type cDNA in buffer and saliva.

FIG. 21E is a graph of the correlation of the linear relation of the QolorEX_{RCA-WT} signal as a function of SARS-COV-2-wild type cDNA concentration in buffer and saliva.

FIG. 21F is a graph showing the quantification of QolorEX_{RCA-WT} selective detection of the SARS-COV-2-wild type cDNA versus different SARS-COV-2 variants cDNA buffer and saliva.

FIG. 21G is a graph showing the magnitude of QolorEX_{RCA-Delta} signal for different concentrations of SARS-COV-2-Delta variant cDNA in buffer and saliva.

FIG. 21H is a graph showing the correlated linear relation of the QolorEX_{RCA-Delta} signal as a function of SARS-COV-2-Delta variant cDNA concentration in buffer and saliva.

FIG. 21I is a graph showing the quantification of QolorEX_{RCA-Delta} selective detection of the SARS-COV-2-Delta variant cDNA versus different SARS-COV-2 variants cDNA buffer and saliva.

FIG. 21J is a graph showing the magnitude of QolorEX_{RCA-Omicron} signal for different concentrations of SARS-COV-2-Omicron variant cDNA in buffer and saliva.

FIG. 21K is a graph showing the linear correlation of the QolorEX_{RCA-Omicron} signal as a function of SARS-COV-2-Omicron variant cDNA concentration in buffer and saliva.

FIG. 21L is a graph of the quantification of QolorEX_{RCA-Omicron} selective detection of the SARSCoV-2-Omicron variant cDNA versus different SARS-COV-2 variants cDNA buffer and saliva.

FIG. 22A is a flowchart of the image quantification (with examples for negative and positive samples) and manual sample analysis.

FIG. 22B is a flowchart of the machine learning analysis performed.

FIG. 22C is a graph showing the accuracy, sensitivity, and specificity of the SVM at the different time points that were studied.

FIG. 22D is a graph of the probability at 7 min calculated by machine learning based on FIG. 22C.

FIG. 22E is a graph of the probability at 15 min calculated by machine learning based on FIG. 22C.

FIG. 23A is a graph showing QolorEX_{LAMP} signal analysis comparing SARS-COV-2 patient human samples (P-1 to P-33) to healthy human samples (H-1 to H-15).

FIG. 23B is a graph of the statistical analysis of the average QolorEX_{LAMP} signal that shows a clear distinguished signal in SARS-COV-2 positive human samples compared to healthy human samples (p<0.001). The plot shows data distribution with a total size of 30 for each healthy and patient sample, mean range, and standard error with a coefficient of 1.5.

FIG. 23C is a graph showing the quantitative correlation of QolorEX_{LAMP} colorimetric signal from a patient human samples with the assay calibration curve for SARS-COV-2 viral RNA load. The error bar shows the SD of the QolorEX signal in 10 colorimetry readouts for each of the 3 sampling of the same patient sample.

FIG. 23D is a graph showing the linear regression and 95% confidence interval of the QolorEX_{LAMP} quantitative response compared with qPCR.

FIG. 23E is a flowchart of image quantification (with examples for negative and positive samples) and sample (manual and machine learning) analysis.

FIG. 23F is a graph comparing probability of SARS-COV-2 infection obtained through a machine learning SVM model based on QolorEX_{LAMP} signal between patient and healthy samples at 10 min. A probability threshold of 0.21 is established based on the comparison for the detection of SARS-COV-2 positive samples.

FIG. 23G is a graph showing the receiver operating characteristic (ROC) curve of the classification of positive and negative samples shows an area under the curve of 0.95 per test.

FIG. 24A is an exploded schematic view of the microfluidic chip of the embodiment of Example 2.

FIG. 24B is a cross section schematic view of the microfluidic chip of the embodiment of Example 2.

FIG. 24C is schematic view of the imaging box of Example 2.

FIG. 24D is an exploded view of the imaging box of Example 2.

FIG. 24E is a schematic of the automation module of the imaging box of Example 2.

FIG. 24F is a graph showing the angular actuator setup exhibiting linear control over the volume pumped.

FIG. 24G is a graph showing the bi-directional flow control demonstrated within the microfluidic chip.

FIG. 24H is a graph showing the bacterial filtration and recovery efficiency per cycle of fluid movement across the filter barrier.

FIG. 25 is a electronics system architecture block diagram.

FIG. 26A is a dot-plot graph of y-value of 30 random points from each different material platform in presence of Resazurin and Resorufin.

FIG. 26B is a dot-plot graph of y-value comparing the gamut provided by the different platforms when in presence of Resazurin, and Resorufin.

FIG. 26C is a dot-plot graph of y-value for the different platforms.

FIG. 27A is an atomic force microscopy characterization (AFM) of the plasmon nanosurface (diameter of nanoparticles 200 nm).

FIG. 27B is an atomic force microscopy characterization (AFM) of the plasmon nanosurface (diameter of nanoparticles 400 nm).

FIG. 27C is an atomic force microscopy characterization (AFM) of the plasmon nanosurface (diameter of nanoparticles 750 nm).

FIG. 27D is an atomic force microscopy characterization (AFM) of the plasmon nanosurface (diameter of nanoparticles 1000 nm).

FIG. 28A is a scanning electron microscopy image showing the plasmon nanosurface (diameter of nanoparticles 400 nm).

FIG. 28B is a scanning electron microscopy image showing the plasmon nanosurface (diameter of nanoparticles 750 nm).

FIG. 29A is a reflectance spectra for a plasmon platform with nanoparticles having a 200 nm diameter.

FIG. 29B is a reflectance spectra for a plasmon platform with nanoparticles having a 600 nm diameter.

FIG. 29C is a reflectance spectra for a plasmon platform with nanoparticles having a 750 nm diameter.

FIG. 29D is a reflectance spectra for a plasmon platform with nanoparticles having a 1000 nm diameter.

FIG. 30A is a graph showing the normalized reflection in function of the wavelength for the different diameters of nanoparticles.

FIG. 30B is a graph showing the electric potential in function of the wavelength for the different diameters of nanoparticles.

FIG. 31A is a graph showing the maximum flow velocity in the detection chamber versus different input flow rates.

FIG. 31B is a graph showing the shear stress over the self assembled monolayer (SAM) layer for different input flow rates and the Critical Shear Stress which leads to SAM detachment.

FIG. 32A is a graph showing the QolorAST signal for different E coli concentrations after 15 mins incubation.

FIG. 32B is a graph showing the correlated linear relation of the QolorAST signal as a function of E coli gDNA concentration (R²=0.97).

FIG. 32C is a graph showing the selective detection of E coli gDNA versus multiple bacterial gDNA and negative controls.

FIG. 32D is a graph showing QolorAST signals for E coli spiked urine (right side bar graph for each condition) versus E coli in LB growth media (left side bar graph for each condition).

FIG. 32E is a graph showing the minimum inhibitory concentration study of E coli in spiked urine.

FIG. 33 is a graph showing the receiver operating characteristic curve for the support vector machine code for minimum inhibitory concentration detection for different bacterial strains in growth media.

FIG. 34A is a graph showing QolorAST signal for the phenotypic assay no antibiotic condition where according to the growth patterns samples where categorized in to no negative (no bacteria), fastidious, or non fastidious bacteria (E coli). Quantification of the data shows mean values±standard error with a coefficient of 1.5.

FIG. 34B is a graph showing statistical analysis of the average phenotypic QolorAST assay signal shows a clearly distinguished signal in negative urine, urine with fastiodious bacteria and urine with non-fastidious bacteria (p<0.001). The plot shows data distribution with a total size of 30 for each sample, mean range, and SD with a coefficient of 1.0.

FIG. 34C is a graph showing the sensitivity in function of the specificity (with an area under the curve (AUC) of 0.855).

FIG. 34D is graph showing QolorAST signal for the genotypic LAMP assay for E coli detection (targeting malB gene) where according to signals the samples where categorized in to negative E coli samples or E coli positive samples. Quantification of the data shows mean values±standard error with a coefficient of 1.5.

FIG. 34E is a graph showing a statistical analysis of the average phenotypic QolorAST assay signal shows a clearly distinguished signal in E coli negative urine and E coli positive urine (p<0.001). The plot shows data distribution with a total size of 30 for each sample, mean range, and SD with a coefficient of 1.0.

FIG. 34F is a graph showing the sensitivity in function of the specificity with an AUC of 1.

FIG. 34G is a graph comparing the probability of UTI infection obtained through a machine learning SVM model based on QolorAST signal between the urine samples in 30 mins. (Bars show mean values with a ±standard error of 1.5 coefficient.)

FIG. 34H is a graph showing the sensitivity in function of the specificity with an AUC of 0.99. N=20 per human sample from the color features extraction in each of the 3-imaging samples.

FIG. 35A is a graph showing a statistical analysis of the average phenotypic QolorAST assay signal at a ciprofloxacine 0.25 μg/ml cut off concentration shows clearly distinguished signal in negative urine, Ciprofloxacine susceptible urine samples and Ciprofloxacine resistant urine samples (p<0.001). The plot shows data distribution with a total size of 30 for each sample, mean range, and SD with a coefficient of 1.0.

FIG. 35B is a graph showing the sensitivity in function of the specificity with an AUC of 0.916.

FIG. 35C is a graph showing a statistical analysis of the average phenotypic QolorAST assay signal at a Nitrofurantoin 64 μg/ml cut off concentration distinguished signal in negative urine, and nitrofurantoin susceptible urine samples (p<0.013). The plot shows data distribution with a total size of 30 for each sample, mean range, and SD with a coefficient of 1.0.

FIG. 35D is a graph showing the sensitivity in function of the specificity with an AUC of 1.

FIG. 36A is a schematic of a microfluidic chip with electrodes for electric sensing of analytes according to one embodiment of the present disclosure.

FIG. 36B is a schematic of a device for electric sensing according to one embodiment of the present disclosure.

FIG. 36C is a schematic of an inlet apparatus according to one embodiment of the present disclosure.

FIG. 36D is a schematic of an assembled device for electric sensing according to one embodiment of the present disclosure.

FIG. 37A is a schematic showing a mask on a glass slide for electrodeposition.

FIG. 37B is a schematic showing the electrodeposition of Cr and Au through the mask of FIG. 37A.

FIG. 37C is a schematic showing the removal of the mask in FIG. 37B.

FIG. 37D is a schematic showing the bonding of microfluidic channels on top of the electrodeposited layer of FIG. 37C.

FIG. 38A is a graph showing the concentration of the current measured in function of the concentration of the spike protein in buffer.

FIG. 38B is a graph showing the concentration of the current measured in function of the concentration of the spike protein in saliva.

FIG. 38C is a graph showing the concentration of the current measured in function of the concentration of the spike protein in blood.

FIG. 38D is a bar graph showing the current measured in samples from healthy and SARS-Cov-2 patients.

### DETAILED DESCRIPTION

The present detection systems leverage a controlled flow of fluid in a microfluidic chip with the use of a suction membrane at the outlet of the microfluidic chip. In operation, when the sample is provided in the inlet of the microfluidic chip, the suction membrane controls the air pressure in the channels by expanding or contracting to thereby drive the fluid flow towards the outlet or back towards the inlet. Conventional systems that use a screw or similar means directly at the outlet of the microfluidic chip are associated with leakage and inaccurate control of the fluid flow. The addition of the membrane which itself can be actuated by a screw for example, allows an improved control over the fluid flow (including allowing bidirectional flow) and does not lead to leakage. One advantage of the suction membrane is that it can controllably halt the flow of the sample above a reaction zone and/or a sensing region of the microfluidic chip without allowing the sample to leak or uncontrollably continue to flow. The bidirectional flow also allows for the sample to be flowed back and forth between the reaction zone and the sensing region to thereby achieve multiple timepoint measurements. A single suction membrane is sufficient to control the flow of the fluid in the microfluidic device however multiple suction membranes can be included to further increase the control over the fluid flow or to facilitate the automation of the assay. A single suction membrane is sufficient to control the flow of a microfluidic chip having 3, 4, 8, 16, 24, 32, 64, or 96 separate channels.

The size of the suction membrane can vary based on the size of the microfluidic chip. More specifically the size of the volume defined inside the suction membrane is correlated to the total volume in the channels controlled by the suction membrane and in fluid communication therewith. Different shapes of the suction membrane are contemplated herein. For example, a hemisphere, an oval shaped hemisphere, a pyramidal shape, or cuboidal shape. Exemplary diameters for a hemisphere suction membrane are in the range of from 0.5 mm to 10 cm with a height of from 0.25 mm to 3 cm. Although a hemisphere is preferred, the function of the suction membrane is independent of its shape as long as the volume contained therein can be controlled by compression or relaxation of the suction membrane.

In the below exemplified embodiments, a mechanically actuated screw was used to perform the compression and relaxation on the suction membranes. However, other mechanical actuators are possible. For example, a piston like structure can be mechanically controlled to push or move away from the suction membrane. It is also contemplated that the mechanical actuation may be passive by the addition of weight on top of the piston or removing weight.

The utility of the suction membrane in controlling the fluid flow is not limited to any specific assay performed by the microfluidic chip. Preferred embodiments pair an assay that can be automated by detection not requiring human inputs with an automation of the control of the suction membrane. In the exemplified embodiments below, the detection is a colorimetric detection or an electrochemical/electric detection. However, other types of detection are possible and broadly spectroscopies are applicable. For example, surface-enhanced Raman spectroscopy (SERS) can be used to detect an analyte using microfluidic chips. In one example, the SERS outputs a label-free spectroscopic finger print for extracellular vesicles (EV) molecular profiling. The SERS is associated with a microfluidic device having an embedded arrayed nanocavity microchips that can detect EV. In one example, an embedded MoS₂ monolayer can be used to enable the label-free isolation and nanoconfinement of single EVs due to physical interaction (Coulomband van der Waals) between the MoS₂ edge sites and the lipid bilayer; and a layered plasmonic cavity that enables sufficient electromagnetic field enhancement inside the cavities.

In some embodiments, the platform is a colorimetric assay via plasmonic excitation. An opaque metallic nanostructured plasmonic platform is sensitive to characteristics of incident light such as its intensity, spectral profile, uniformity, and the angle of incidence. An epi-illumination imaging setup is preferably used to offer better control over illumination and imaging modalities.

One example of colorimetric techniques is the sensing of nucleic acid sequences using a nucleic acid amplification assay and a colorimetric sensor that changes color based on the amplification. This is particularly useful for the detection of pathogens. While polymerase chain reaction (PCR) technique remains the gold standard technique, isothermal nucleic acid amplification techniques (NAAT), especially Loop-mediated isothermal amplification (LAMP) have gained traction. Several advantages of LAMP include a requirement for constant temperature for amplification (instead of a cycle as per PCR), higher specificity and sensitivity compared to conventional methods, and stability against some amplification inhibitors. Among different colorimetric techniques, naked-eye/dye-based readouts are suitable for integration with LAMP. This technique also allows for easy integration with lab on a chip (LOC) platforms for point of care/need applications, as they require simple imaging setups allowing easy interpretation.

A major feature of a point of care/need diagnostic system is the ability to integrate all of the discreet assay steps in a fashion more suitable for point of care/need settings. In the case of nucleic acid amplification assays, these steps are sample collection, sample processing, reagent mixing, amplification reaction, and detection sub-steps. In addition to this, the sequential nature of a typical RT-LAMP assay, i.e. pathogen lysis, metering of sample and reagents followed by controlled heating for amplification, necessitate not only precise but also a facile setup for the end user in a point of care/need setting. To address these broad needs, a microfluidic setup was developed to implement techniques that allow metering and precise control of fluids and heat transfer, onto a single platform. Indeed, confined reaction volumes allow for fast and high throughput analysis, and enhanced heat transfer. Although, previous research on colorimetric readout-based pathogen detection platforms utilized microfluidic setups to integrate major assay sub-steps i.e., sample collection, sample processing, reagent mixing, amplification reaction, and detection, they often involved user involvement in one of more of these sub-steps, especially in sample collection, sample preprocessing, and/or fluid manipulation steps.

Another significant feature of microfluidic setups is their propensity to incorporate auxiliary components that could help reduce user involvement while achieving features suitable for point of care settings. Specifically, there has been growing interest in leveraging additive manufacturing techniques to fabricate auxiliary components that could offset the need for expensive equipment and/or trained personnel. For colorimetric detection assays, in both 3D printing leveraged and conventional integrated microfluidic systems alike, most of the current technologies lack user independence and autonomy in processing one or more of the sequential assay steps, especially in sample collection, sample preprocessing, and/or fluid manipulation steps.

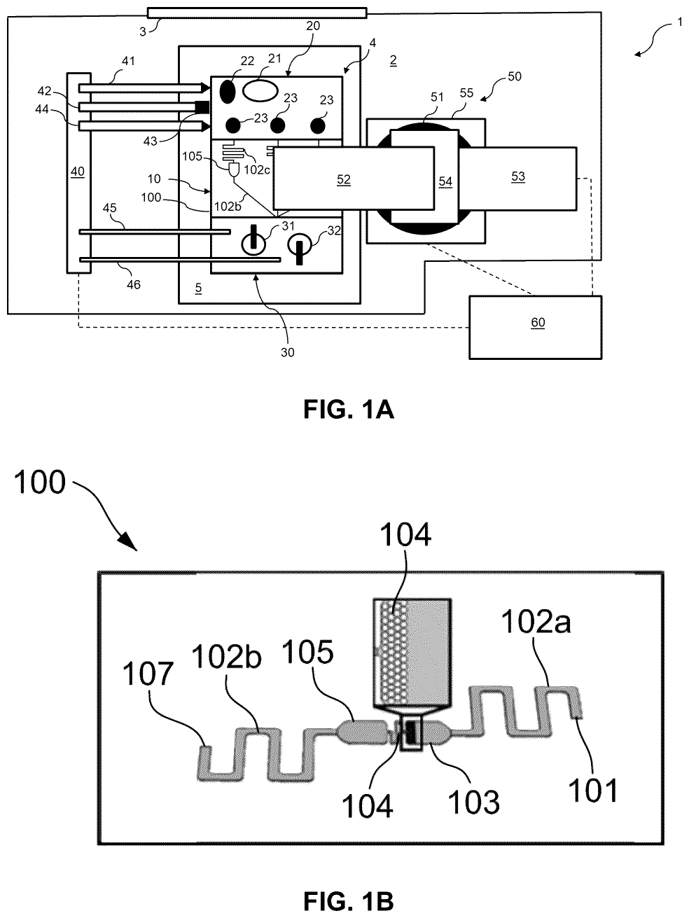

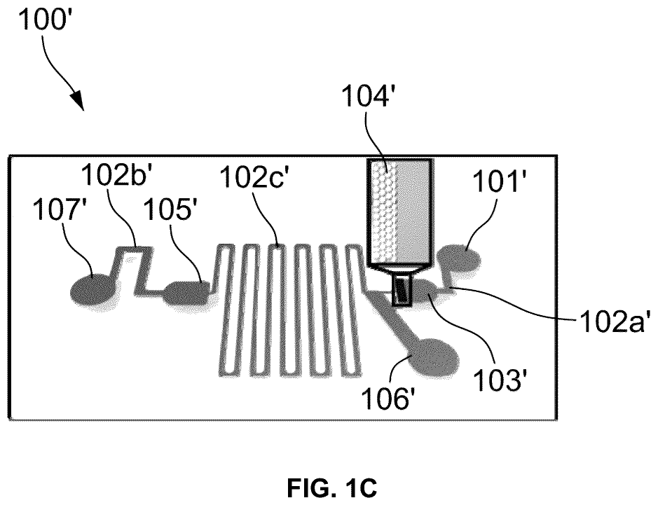

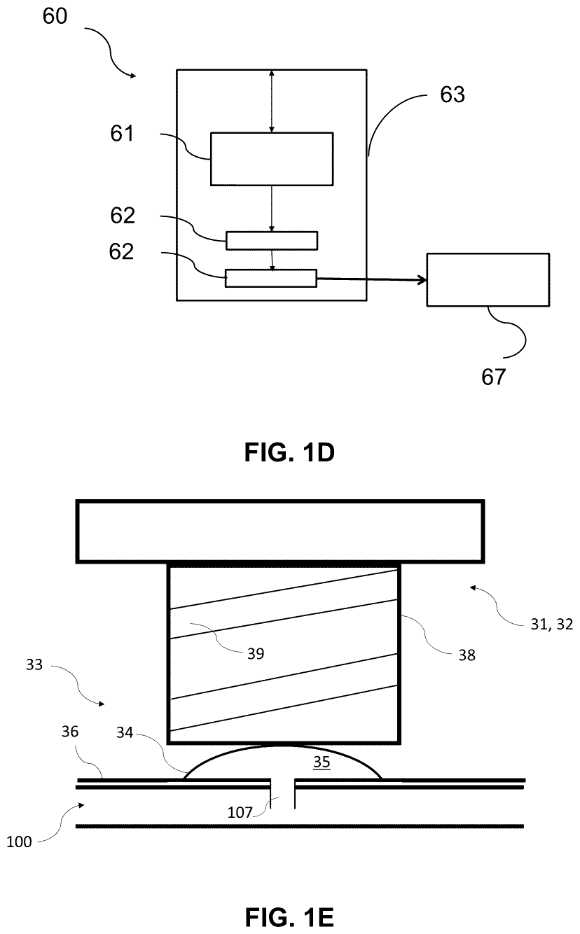

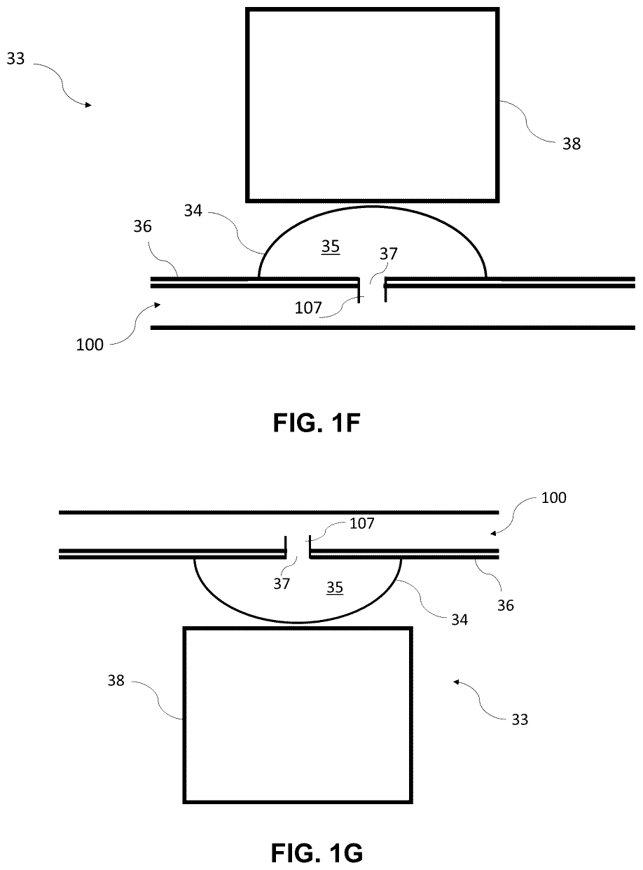

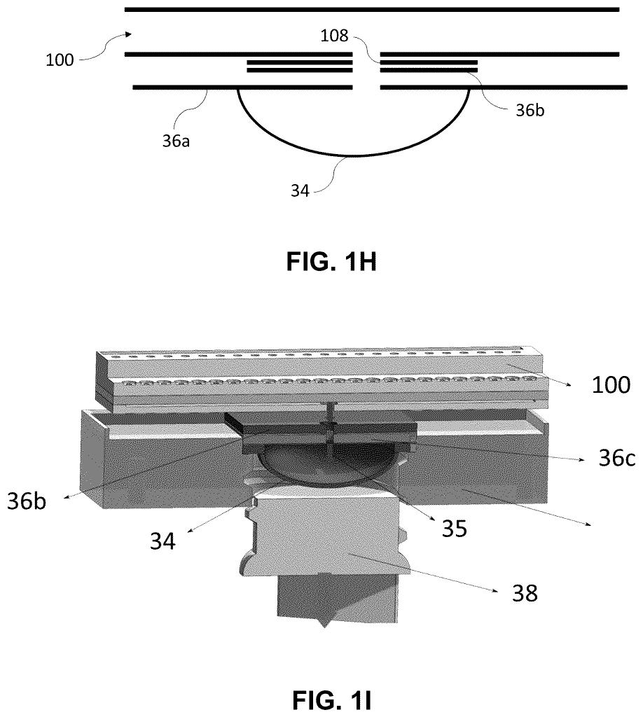

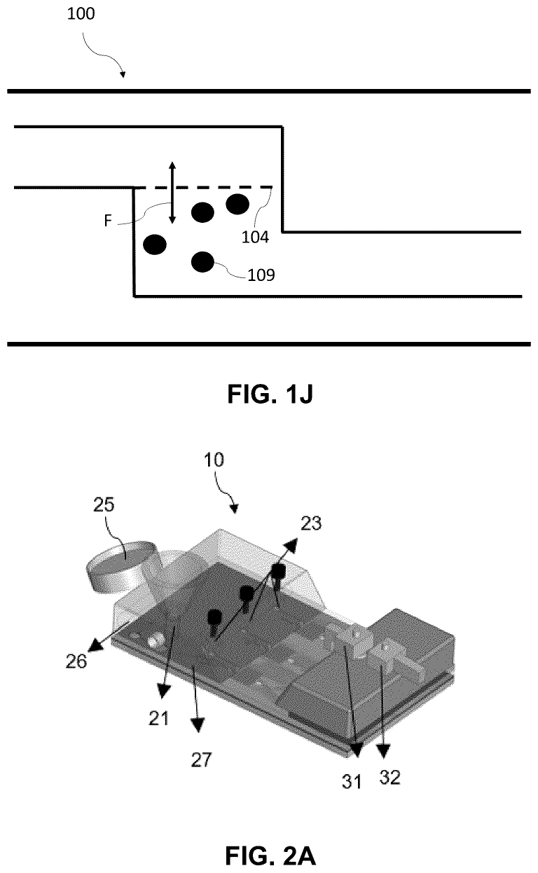

Making reference to FIG. 1A, there is provided an exemplary colorimetric detection system 1 that includes a colorimetric detection device 2 and a microfluidic cartridge 10. The microfluidic cartridge 10 and the detection device 2 are provided separately and the microfluidic cartridge 10 is placed onto the cartridge holder 5 of the detection device 2 when the detection assay begins. The microfluidic cartridge 10 comprises a microfluidic chip 100, an inlet apparatus 20 and an outlet apparatus 30.

Now making reference to FIGS. 1B and 1C, two embodiments of the microfluidic chip 100 and 100′ are shown. The microfluidic chip 100 has an inlet 101 adapted to receive a sample, such as the exemplary samples discussed herein. An inlet microchannel 102a is defined between the inlet 101 and an incubation chamber 103. The inlet microchannel 102a fluidly connects to an incubation chamber inlet. The incubation chamber inlet may be defined at a junction between the inlet microchannel 102a and the widening portion of the incubation chamber 103. In the embodiment shown, the microfluidic chip 100 has a single inlet microchannel 102a. A plurality of inlet microchannels 102a may be contemplated in other embodiments. The microchannel 102a may be shaped so as to promote mixing in the flowing sample upstream of the incubation chamber 103. As shown, in some embodiments, the microchannel 102a has a serpentine shape. The microchannel 102a may include a plurality of hairpin bends. The number of hairpin bends may vary depending on the embodiments. The number of hairpin bends may be selected so as to obtain a desired level of mixing. In at least some embodiments, there is at least three hairpin bends. There may be between two and twelve hairpin bends in some embodiments. There could be more in other embodiments. The microchannel(s) 102a may have other shape/geometry adapted to promote mixing in the flowing sample. The microchannel 102a may have a uniform cross-section or a variable cross-section. For example, the microchannel 102a may define one or more mixing chambers or widening section(s) and/or bottleneck section(s) there along. This may create turbulence within the flowing sample, by a change in geometry or pressure differential within the flowing sample, which may promote mixing. The microchannel(s) 102a may be linear (straight) in other embodiments, with or without such mixing chambers and/or sections. The microchannel 102a may have a cross-sectional shape(s) and size(s) selected based on an inlet pressure required to deliver the sample. Although the microchannel 102a was described, the same applies to microchannels 102b and 102c.

The incubation chamber 103 may receive/contain the mixed (or unmixed) sample. When the sample is contained in the incubation chamber 103 with the colorimetric sensor, the sample may be subjected to conditions that promote the colorimetric reaction to change the color of the sample. For example, heating may be applied.

As shown, a barrier 104, which may also be referred to as a barrier filter, is located downstream of the incubation chamber inlet. The barrier 104 may restrict the flow (e.g., reduce the flow rate) from exiting the incubation chamber 103. In the embodiment shown, the incubation chamber 103 includes the barrier 104. After incubation, the sample is pushed (e.g., by pressure differential) through the barrier 104 and into the sensing chamber 105. The barrier 104 may occupy a portion of the incubation chamber 103. The proportion of the incubation chamber 103 occupied by the barrier 104 may vary depending on the embodiments. In some embodiments, the barrier 104 may take up less than 50% of a total volume of the incubation chamber 103. Other proportions, i.e., between 50% and 70% could also be contemplated. The sample may be substantially or entirely retained in the incubation chamber 103 thanks to the barrier 104. In this context, the term “substantially” may be defined as having at least 80%, at least 85%, at least 90%, at least 95% or at least 99% of the volume of the sample being retained in the incubation chamber 103 for an incubation period. The barrier 104 may be enclosed within the incubation chamber 103 in a downstreammost portion of the incubation chamber 103. This is only one possibility. The barrier 104 may be located downstream of the incubation chamber 103, such as in a separate “filter chamber” fluidly connected to the incubation chamber 103 downstream thereof as another example.

The barrier 104 may entrap debris, undesirable particles, cells, such as bacteria, or other microscopic bodies before the flowing sample reaches the sensing chamber 105. In at least some embodiments, the barrier 104 includes an array of protruding microstructures. In an embodiment, the protruding microstructures are substantially cylindrical in shape (such as micropillars), however other shapes may be contemplated. The protruding microstructures are spaced apart to define a minimal distance between two protruding microstructure or between a protruding microstructure and a wall of the incubation chamber 103. The protruding microstructures may all have substantially the same size or there can be a variation in the size between the different protruding microstructures. The protruding microstructures can be arranged such that a flow of sample across the barrier 104 has to go through at least one minimal distance. This minimal distance can be referred to as the filter pore size. The minimal distance may be a range of values as the distance between two protruding microstructures may not be exactly constant. Solid particles, organisms or molecules that are larger than the minimal distance may not go through the barrier 104 and may thus be entrapped in the incubation chamber 103. For simplicity, the minimal distance between protruding microstructures of the barrier 104 will be referred to herein as the pore size of the barrier 104 filter. The pore size can be in the nanoscale range and can prevent the passage of bacteria and certain viruses, molecules and/or polymers. In some embodiments, the pore size is less than 1000 nm, less than 900 nm, less than 800 nm, less than 700 nm, less than 600 nm, less than 500 nm, less than 400 nm, between 100 nm and 1000 nm, between 200 and 900 nm, between 200 and 800 nm, between 200 and 700 nm, between 200 and 600 nm, between 200 and 500 nm or between 200 and 400 nm. In some embodiments, the protruding microstructures have a size of from 5 to 50 μm or from 5 to 40 μm. For example, the protruding microstructures can be micropillars having a diameter from 5 to 50 μm or from 5 to 40 μm. The spacing between the micropillars is preferably sufficiently large so as to allow a substantially laminar flow of the sample across the barrier 104. In some embodiments, the barrier 104 comprises at least two rows of protruding microstructures spaced apart so as to define a minimal distance being the pore size as described above. In some embodiments, the barrier 104 can comprise at least 3, at least 4, at least 5, at least 6, from 2 to 20, from 2 to 15, or from 2 to 10 of rows of protruding microstructure.

As shown in FIGS. 1A-1B, the incubation chamber 103 and the sensing chamber 105 are fluidly connected via a microchannel 102c. As shown, the microchannel 102c extends between the incubation chamber 103 and the sensing chamber 105. In the embodiment shown, the microchannel 102c has a serpentine shape, which may further promote mixing of the filtered sample once it flowed through the barrier 104. There may be more microchannels 102c fluidly connecting the chambers 103, 105 in other embodiments, and/or microchannel 102c may have other shapes, similar to the inlet microchannel 102a discussed above, for example, as per FIG. 1B, downstream of the sensing chamber 105 is an outlet microchannel 102b. The outlet microchannel 102b is shown as a single serpentine channel 102b. Other shapes/geometry may be contemplated. The outlet microchannel 102b may channel the sample out of the chip 100 through outlet 107. The sample may be drained through the outlet 107. A plurality of outlet microchannels 102b fluidly connected to the sensing chamber 105 downstream thereof may be contemplated. More than one outlet 107 may also be contemplated in other embodiments.

The sensing chamber 105 has a plasmonic nanosurface, which may be referred to as plasmonic substrate, to allow increased sensitivity to the change in color of the colorimetric sensor. The color-generation strategy of plasmonic color printing involves the patterning of various geometrical metallic nanostructures. The nanostructures have a size that is smaller than that of the diffraction limit of light. The nanostructures and materials thereof are designed to resonate at a specific optical frequency leading to the production of different colors across the visible spectrum. The nanostructures act as nanoantennas when exposed to an electromagnetic field of light that resonate to increase a color gamut between the changes in color of the colorimetric sensor.

The nanostructures protrude from the nanosurface. The nanostructures may be in the shape of nanodisks, ellipses, nanocubes and/or multimers. In one embodiment, the nanostructures may have a diameter between 200 nm and 1000 nm. The interparticle gap spacing (gap between adjacent protruding nanostructures) can be considered to act as a plasmonic nanocavity. The interparticle gap length can for example vary from 20 nm to 500 nm (±5 nm or ±5%) or 73 nm and 340 nm (±5 nm or ±5%) with increasing nanostructures diameter (or maximum transverse dimension if diameter does not apply). With decreasing color change in the assay, smaller gaps (below 200 nm) generate more enhanced electromagnetic field. In a least some embodiments, the nanostructures have a plasmon-supported metallic layer with the ability to provide tunable localized surface plasmon resonance. The plasmon-supported metallic layer may provide high-resolution plasmonic color with a white background. For example, the plasmon-supported metallic surface is one of gold, silver, and aluminum or alloys thereof such as AuAg, AuAl, and AgAl. The plasmon-supported metallic layer may also be a bimetallic of Au, Ag, and Al such as AuPd, AgPd, AuNi, AuCu, AgCu, AuNiCu. In at least some embodiments the plasmon-supported metallic layer is a layer of 5 nm to 100 nm, 10 to 50 nm, 15 to 25 nm or 10 to 25 nm. Under the plasmon-supported metallic layer the nanostructures may have a back reflector layer. In some embodiments, the back reflector layer has a thickness from 10 nm to 400 nm, 50 nm to 130 nm or from 60 nm to 120 nm. The back reflector layer covers nanoparticles that are deposited on the surface of the sensing chamber 105. The back reflector material may advantageously be deposited using sputtering, ebeam deposition and/or spin coating. In one embodiment the back reflector layer comprises or consists of one of ZnO, TiO₂, hydrogen silsesquioxane (HSQ), AZ MiRTM, or polymethyl methacrylate (PMMA). In one example the nanoparticles are made of polystyrene and have a diameter of between 200 to 1000 nm. The nanoparticles may be in any suitable shape, preferably a spheroidal shape such as a sphere. Unlike organic-dye color filters, the plasmonic color filters may offer advantages such as high color tunability, sensitive color changing based on medium permittivity and low color degradation rate.

Referring to FIG. 1C, a variant of the chip 100 of FIGS. 1A-1B is presented. Like features bear the same reference number for ease of reference, with prime added. Characteristics of the features described with respect to the chip 100 may similarly apply to chip 100′ of FIG. 1C, hence they will not be repeated in whole for conciseness. For example, in FIG. 1C, the barrier 104′ is enclosed in the incubation chamber 103′ and occupies a portion of the total volume thereof. This is given as an example.

As illustrated in FIG. 1C, the colorimetric sensor may be added within the sample downstream of the inlet 101′, inlet microchannel 102a′ and incubation chamber 103′. In the variant shown, the microfluidic chip 100′ includes a second inlet 106′. The second inlet 106′ is located downstream of the incubation chamber 103′. The second inlet 106′ may be adapted to receive the colorimetric sensor. The second inlet 106′ may also be used to provide other reagents into the flowing sample, such as, without limitation, nucleic acids, primers, enzymes, buffers, salts. In embodiments where the colorimetric sensor is provided after the sample has gone through the incubation chamber 103, i.e., downstream of the incubation chamber 103′, it may be desirable to perform further mixing of the sample before it reaches the sensing chamber 105′. As shown, a microchannel 102c′ fluidly interconnects the incubation chamber 103′ and inlet 106′, at an upstream end of the microchannel 102c′, and the sensing chamber 105′ at a downstream end of the microchannel 102c′.

The microchannel 102c′ defines a mixing zone between the incubation chamber 103′ and the sensing chamber 105′ adapted to provide sufficient mixing of the sample with the colorimetric sensor and sufficient time for the colorimetric reaction to occur at a predetermined flow rate. As it is being mixed, the flowing sample may change color before reaching the sensing chamber 105′. The mixing zone, also referred to as mixing channel, may be a serpentine or any other suitable shape as described above, for example with or without mixing sub-chambers, one or more microchannels 102c′, etc. In an embodiment, the walls of the microchannel 102c′ have an outline adapted to promote mixing. Mixing may be performed by creating a turbulent flow. In an embodiment, such as shown, the side walls of the microchannel 102c′ have a toothed outline. The toothed outline may define a series of arrows or serially distributed triangularly shaped sections. Other outlines may be contemplated, such as an outline defining discontinuities, bends, waves, or irregular patterns, for example. As another mixing parameter, surface roughness of the walls may also contribute to the mixing. Other configurations may be contemplated. While such toothed outline is described with reference to microchannel 102c′, it should be understood that any one of the microchannels (102a, 102b, 102c, 102a′ and 102b′) identified may have such configurations described with respect to microchannel 102c′.

Returning to FIG. 1A, the microfluidic cartridge 10 has an inlet apparatus 20. The inlet apparatus 20 covers the microfluidic chip 100 at the level of the inlet 101, the incubation chamber 103 and the filter barrier 104 of the microfluidic chip. The inlet apparatus 20 has a receptacle 21 adapted to receive the sample. In one example, the receptacle 21 is a funnel. The receptacle 21 optionally has a closing lid, to avoid losses of the sample particularly if the sample is heated. The receptacle is in fluid communication with the inlet 101 to provide the sample to the microfluidic chip 100. Accordingly, in some embodiments, the sample is saliva and an individual can directly spit into the receptacle 21. However, other embodiments are also contemplated herein. For example, the sample can be urine, blood, sweat, tears, a microorganism containing sample (e.g. virus, bacteria, parasite), or a cell containing sample (e.g. a cancer cell). The microorganism containing sample or the cell containing sample can be cultures or can be solid samples that have been suspended into a solution or buffer (e.g. a biopsy of cancer cells).

Although it is preferred that the colorimetric sensor is provided autonomously (e.g. without human intervention) by the microfluidic cartridge, it is possible that the sample is prepared before being provided to the microfluidic chip. For example the sample can be suspended, purified, filtered, or centrifuged after being collected. However, it is an objective of the present colorimetric detection system to minimize the steps taken by individuals to increase autonomy and to decrease human induced errors and inconsistencies. Accordingly, it is an advantage of the present system to provide the colorimetric sensor from the microfluidic cartridge 10 as described below.

The colorimetric sensor may be any appropriate colorimetric sensor that is specific to an analyte of interest so that the colorimetric sensor changes the color of the sample if the analyte is present. The colorimetric sensor may be a salt that reacts with a metabolic enzyme such as the NADH/NADPH cellular oxidoreductase enzymes. Examples of such salts include resazurin (metabolized to resorufin) and tetrazolium salts that are metabolized to formazan due to the disruption of the tetrazole ring. The tetrazolium salt can be selected from the group consisting of MTT (3-(4,5-dimethyl-thiazol-2-yl)-2,5-diphenyltetrazolium bromide), XTT (2,3-bis-(2-methoxy-4-nitro-5-sulfophenyl)-2H-tetrazolium-5-carboxanilide inner salt), MTS (3-(4,5-dimethylthiazol-2-yl)-5-(3-carboxymethylphenyl)-2-(4-sulfophenyl)-2H-tetrazolium), and WST (water-soluble tetrazolium salts). The colorimetric sensor may be a 3,3′,5,5′-Tetramethylbenzidine or TMB which is a chromogenic substrate that can used in staining procedures in immunohistochemistry as well as a visualizing reagent exploited in enzyme-linked immunosorbent assays (ELISA). TMB is a white solid that forms a pale blue-green liquid in solution with ethyl acetate. The colorimetric sensor may be a pH sensitive dye in the fluid media that changes color when the pH changes. For example the colorimetric sensor may be phenol red, methyl blue, bromothymol blue, p-nitrophenol (formed by alkaline phosphatase from p-nitrophenol phosphate) and other similar colorimetric acid-base indicators. The colorimetric sensor can also be a H₂O₂ sensitive media that changes color with the concentration of H₂O₂ such as iodide or titanium based H₂O₂ indicators and the Amplex™ Red reagent which reacts with H₂O₂ to produce the red-fluorescent oxidation product, resorufin. In addition, color-sensitive nanoparticles may be used, including Au, Ag, AuPd and other nanoparticles possessing colors in the range of red to the blue. In some embodiments, the sample is selected from oral fluid, sputum, urine, tears, blood, plasma, nasal fluid, sweat, cerebral spinal fluid, suspended cells or microorganisms.

The inlet apparatus contains a storage chamber having a rupturable membrane and housing a colorimetric sensor as described above. The storage chamber 23 is in fluid communication with the microfluidic chip upstream of the sensing chamber 105, and preferably upstream of the mixing channel 102c. In some embodiments, the storage chamber 23 can fluidly connect to the microfluidic chip 100 before the incubation chamber 103 and barrier 104, in embodiments where it is desired to incubate the colorimetric sensor with the sample. One such example is the MTT assay where the objective is to determine and optionally quantify whether a cell population in the sample is alive or dead. In that example, the colorimetric sensor (i.e. MTT) can be incubated in the incubation chamber 103 with the cells and after the incubation the colorimetric sensor passes through the barrier 104 to get to the sensing chamber 105 but not the cells which are retained at the barrier. In other embodiments, the colorimetric sensor is provided downstream of the barrier. One such example is when the analyte is a nucleic acid sequence and the sample has to first be lysed to release the nucleic acid content therein. In that embodiment, the cell debris may be retained by the barrier 104 while the nucleic acid sequences go through and are then mixed with the colorimetric sensor in the mixing channel 102c.

In one particular example, the sample (e.g. saliva) is provided without any treatment directly into the receptacle 21. In such embodiments, the inlet apparatus 20 has a storage chamber containing lysis reagents 22. However, lysis may not be necessary in some cases as that depends on the analyte and the sample. Lysis is generally needed when the analyte is a nucleic acid sequence. In such embodiments, the storage chamber 23 can further contain the necessary reagents to perform a nucleic acid amplification (e.g. polymerase chain reaction (PCR), reverse transcription loop-mediated isothermal amplification (RT-LAMP) or a rolling circle amplification (RCA)). RT-LAMP and RCA are the preferred amplification techniques for a rapid screening. The reagents for a nucleic acid amplification include the primers targeting the analyte (forward and reverse), nucleotide and an appropriate DNA polymerase.

The inlet apparatus operates autonomously thanks to actuators. In embodiments where the lysis chamber 22 is present in the microfluidic cartridge 10, a piercing actuator 41 can be used to pierce a rupturable membrane of the lysis chamber 22 in order to release the contents of the lysis chamber 22 and bring them into contact with the sample to begin lysis. The lysis can include heating to a temperature of 85 to 98° C. for example around 95° C. This can be achieved by using a heating actuator 42 having a heating element 43. Finally, to release the contents of the storage chamber 23, another piercing actuator 44 can be used to rupture a rupturable membrane of the storage chamber 23 to release its content into the channels of the microfluidic chip 100. The actuators 41, 42 and 44 are connected to an actuating motor 40 which mechanically activates the actuators 41, 42 and 44. The actuating motor 40 can be connected to a controller or is coupled to a processing device 60. In some cases, the actuating motor 40 is connected to a controller and the controller is coupled to the processing device 60.

The flow in the microfluidic chip 100 is driven by a negative pressure created by two screws 31, 32 controlling the compression on the suction membrane in the outlet apparatus. The screws 31, 32 are released by actuators 45, 46 which are also connected to the actuating motor 40. It would be most economical and simplest to have the same motor 40 actuate all the actuators, however, it is of course possible to use multiple motors. To drive the flow of the sample to the incubation chamber 103, the first suction actuator 45 releases the first suction membrane which creates a negative pressure to drive the flow. After incubation, to drive the flow of the sample past the barrier 104 and to drive the flow of the contents of the storage chamber 23 if they are provided after the barrier 104, the second suction actuator 46 releases the second screw 32 to drive the flow and optionally the mixing in the microchannel 102c. The autonomous functioning of the present system is described in more detail further below, particularly in the example section.

When the sample reaches the incubation chamber 105, the light detection is performed with a light detection apparatus 50. An advantage of the present system is that a brightfield microscope is not needed and a more compact system is employed. A condensing lens 51, for example an objective, is used to condense the light detected from the sensing chamber 105 of the microfluidic chip 100. A light source 52 is provided to perform an epi illumination on the sensing chamber 105. This means that the light of the light source 52 is provided on the same side as the condensing lens 51. Preferably, the light source 52 is an illumination column with a light emitting diode (LED). An image sensor 53, for example a camera or a CMOS sensor, receives the light condensed by the condensing lens 51. The image sensor can register the light received as an electronic signal and can send the electronic signal to the processing device 60. Accordingly, the image sensor 53 is coupled to the processing device 60. The condensing lens 51, the light source 52 and the image sensor 53 are all connected optically by appropriate means 54. In some embodiments, the microfluidic chip 100 can have more than one sensing chamber 105. In such embodiments, it is required to have the condensing lens 51 be able to move to be positioned above each of the sensing chamber 105. In these embodiments, the light detection apparatus can be connected to a motorized platform 55 which allows at least the lateral movement with respect to the microfluidic chip and in between the inlet apparatus and the outlet apparatus.

The processing device 60 is shown in FIG. 1D according to one embodiment. The processing device comprises a computing device 63 which may be handheld, portable, or fixed. For simplicity only one computing device 63 is shown but a system may include more computing devices 63 operable by users to access remote network resources and exchange data. The computing devices 63 may be the same or different types of devices. The computing device 63 comprises at least one processor 61, a data storage device 62 (including volatile memory or non-volatile memory or other data storage elements or a combination thereof), and at least one communication interface (not shown). The computing device 63 components may be connected in various ways including directly coupled, indirectly coupled via a network, and distributed over a wide geographic area and connected via a network (which may be referred to as “cloud computing”).

For example, and without limitation, the computing device 63 may be a server, network appliance, a set-top box, embedded device, computer expansion module, personal computer, laptop, personal data assistant, cellular telephone, smartphone device, UMPC tablets, video display terminal, gaming console, electronic reading device, and wireless hypermedia device or any other computing device capable of being configured to carry out the methods described herein.

Each processor 61 may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof.

Memory 62 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each communication interface enables computing device 63 to interconnect with one or more input/output devices 67, such as a keyboard, mouse, camera, touch screen microphone, display screen and speaker. For example, a display screen may display a symbol or sign that is indicative of the presence or absence of the sample analyte in the sample. In one embodiment, the display screen displays the value of the concentration of the sample analyte in the sample. In a further embodiment, the display screen may display the estimated value of the concentration of the sample analyte in the sample of the subject who provided the sample. The display can be a simple display in black and white or a more modern touch screen able to receive commands. A user interface may contain a button or other physical means for the user to signal to the device to begin the analysis of a sample.

In some embodiments, a network interface enables the computing device 63 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

The computing device 63 can be operable to register and authenticate users (using a login, unique identifier, and password for example) prior to providing access to applications, a local network, network resources, other networks and network security devices. Computing device 63 may serve one user or multiple users.

In some embodiments, a machine learning algorithm is used to increase the accuracy of the detection. In such embodiments, the memory 62 can store the training data set and may continuously update the training data set. The memory 62 may have various parameters stored therein and can store the readings performed over time. Features of machine learning may include dimensionality reduction of the electrical signal using one of principal component analysis (PCA), locally linear embedding (LLE), multidimensional scaling (MDS), t-distributed stochastic neighbor embedding (t-SNE), and linear discriminant analysis (LDA). In further embodiments, the machine learning is configured to perform the classification task using one of logistic regression, soft Regression, decision Tree, random forest (RF), and an artificial neural network (ANN). For example, the machine learning algorithm is configured to perform the regression analysis using one of linear regression, gradient descent, polynomial regression, regularized linear model, ridge regression, lasso regression, and support vector machine (SVM).

Now making reference to FIG. 1E which illustrates the flow control system 33, the screws 31, 32 drive the fluid flow in the microfluidic chip 100 by putting pressure on or releasing pressure off of a membrane 34 (also referred to herein as a suction membrane or suction cup). The membrane 34 is in fluid communication with the outlet 107 of the microfluidic chip 100. The membrane 34 is a flexible membrane preferably made of elastomers such as PDMS and photo-curable resins (such as methacrylates) and the like. Preferably, the elastomer is a 3D printable material. The membrane 34 is formed on a solid support 36 and houses a pocket of air 35 which is in fluid communication with the outlet 107. In some embodiments, the solid support 36 on which the membrane 34 is formed on is the surface of the microfluidic chip 100. In such embodiments, the membrane 34 is therefore part of the microfluidic chip 100. However, in other embodiments as described in greater details below, the membrane 34 can be separate from the microfluidic chip 100 and then brought in fluid communication with the outlet 107 before beginning the assay. Once a liquid sample enters the inlet 101 of the microfluidic chip 100, the air present inside the microfluidic channels and chambers, as well as inside the membrane 34 is sealed off from the external environment, which allows the membrane 34 to controllably drive the fluid flow using the air pressure inside the microfluidic channels by contracting or expanding. The contraction or expansion of the membrane 34 is driven by a mechanical actuator 38 which may be a screw 31,32 having indentation 39 that fits within a supporting structure such as the outlet apparatus 30. As illustrated in FIG. 1F, the mechanical actuator 38 is not necessarily a screw and can be any suitable alternative structure that can provide a controlled pressure on the suction membrane. The ease of actuating the screw in an autonomous manner is a reason why the screw is a preferred embodiment.
. . . generally include electrical detection from AMMED

In some embodiments, as illustrated in FIG. 1G, the suction membrane can be positioned below the microfluidic chip. The suction membrane 34 can be part of the microfluidic chip 100 or can be part of the detection apparatus and is therefore supported on a solid support 36 that provides fluid communication through a hole 37 to the outlet 107. Such embodiments allow the membrane to be larger as its size does not need to depend on the size of the microfluidic chip. This can allow a single membrane to control a microfluidic chip having a significant number of microchannels (e.g. 24 or 96).

As illustrated in FIGS. 1H and 1I, the suction membrane 34 can be supported on a surface 36a of a solid support 36 which has an opposing surface 36b that reversibly adheres to the bottom surface 108 of the microfluidic chip. In one example, the surfaces 36b and 108 adhere through magnetism. In another example, the surfaces 36b and 108 have a three dimensional structure that fit into each other mimicking a lock and key geometry. Regardless of the means to adhere the surfaces 36b and 108 it is essential that this reversible adhesion be hermetic such that a closed environment is formed between the air pocket 35 and the outlet 107. In one example, as illustrated in FIG. 1I, a gasket 36b with a magnetic 36c underneath comes into contact with the bottom surface of the microfluidic chip.

As explained above and also in greater details below, the suction membrane allows for a bi-directional flow which can be leveraged to pass the sample from the incubation chamber 103 to the sensing chamber 105 back and forth multiple times for multiple timepoint measurements. As illustrated in FIG. 1J, bacteria, debris or other solid components 109 that interfere with the colorimetric detection are retained by the filter barrier 104. FIG. 1J illustrates a three dimensional flow of the flow rather than a two dimensional liner flow across the filter barrier 104. Both embodiments are possible but when operating a bidirectional flow the three dimensional flow as illustrated in FIG. 1J is preferred to reduce the risk of clogging the filter barrier (by retaining the debris below the filter barrier). Additional details are provided herein below particularly in Example 2.

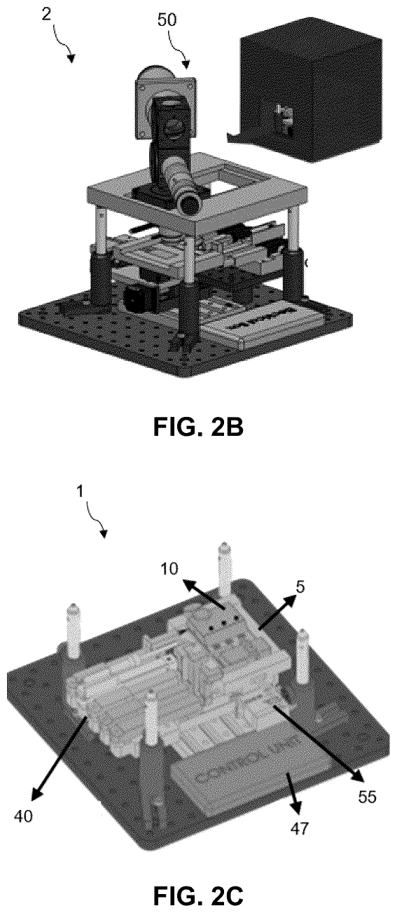

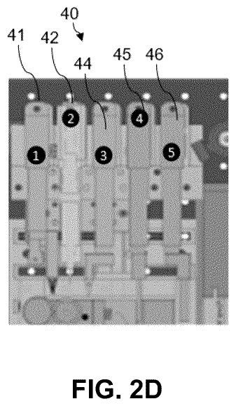

In one exemplary embodiment, the automated setup of the present system comprises of two modules, a microfluidic module (named microfluidic cartridge 10) (FIG. 2A); and an imaging module (named light detection apparatus 50) (FIG. 2B). FIG. 2A shows a schematic representation of an exemplary microfluidic cartridge 10 designed to aid in the automation of the process of sequential steps in a LAMP assay. FIG. 2A shows an embodiment where a lid 25 is included to close the receptacle 21. A lysis chamber 22 houses the lysis reagents and is fluidly connected to the receptacle 21. A lysis vent 26 can also be included for venting after lysis. The lysis can be performed in the receptacle 21 or in another vessel of the inlet apparatus in fluid communication with the receptacle. Accordingly, in this embodiment the lysis of the sample is performed in the inlet apparatus and before the sample reaches the microfluidic chip 100. FIG. 2A also illustrates a vent 27 connected to the storage chamber 23 for venting of the storage chamber 23 and allowing the entry of its contents into the microfluidic chip 100. FIG. 2B shows a schematic representation of an exemplary colorimetric detection device 2 following the collection of the sample, the microfluidic cartridge 10 is placed in a portable setup. This exemplary portable setup houses the imaging module, the cartridge holder which is mounted on an x-y translation stage for scanning the detection chambers, components of automation (majorly linear actuators), and a central control unit housing the microcontrollers. The imaging setup is an epi-illumination setup designed on reflected light microscopy principles and is named portable reflected-light imaging setup with controlled epi-illumination (PRICE). FIG. 2C shows an exemplary embodiment of the microfluidics cartridge inside the colorimetric detection device. The controller 47 of the actuator motor 40 is shown. FIG. 2D shows the actuators 41, 42, 44, 45, and 46 in an exemplary embodiment connected to the actuator motor 40.

A true point of care colorimetric nucleic acid testing device, analogous to qPCR, that employs RT-LAMP and RCA to amplify nucleic acid (RNA and DNA) in one step at a steady temperature was achieved which quantifies the presence of nucleic acid biomarkers via the color reading of the media. Unlike most commercialized technologies and those under research that employ fluorescent read-outs, the present system can combine a label free and easily adaptable colorimetric read-out with a multiplexed microfluidic sample preparation and delivery system. The core principle of the colorimetric readout is based on the plasmonic induced enhancement of nucleic acid amplification generated on the surface of a novel integrated nanostructured fluidic platform, which provides ultrasensitive and quantitative detection of low concentrations of nucleic acids in non-manipulated body fluids. When subjected to light, plasmonic surfaces inject electrons into the assay media resulting in plasmonic catalysis and enhanced amplification rate (less than 10 minutes). This plasmonic amplified color change of the media is observable with the help of a bright field microscope or simply the naked eye, obviating the need for complex equipment or trained personnel. The integration of the nano-plasmonic components with microfluidic sample preparation and delivery allows for multiplexed testing, limited sample/reagent consumption, and ease of automation and operation by untrained personnel.

The fabrication of the microfluidic cartridge is described in detail in the Example section below. Nevertheless, in brief, first, a lithography step is carried out to transfer the heater (e.g. width: 400 μm), and pad (e.g. length: 5 mm, width: 2 mm) features to a photoresist layer through a photomask with the desired patterns. This is followed by a buffered oxide etch to remove native oxide and a potassium hydroxide etch for a 200 nm silicon etch. Next, a lift-off process for selective deposition of the heater elements in the etched grooves is carried out. This starts with a second lithography step followed by an electron-beam deposition of for example 240 nm aluminum. Accordingly, the lift-off is completed by submersion in suitable remover. Next, the last lithography step is carried out to pattern the fluidic device features including inlet/outlet ports (e.g. ¢ 2 mm), lysis chamber (e.g. length: 1.74 mm, width: 1.5 mm, depth: 50 μm), mixing channels (e.g. width: 200 μm, height: 50 μm), and plasmonic window (e.g. length: 1.94 mm, width: 1.5 mm, height: 50 μm) into a SU-8 layer (for example SU-8 2050). Subsequently, the wafer (e.g. 6-inch) is diced into individual chips (e.g. length: 26.5 mm, width: 35 mm) using a dicing saw.

### Example 1

The pathogen detection system developed in the present example has three major steps, (i) sample collection from the user, (ii) amplification assay, and (iii) image capture and data analysis. In the first step, the user spits into the saliva collection funnel (as shown in FIG. 2A) on the microfluidic cartridge until the saliva fills up to the specified level. The user then covers the saliva inlet by closing a sliding door above the inlet. Following this, the user opens the sliding door and places the microfluidic cartridge on a stage inside the imaging box FIG. 2B. The user then connects to the system via a mobile application and starts the system. A concerted effort between different components inside the box facilitate all the key assay steps namely, (a) sample lysis, (b) mixing with amplification reagents, (c) heating for amplification reaction. Once the assay is completed, the colorimetric endpoint is imaged, and data is analyzed. The results are then transmitted to the user's mobile application.

The portable reflected-light imaging setup with controlled epi-illumination (PRICE) has two main important modules, (i) an illumination module and (ii) an image capture module. To implement the illumination module, a Koehler illumination optical train was mimicked with off-the-shelf optics. A 5000K 90CRI LUXEON™ LED (Lumileds™ Inc.) was used as the primary illumination source. To collimate the LED, a diffusive aspheric condenser lens (d=25.4 mm, f=20.1 mm, Thorlabs™) was used. A ring-actuated iris diaphragm (Thorlabs™) was used as a field diaphragm with aperture diameters ranging from 8 mm (minimum aperture opening) to 12 mm (maximum aperture opening). The collimated light was then illuminated on the back of an achromatic doublet lens (d=25.4 mm, f=30 mm, Thorlabs™), creating an imaging at the focal length of the lens. A ring-actuated iris diaphragm (Thorlabs™) was used as an aperture diaphragm with aperture diameters ranging from 8 mm (minimum aperture opening) to 12 mm (maximum aperture opening). Finally, the image of the light at the aperture diaphragm is collimated by an achromatic doublet lens (d=25.4 mm, f=30 mm, Thorlabs™). The collimated light is then projected onto the back aperture of the objective (TU Plan Fluor EPI 20×, N.A. 0.45, W.D. 4.5 mm, Nikon™ Inc.) via a beamsplitter (Reflectance: Transmittance—30:70, d=25.4 mm, Thorlabs™) placed at an angle of 45 degrees with the vertical. The reflected light from the sample placed the working distance was collected by the objective. Since the objective was infinity focused, a condenser lens (tube lens, f=200 mm) was used to project the image onto the CMOS sensor (Sony™ IMX477R, 12.3 MP, Raspberry Pi Inc.).

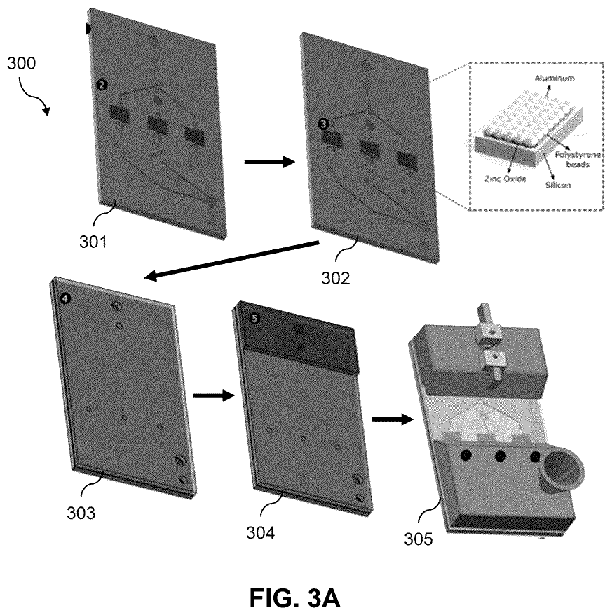

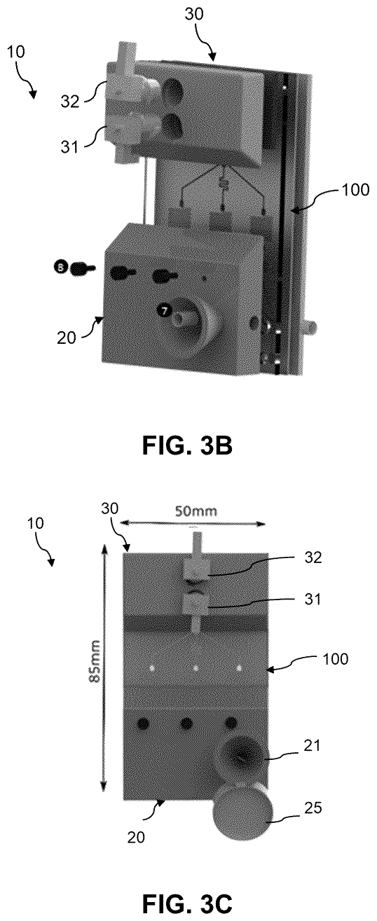

The microfluidic cartridge of the present example has two major modules, (i) a cleanroom fabricated microfluidic chip and (ii) a 3D printed fluid handling attachment. Together these two modules enable the integration of sample collection, sample lysis, reagent mixing and amplification steps as a single platform. All the microfluidic chip and the cartridge components were designed using AutoCAD™ and SolidWorks™ software. The fabrication process 300 is shown in FIG. 3A. The first step 301 of the fabrication process is the patterning of the fluidic channels (400 μm width and 50 μm thick) using UV photolithography process. A lithography mask was designed to pattern a 50 μm thick SU-8 layer (SU-8 2050, MicroChem Corp., MA, USA) on a silicon substrate via a straightforward lithography process. In the second step 302, the color sensitive platform was fabricated using a fabless nano-patterning technique. Briefly, a generic approach was used to develop a colloidal self-assembly monolayer (SAM) of nanoparticles at a water/air interface. Next, the resulting hone-comb structures are transferred to the Si substrate. Subsequently, a ZnO thin film (120 nm) was deposited as a low dielectric constant back reflector. Last, a thin aluminum layer (10 nm) was deposited to provide a tunable localized surface plasmon resonance with a white background. The inset shows the various materials involved in the fabrication of the color sensitive platform. In the next step 303, a thin polydimethylsiloxane-PDMS layer (10:1, PDMS SYLGARD™ 184 silicone elastomer, Dow™ Consumer Solutions, QC, Canada) was punched with holes at channel inlets. The punched PDMS layer was plasma treated for 40 sec at maximum power (Harrick™ Plasma cleaner, PDC-32G (115V), 18 W). This surface activated PDMS layer was bonded to the SU-8 fluidic layer to create closed microfluidic channels. Next, at step 304, PDMS based suction cups layers (including a PDMS membrane under each suction cup) were fabricated using stereolithography (SLA) printed molds. This suction cup layer was bonded to the fluidic-PDMS layer by plasma treatment for 40 sec at maximum power. Finally, at step 305, the stereolithography (SLA) 3D printed cartridge (printed at 50 μm resolution with the Form 3, Formlabs™, USA) was bonded to the PDMS covered microfluidic chip using a double-sided tape conducive to plasma activated bonding (treated at maximum power for 40 sec and placed in 95° C. for 90 min). FIG. 3B shows the exploded view of the microfluidic cartridge showing multiple components and FIG. 3C shows the top view of the microfluidic cartridge. The saliva slider is used to seal off the inlet once the saliva is collected. The brass metal inserts are employed for lysis of the sample. Small screws are used to seal-off the inlets (in the printed cartridge) used for reagent loading. The components are 3D printed screws for actuating the suction cups by applying a small lateral force during automation, resulting in a negative pressure gradient and subsequent flow of liquid from the inlets.

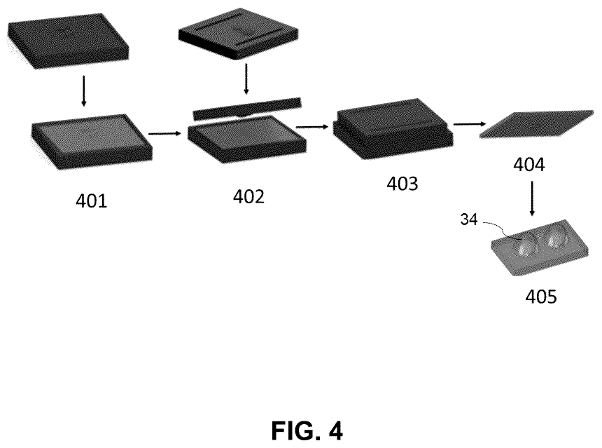

In this example, 3D printed molds were used for the fabrication of suction cups with PDMS. SolidWorks™ software was used to design the master mold. A high resolution SLA 3D printing (Form 3, Formlabs™, USA) was employed at a layer thickness of 25 μm in the z-axis as per the company's specifications. The post-printing treatment included a wash in isopropyl alcohol (IPA) for 20 min followed by drying and ultra-violet (UV) curing at 60° C. for 20 min. Once the curing was done, the supports were removed. The master mold had two components, male and female molds. Before proceeding to pour PDMS for molding, the 3D printed parts were surface treated to avoid curing inhibition at the PDMS-mold interface. The fabrication of the suction cups is shown in FIG. 4. The 3D printed master mold post curing is first heated at 130° C. in oven for 4 h, following by an air plasma treatment (Harrick Plasma cleaner, PDC-32G (115V), 18 W) for 3 min. The molds are then treated with 10 μL trichlorosilane (Sigma Aldrich) in a vacuum desiccator overnight. Finally, as per step 401, the PDMS-curing agent mixture in the ratio of 10:1 (PDMS to curing agent ratio), is poured into the female mold. The male mold fits tightly onto the female mold via the guides at the corners (step 402). The male mold has vertical openings to accommodate the overflow of excess PDMS upon insertion into the female mold. The mold combination is then placed in the oven at 65° C. overnight for curing step 403 and finally the cured PDMS suction membranes 34 are obtained 404, and then cut 405 to the desired dimensions.

All the 3D printed components were designed with SolidWorks™ software and fabricated using a SLA 3D printer (Form 3, Formlabs™, USA) at a layer thickness of 50 μm in the z-axis as per the company's specifications. The post-printing treatment included a wash in isopropyl alcohol (IPA) for 20 min followed by drying and UV curing at 60° C. for 20 min. Once the curing was done, the supports were removed. Following this, the collection funnel, lysis funnel, and reagent storage chambers housed in the 3D printed fluid handling attachment, were coated with epoxy resin (Artresin™, Canada) to make the surface biocompatible. Finally, a hollow biocompatible aluminum insert (McMaster-Carr™ Inc, Canada) was incorporated into the 3D printed fluid handling attachment as the lysis chamber.

The automation module had three main components, (i) Linear actuator system, (ii) Heating module, (iii) x-y translation stage and (iv) Imaging and data processing module. Two main microcontrollers were used here, Arduino UNO (Arduino Inc.) and Raspberry Pi 4 (Raspberry Inc.). The Arduino was employed to control components (i), (ii), (iii), (iv) and the Raspberry Pi controlled the imaging and data processing module. Five linear actuators (Actuonix™ Inc.) were employed to facilitate sequential fluid handling steps. This detection platform requires heating for the lysis and amplification steps of the assay, to facilitate this employed two heating components, a portable solder iron (TS-100) for saliva lysis and ceramic thermal heater (Bolsen™ Tech Inc.) for LAMP reaction at 65° C. The two heating elements were controlled with a two-channel relay module (Yizhet™ Inc.). As previously mentioned, here a multiplexed approach with three detection chambers was used. Hence it was needed to have a x-y translation stage to scan and image across multiple intra-chambers as well as inter-chamber regions. To realize this a linearly guided computer numerical control (CNC) stage that was driven by a stepper motor (FUYU™ Inc.) was employed for stage movement in x-direction, with a guide length of 50 mm and a resolution of 0.25 mm. To move the chip in y-direction a single axis manual translation stage was used (Edmund Optics™ Inc.) attached to a 3D printed holder that firms the microfluidic cartridge in place. The screw head of this y-axis translation component was controlled by a knob attached to a continuous servo (SPT digital, SPT5325LV). The image once captured by the CMOS sensor was captured and analyzed on-board the Raspberry Pi 4. Finally, the results were transmitted and communicated via a mobile application created with MIT App inventor.

The RT-LAMP assay employed in this example used the primer set against the ORF1ab gene obtained from Sigma-Aldrich™, USA. The individual oligonucleotide concentrations of the 10× primer mix were, 0.2 μmol/L of forward outer primer, 1.6 μmol/L of forward inner primer and backward inner primer, 0.4 μmol/L of forward loop primer and backward loop primer. The primer mix was mixed with WarmStart™ Colorimetric LAMP 2× Master Mix (NewEngland Biolabs™, MA, USA), and RNase free water (Thermo Fischer Scientific™, MA, USA). The standard reaction volume was 20 μL that consisted of 2 μL 10× primer mix, 10 μL 2× master mix, 7 μL RNase free water, and 1 μL synthetic SARS-COV2 RNA (VR-3276SD ATCC, VA, USA) sample. The samples were incubated at 65° C. for different periods to visualize color change versus time for different samples.

A pressure driven flow induced by suction cups was used to enable fluid flow with minimal user involvement. The suction cups act as actuators on the flexible membrane to control the air pressure and thus the fluid flow in the microfluidic channels. The key features of an amplification assay are, (a) discrete sequential steps involved in the assay, and (b) metering of fluids involved (sample and reagents). To expand, the sequential steps in a typical amplification assay (i) sample collection, (ii) sample lysis, (iii) mixing with amplification reagents (in a fixed volumetric ratio), (iv) amplification reaction, and (v) end point detection. Three key technologies were leveraged to enable integration of all these sequential steps on to a single microfluidic cartridge, they are, (1) mechanically actuated suction cups, (2) microfabrication, and (3) additive manufacturing. The suction cups facilitate power free, userless fluid flow manipulation via mechanical actuating with a 3D printed screw-nut like setup. Microfabricated silicon-based chip housed the channels and chambers required for mixing, amplification, and detection steps. Additive manufacturing (i.e. 3D printing) enabled fabrication of a 3D printed fluid handling module that is coupled with the silicon microchip. This fluid handling module houses sample collection, sample lysis, reagent storage and suction cup actuation components.

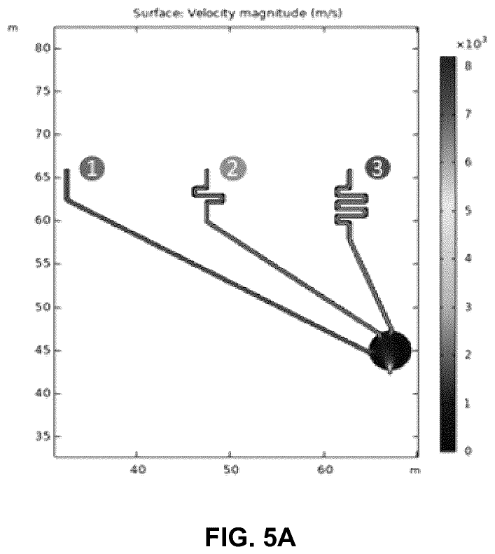

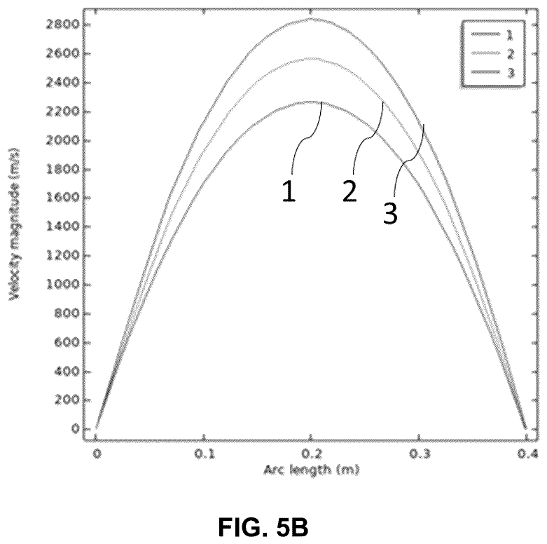

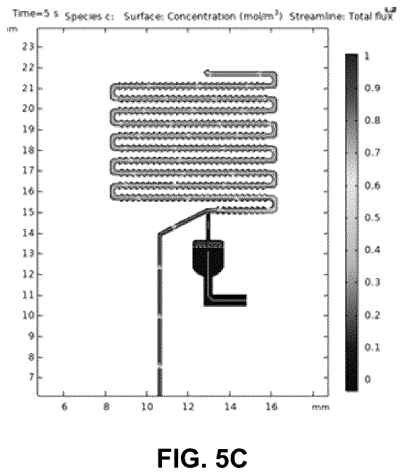

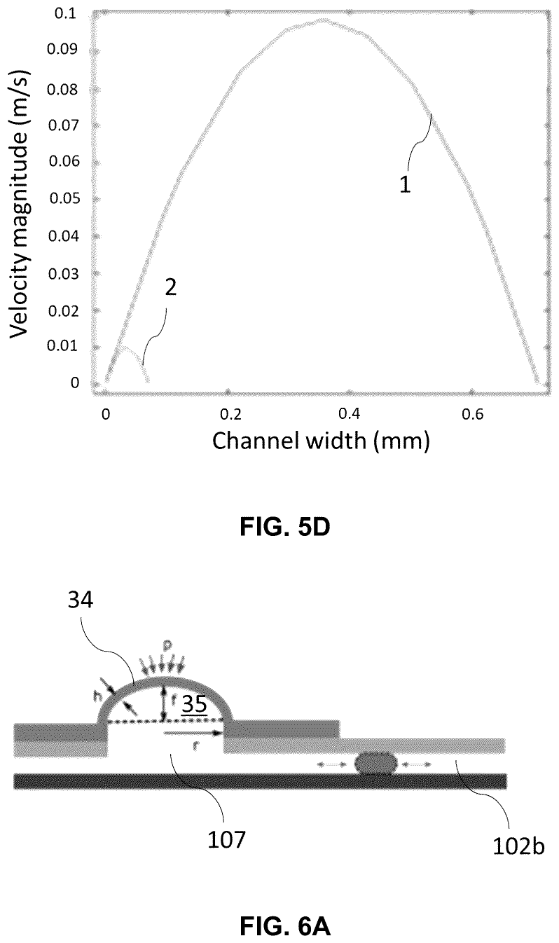

One of the key technologies in the integration of all the assay steps onto a microfluidic cartridge is microfabrication. SU-8 microchannels were used to enable fluid handling. COMSOL™ simulation methods were employed for designing the microfluidic chip. One key requirement was the mixing of lysed saliva sample with the reagents in the volumetric ratio of 1:10. To execute this, a Y-junction mixing followed by a serpentine channel was used to ensure complete mixing. The area of cross section of all the channels was the same, the channel widths were manipulated to ensure a flow rate ratio of 1:10. The right combination of channel widths was arrived at by using 2D COMSOL™ simulation, modeled at creeping flow conditions. The central idea was that the area of cross section of the channels was the same and the widths were manipulated to change the overall volumetric flow rate. The change of widths ultimately effects the distribution of the negative pressure produced by the suction release. Given the multiplexed nature of the proposed system the lysed sample should be distributed into the channels leading up to mixing module. Considering the design requirements for the automation, a pressure distribution simulation was performed to ensure uniform pressure distribution (FIGS. 5A-5B). In addition to this, the mixing module was simulated to ensure perfect mixing over the length of the serpentine (FIGS. 5C-5D).

The PDMS based suction cups were employed to drive the fluid flow with no user involvement or expensive external equipment (like syringe pump, peristaltic pump). The suction cups and the membrane work on the principle of air displacement giving rise to a negative pressure in the microfluidic channels thereby inducing fluid flow along the pressure gradient.

The volume of liquid that can be moved/pumped by the suction cup and membrane is dependent on the volume of air displaced upon compression of the membrane. A mechanical actuation system with a nut and screw mechanism was used herein to apply the pressure on the membrane. However, other actuation systems would be also suitable and the present disclosure is not limited to a nut and screw mechanism. In the context of fluid flow in microchannels, it is important to employ suction cups and membranes that can precisely pump desired volumes. However, the mechanical actuation system is prone to having residual volume when the cup is pressed down. Hence, correlating the experimental suction membrane volume to the theoretical volume is important to account for the residual volume. Specifically, the effect of mechanical actuation in the current system on the residual volume. Initially the suction membrane is assumed to be a hemisphere, hence the initial volume (Vin) is given by

$${V}_{in} = \frac{π}{6} * {d}^{2} * {f}_{max} \qquad ( 1 )$$

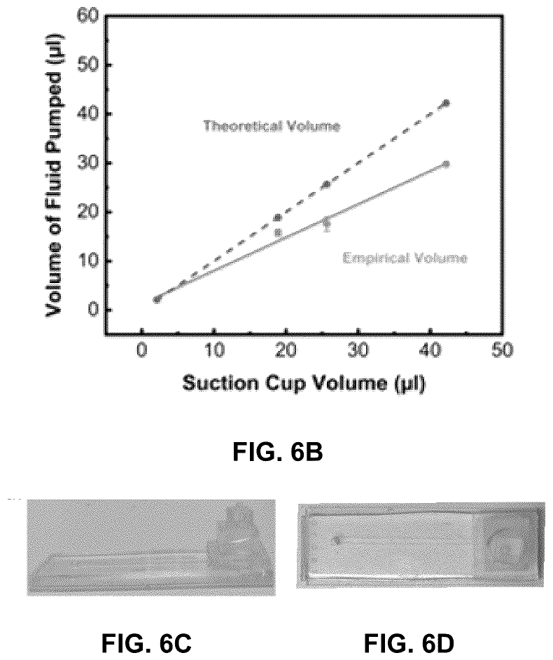

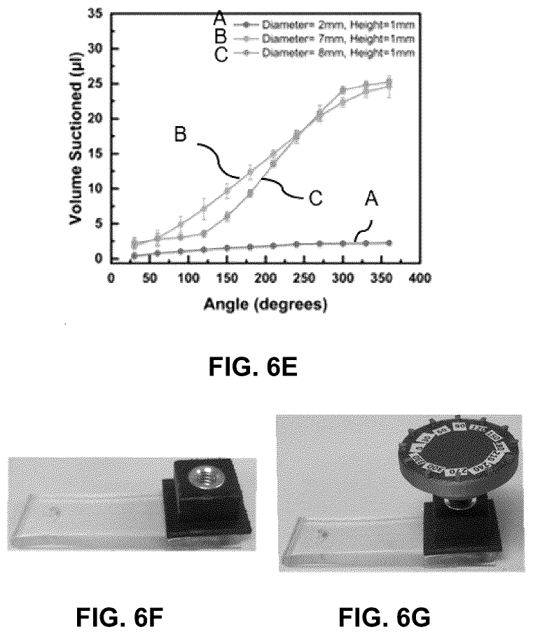

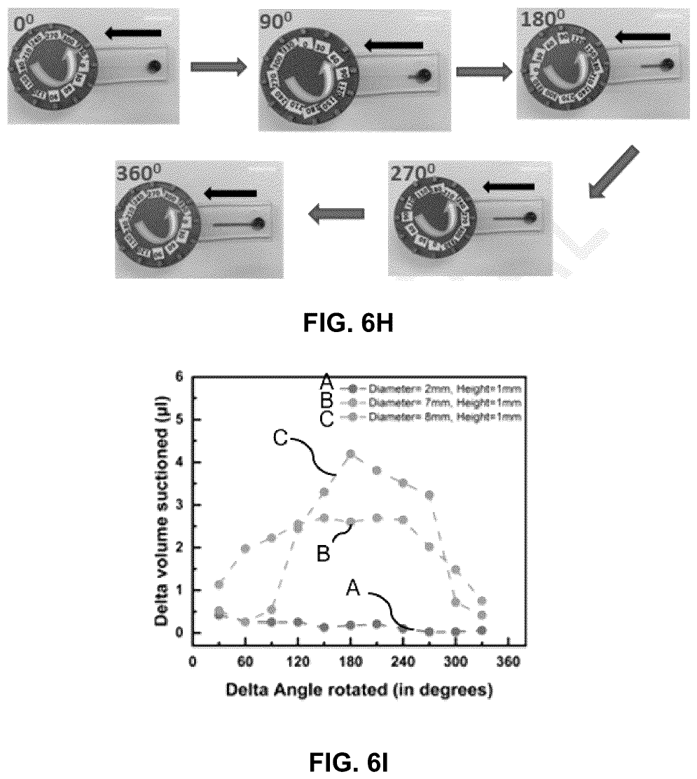

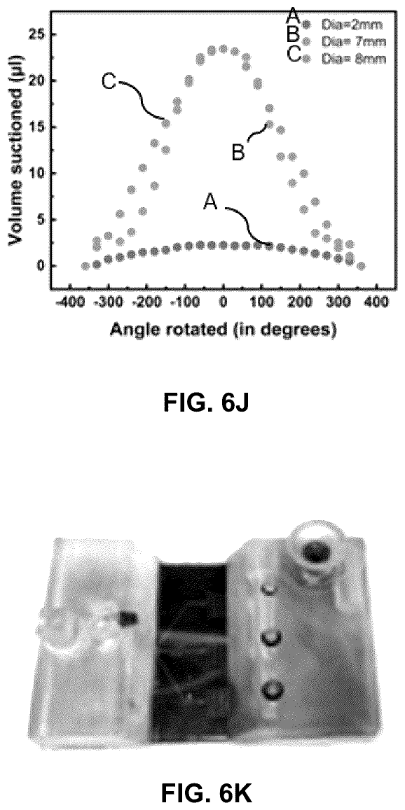

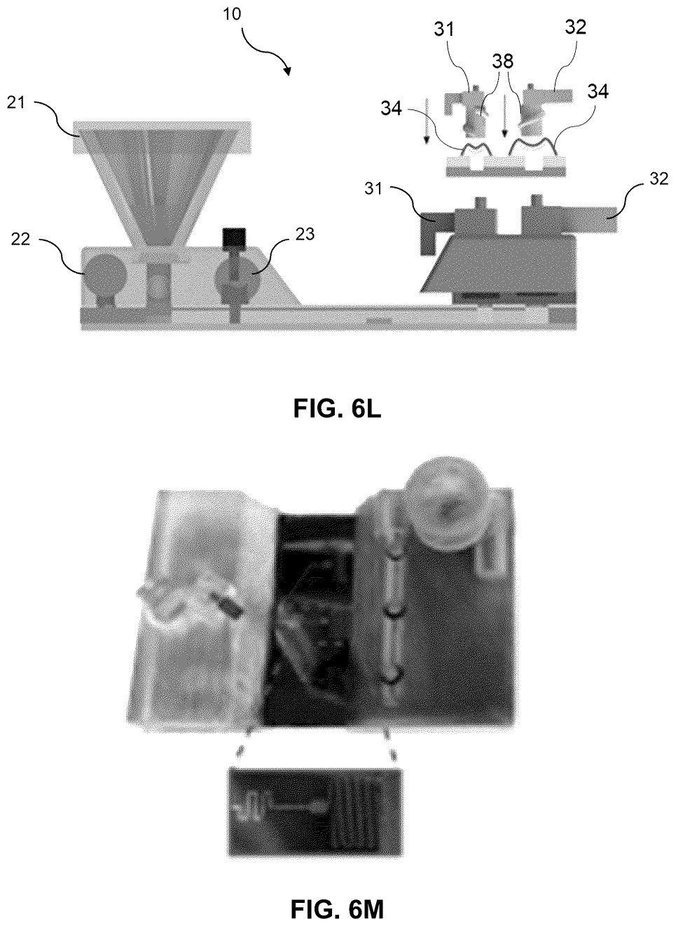

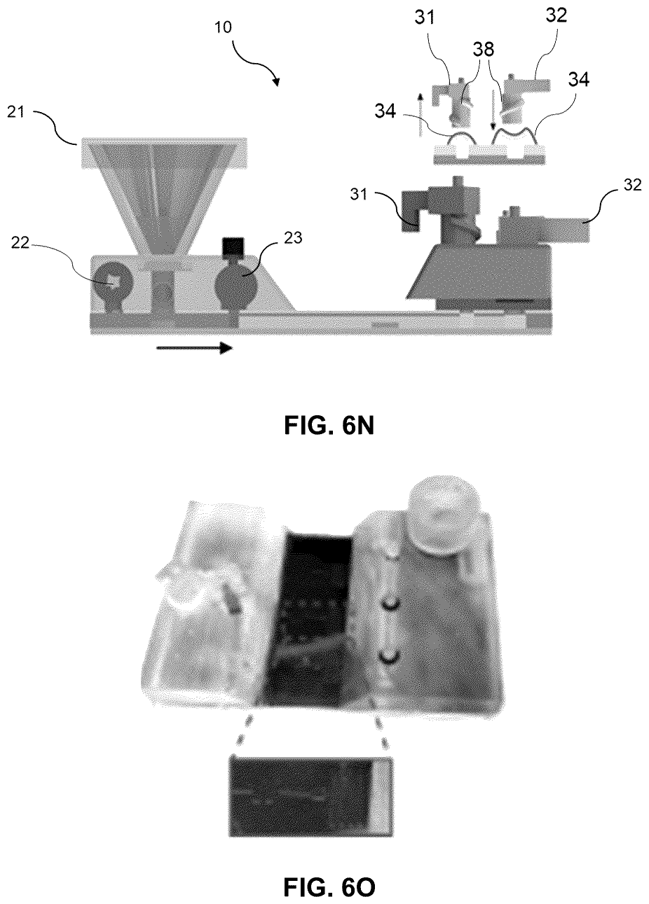

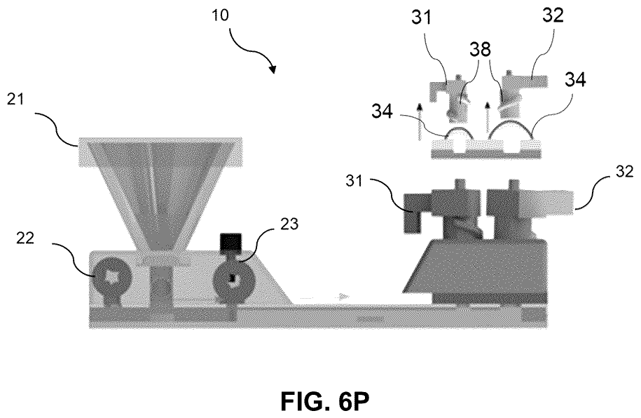

In equation 1, d is the diameter of the suction membrane 34 and h is the central height of the hemisphere (FIG. 6A). The suction membranes were fabricated using SLA printed mold (FIG. 4). The lysed saliva sample was suctioned to the mixing junction. A key design criterion was that the suction membrane volume correlated to the volume of the fluid suctioned. The volume of microchannels up to this point was calculated to be 3.4 μL. Following this, the lysed sample with amplification reagents were provided at a volume ratio of 1:10. The volume of serpentine mixing channel and detection chambers cumulatively resulted in a volume of 8.3 μL. Hence correlating the theoretical volume (actual volume) of the suction membrane given by equation 1 should be correlated to volume of fluid suctioned with the mechanical actuation setup with the suction cup. The mechanical actuation of the suction cups was carried out using a 3D printed screw-nut system, which exerts a normal force of around 11N on the suction membrane (FIG. 6B). FIG. 6B shows the correlation between the theoretical volume of the suction membrane to the volume of the fluid suctioned when actuated with the 3D printed screw-nut system employed (FIGS. 6C-6D). It can be interpreted that the mechanical actuation affects the residual volume in the suction membrane which in turn affects the empirical volume of fluid pumped. From FIG. 6B it is evident that the volume of fluid suctioned deviates from the theoretical volume, this can be attributed to the fact that there is residual volume when a mechanical actuation system with a screw-nut type setup is used. It is also interesting to note that the volume of the fluid suctioned follows a linear trend (FIG. 6B). The linear trend profile equation was used to accurately design the suction cups and membranes for the desired volumes based on the microchannel size and total volume in the microfluidic chip.

It was further built upon the effect of mechanical actuation on the volume of fluid suctioned. It was hypothesized that the volume of fluid suctioned/pumped (Vₚ) can be varied by manipulating the deflection of the PDMS suction membrane (FIG. 6E). This volume, Vₚ, is controlled by the mechanical actuation of a screw and nut system (FIGS. 6F-6G). The central idea revolves around the concept that the volume, Vₚ, can be controlled via fine threaded screws mechanically pressing on the suction membranes. For each rotation, the screw moves a distance equivalent to the pitch which in turn manipulates the deflection of the suction membrane. This is demonstrated in FIG. 6H, where the screw head is rotated clockwise (CW) and counter clockwise (CCW) to pump fluid in and out of the channels in multiple cycles. The fluid pumping is depicted by the controlled mechanical actuation of the PDMS suction membrane. The tip of the screw exerts a perpendicular force on the suction membrane displacing/releasing the air underneath causing a pressure gradient conducive to fluid flow. The demonstration shows volumetric fluid metering based on the angle of the screw rotated in either CW or CCW directions, and thus a bidirectional flow was achieved. The volume of the spherical suction membrane is given by equation 2,

$$V = \frac{π f}{6} ( 3 {r}^{2} + {f}^{2} ) \qquad ( 2 )$$

Where V is the volume stored by the suction membrane, f is the deflection, r is the radius of the suction membrane (FIG. 6A). The deflection f is in turn a function of applied pressure and for silicone polymer (Poisson's ratio of 0.5) is given by,

$$\begin{matrix}f = ( \frac{9 {r}^{4}}{64 E {h}^{3}} ) p , & for f \leq h\end{matrix} \qquad ( 3 )$$

$$\begin{matrix}f = {( \frac{3 {r}^{4}}{16 E {h}^{4}} )}^{1 / 3} h {p}^{1 / 3} , & for f > h\end{matrix} \qquad ( 4 )$$

Here E is the elastic modulus of the chamber material, h is the chamber PDMS membrane thickness, and p is the loading pressure. These equations hold true only when 2r>h, which is the case in the present suction membrane. From equations, (2), (3) and (4), it can be inferred that volume of the suction membrane (v) varies cubically with loading pressure (p) in the f≤h and varies non-linearly in the regime f>h. The experimental results correlate with the theoretical profile showed in FIG. 6E. Specifically, it was demonstrated that the control of fluid flow with actuation varied in steps of 30° angle either CW or CCW. Different sizes of suction membranes (diameters (d)—2 mm, 7 mm, 8 mm and height (h)—1 mm) were employed to demonstrate this controlled flow actuation. Given the pitch of the screw used was 1.4 mm (distance moved by the screw in 1 full rotation), the volume suctioned plateaus after 300° of rotation.

The delta volume suctioned is given by first order differential of the equation (4), as follows

$$\frac{d V}{d f} = \frac{π}{2} ( {r}^{2} + {f}^{2} ) \qquad ( 5 )$$

This equation 5 shows that change in suction membrane volume (i.e. volume of fluid suctioned), is in quadratic relationship with the deflection of the membrane. The experimental results are in correlation with this since a parabolic profile was obtained. In other words, the angular control allows for precise manipulation of the fluid volume in the microchannel. By incorporating this screw-nut actuation system with a screw of pitch of 1.4 mm, it was demonstrated that the pumping of fluid volumes as low as 0.1 μL can be done (FIG. 6I). This process of fluid pumping into the channel was found out to be in correlation with the fluid pumping out of the channel in one full cycle (FIG. 6J).

The silicon based microfluidic chip was bonded to the 3D printed attachment to facilitate automation of all the assay steps. More specifically, the 3D printed attachment houses sample collection, sample lysis, reagent storage and suction membrane actuation components (FIGS. 6K-6P). The sequential steps involved in the operation of the cartridge to carryout lysis and metered reagent mixing are shown in FIGS. 6K-6L. One key technology driving this process is 3D printing, more specifically, high resolution, micron thick 3D printed membrane. In the first step, FIGS. 6J-6K the amplification reagents were loaded into the reagent storage chambers with the suction membranes in pressed state and the saliva is collected in the funnel for lysis and the saliva inlet was sealed off with a tightly sealed lid. Then, as shown in FIGS. 6M-6N, once the lysis step was completed, the saliva channel was vented by breaking the membrane 22 and the first suction membrane 34 was released from the compressed state by lifting the screw 31. Finally, as shown in FIGS. 6O-6P, once the saliva reached the Y-junction of the mixing channel, the second membrane 23 was broken, exposing the reagent inlets to the atmosphere. The second suction screw 32 released the suction membrane 34 by relieving the pressure on the suction membrane 34 causing the lysed saliva and reagents to enter the mixing channel.

The sequential nature of the amplification assays requires the amplification reagents mixing with the sample only after the lysis. To facilitate this, the amplification reagents are stored on the cartridge in the storage chambers. The chambers are sealed off from atmospheric pressure, to impede the amplification reagents from entering the serpentine mixing channel before the flow of the lysed saliva to the y-shaped mixing junction. To realize this, high resolution of SLA 3D printer was leveraged to print membranes in the order of microns in thickness. These rupturable membranes, upon breakage, cause the atmospheric venting leading to the flow of the reagents to the Y-junction and subsequent mixing with lysed sample. In the final step of automation, this membrane breakage step is executed with a linear actuator with sharp tip. Hence the thickness of the membrane plays an important role, as the force required for breaking the membrane should be a value that can be executed by the tip of the linear actuator.

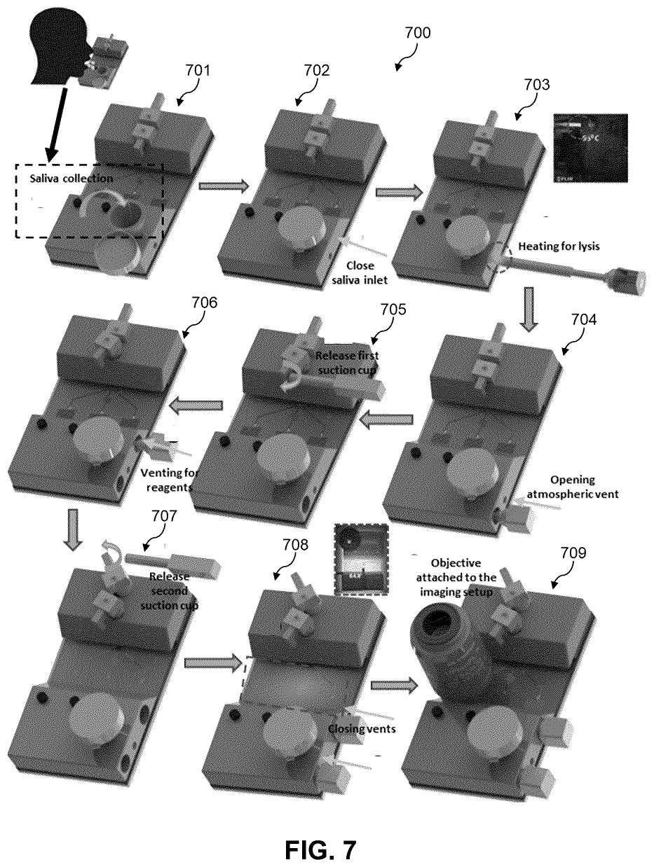

FIG. 7 shows the detection method 700, in step 701, the user spits saliva in the funnel on the 3D printed cartridge. The inlet is then closed by covering the inlet with a slider to mitigate evaporation 702 secured by the friction between the parts. In the next step the sample is heated to 95° Celsius by a heating element in contact with metal inserts 703 which in turn are in direct contact with the saliva sample. The closing lid helps mitigate the sample evaporation during heating step. Once the lysis step is done, the saliva inlet is exposed to atmospheric pressure (venting) via breaking 704 of a 100 micron thick membrane which results in the exposure of the saliva inlet to atmospheric pressure. Following this, the first suction membrane (in compressed state) is released 705 resulting in a negative pressure in the channels, allowing the saliva to flow to the mixing Y-junction. The volume of the suction membranes was calculated based of the volume of liquid desired in the channels as described above. Next, the amplification reagents stored are vented to atmospheric pressure by breaking a 100 μm thick 3D printed membrane 706. Once this venting is completed, the second suction screw releases the compression on the second suction membrane 707 resulting in a negative suction pressure enabling the mixing of lysed sample and amplification reagents via a Y-junction followed by a serpentine channel and reaches the detection chamber. Both the vent openings in the 3D printed cartridge are closed to mitigate evaporation 708. The detection chamber is then heated to 65° Celsius for 10 min to enable the amplification reaction 708. Following the amplification reaction, the detection chamber is imaged 709 and subsequently the images are analyzed, and results are communicated to the mobile phone application.

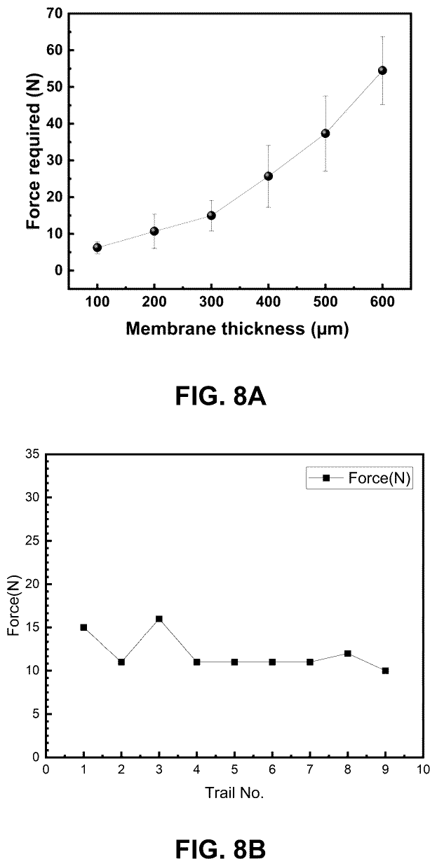

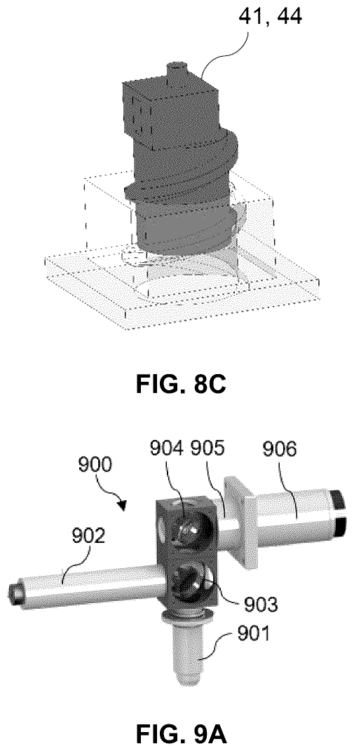

Rupturable membranes were fabricated at different thicknesses starting from 100 μm up to 600 μm. The rupturable membranes were then manually broken to evaluate the required force to inflict damage. It was found that an average force of 6.26N (FIGS. 8A-8C) was required to break a 100 μm thick rupturable membrane, which is within the limit range of force inflicted by an average human finger. Hence, it was hypothesized that this thickness would be ideal for application in an automated setup, owing to the requirement of minimal force.

The extent of mixing module was evaluated by employing image analysis of images captured by a microscope. The whole cartridge operation shown in FIGS. 6K-6P was carried out but with green dyed water which was used to simulate lysed saliva and non-dyed clear water was loaded into the reagent storage chambers as simulation fluid. Ultimately, it is desired to have the lysed saliva and reagent mix in the ratio of 1:10. In addition to this, mixing should be ensured to be sufficient in the detection chamber, where the amplification is carried out and the colorimetric change is recorded. To ensure that the mixing occurs in the desired ratio, a PDMS replicate of the exemplified microfluidic chip was used to capture the color of the final mixed liquid. Images of the detection chamber with the mixed liquid were captured. These images were then compared with images of the detection chamber taken when loaded with pre-mixed liquid (green dye to water in the ratio of 1:10). The green value of the RGB was the same for mixed liquid in the detection chamber (G=248) and the premixed liquid (G=243). Whereas the water filled channel have a green value of 183.

A portable reflected-light imaging setup with controlled epi-illumination (PRICE) was designed to capture the colorimetric change of the assay solution. In the current scheme of SARS-CoV-2 detection, the current platform was dubbed “QolorEX” and it enhanced the colorimetric change via plasmonic excitation. QolorEX is a nanostructured platform fabricated in cleanroom with deposition of multiple layers of metals. This platform elicits structure and material dependent-color upon irradiance of white light, extensively studied in the past and termed as plasmonic based coloring. These metallic surfaces are sensitive to illumination properties which could ultimately affect the colorimetric readout. Hence it was important to ensure to have a uniform, consistent, and controlled illumination and subsequently the use of PRICE as a replacement to a commercial brightfield microscope. The PRICE has two main modules (i) illumination module and (ii) imaging module.

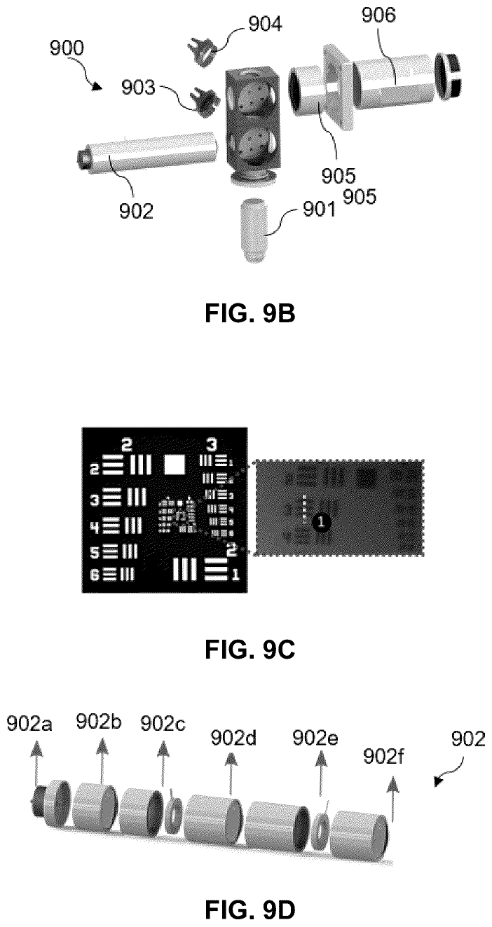

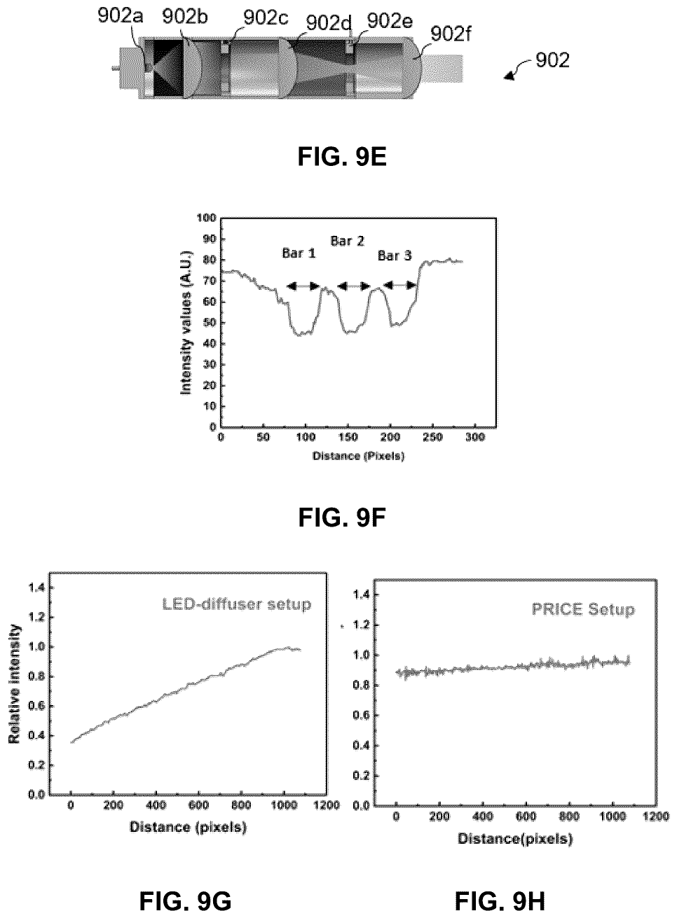

The light detection apparatus used in the present example is shown in FIGS. 9A-9B and is a combination of many different off-the-shelf optical components. The light detection apparatus or in this example the imaging module uses a 20× objective 901 as the condensing lens with the detection platform placed at the focal plane of the objective. An illumination column 902 provides light to the objective 901 with the beam splitter 903. The reflecting mirror 904 directs the light to the tube lens 905. The image of the detection platform is then focused onto the CMOS sensor 906 using the tube lens 905 of 200 mm focal length. Since it was intended to capture the color change on the detection platform, it is desirable to have a large field of view (FoV) while maintaining a high numerical aperture (determined by the objective). Using a tube lens 905 of standard focal length (200 mm) eliminated spherical and chromatic aberration while providing high FoV. A CMOS sensor 906 with a diagonal length of 7.9 mm was selected to maximize the FoV. Moreover, this combination of tube lens 905 with the CMOS camera 906 provided a digital magnification of 275× (calculated at a Field number (FN) of 22 mm) since the CMOS 906 only captures a part of the image created by the tube lens 905. The FoV and the resolution of the imaging module was characterized using a 1951 US Air Force (USAF) resolution target (FIG. 9C). The system could resolve the lateral lines in Group 7 Element 6, which yields a resolution of 228 lp/mm or 4.4 μm. Subsequently the field of view is also determined across the entire area of CMOS as 298 μm. The detection chamber size employed here approximately is, 1500 μm in the lateral direction, hence this FoV 298 μm would allow the complete imaging of the detection chamber in 3 scans of different inter-chamber regions while not losing crucial information.

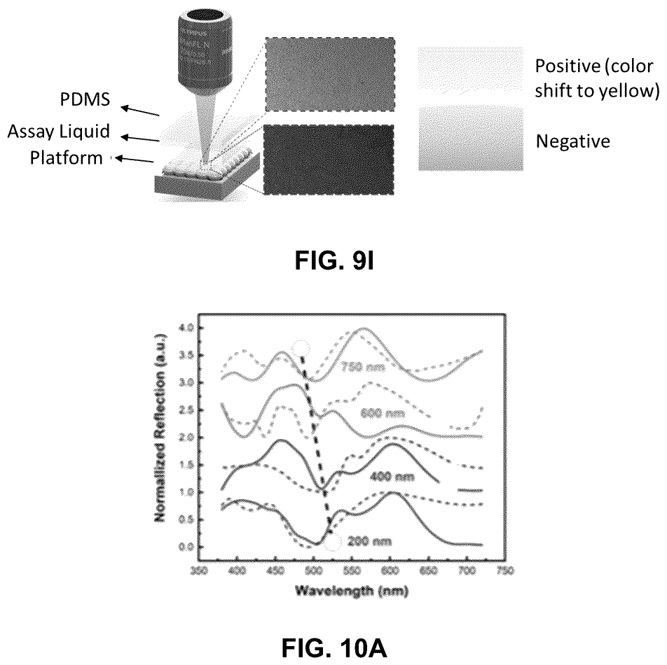

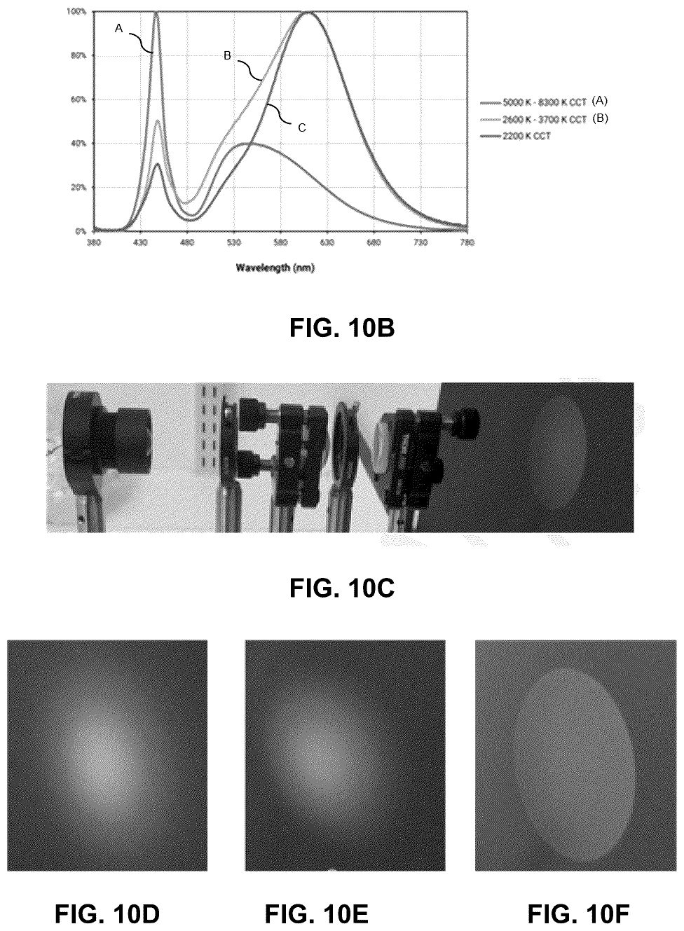

Ensuring uniform illumination is crucial for capturing accurate colorimetric reading. Having a controlled illumination column would also facilitate more control over the illumination parameters, specifically area of illumination and the intensity of illumination. One key issue with achieving uniform illumination is the diverging angle of irradiance of an LED. The 5000K LED employed in this example has a total viewing angle (defined as the angle from the LED centerline after which the luminous intensity drops to half of the maximum) of 60°. Among different illumination methods employed in standard microscopes, Koehler illumination is widely adopted owing to its illumination uniformity. Moreover, Koehler illumination setup is more resilient to external disturbances like dust and optical imperfections, making them suitable for imaging outside of controlled environments. These features also facilitate minimal variations in the images obtained by the camera over long and repeated cycles. Hence, a portable illumination column mimicking the Koehler setup would address the challenges with controlled illumination. Another point to note it that Koehler illumination is generally aimed at trans-illumination which works only for imaging translucent samples. In the present case, an epi-illumination is needed since the detection chamber is opaque in nature. The illumination column 902 is shown in FIGS. 9D-9E. A 5000K 90CRI LED 902a was placed at the focal plane of an aspheric condenser 902b with a diffuser. A diaphragm 902c is placed after the aspheric lens 902b that allows the control over the ‘area of illumination’ by controlling the radius of diaphragm 902c aperture opening. The collimated light is then focused an achromatic lens 902d that forms real image of the light source of a diaphragm 902e placed at the focal length of the lens. The aperture opening of this diaphragm 902e allows control over the ‘intensity of illumination’. In the final step, the real image comes out as a collimated beam of light after passing through another achromatic lens 902f placed at the focal length. Different LED and optics setup for illumination were first compared visually (FIGS. 10A-10F). It was evident from the results, visually, that the illumination column with PRICE offered a more uniform spectral profile. This was further validated by examining the uniformity of illumination by placing an aluminum sample at the focal plane of the objective and analyzing the intensity values of the image (FIGS. 9F-91). The differences in intensity for the PRICE setup varied only 17% whereas the regular LED-diffuser lens setup with an aspheric diffuser varied 65%.

The source of illumination is thus an important property that can have predominant effect on the final color captured and observed. The platform used herein, QolorEX, was characterized using UV-Vis spectroscopy to obtain the resonance wavelength (FIGS. 10A-10F). The 5000K LED employed for illumination has the spectral profile shown in FIG. 10B, with two intensity peaks in the wavelength interval of ˜430 nm-500 nm (narrower peak) and in the interval ˜550 nm-660 nm (broader peak). The majority of the intensity falls in the ˜430 nm-500 nm, which matched with the resonance wavelength of the platform. Color rendering index (CRI) is another important parameter and signifies the extent of closeness of colors revealed by the light source when compared with ideal lighting conditions. The LED has a specified CRI of 90, making it an ideal candidate for illumination.

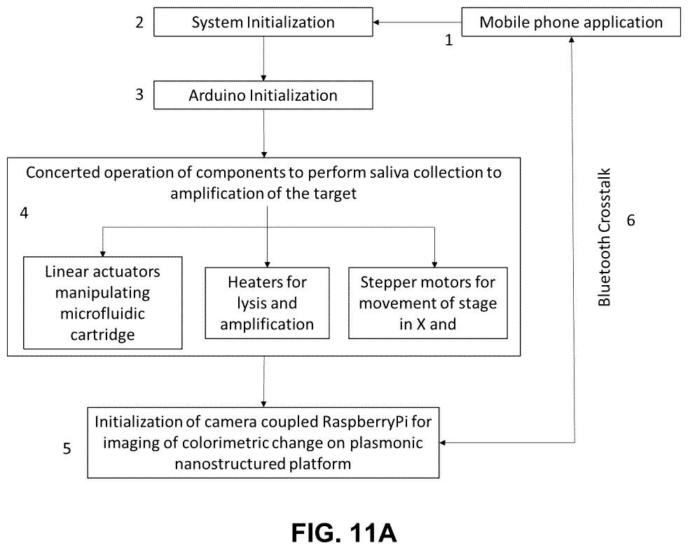

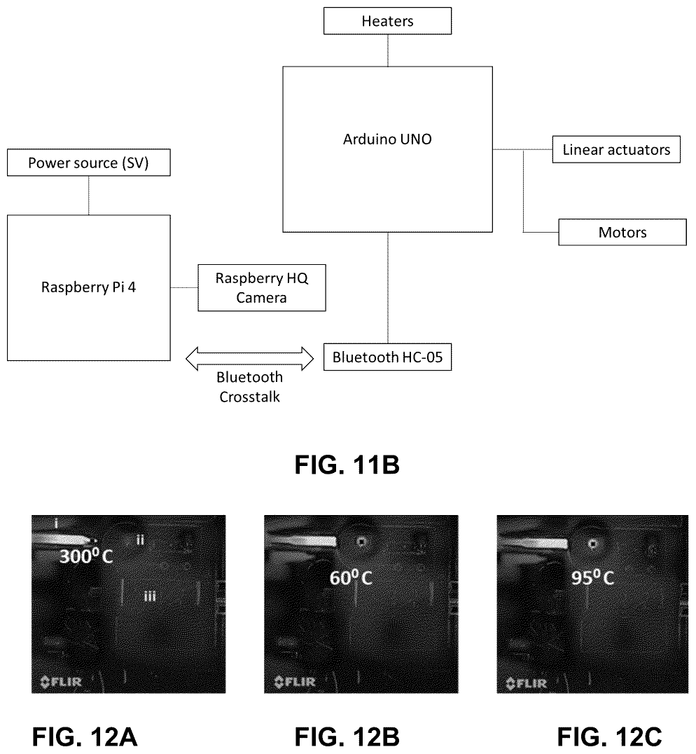

For the successful application of the current setup at the point of need, it is necessary to integrate PRICE (imaging setup) and operation of the cartridge in an automated fashion. In first, the operation of cartridge has sequential steps, with key steps that could require user involvement in absence of an automated setup. These key steps, include (i) breakage of the membrane, (ii) release of the suction cups (by twisting the screws holding them in place), (iii) heating for saliva and amplification steps. To automate these steps, a system of five linear actuators was employed (coded—A1, A2, A3, A4, A5) (as shown in FIG. 2D) controlled by an Arduino UNO microcontroller (FIGS. 11A-11B).

FIG. 11A is a flow diagram depicting the high-level operation of microfluidic sample-to-answer pathogen detection platform, with major emphasis on electronic components involved. The number coded blocks indicate the sequence of the individual process involved in the operation. In brief, Step-1 to 3 involves the user to connect to the system via a mobile application enabled by an on-board Bluetooth module connected to the Arduino UNO. In the next subsequent step, the components in the Arduino are activated in concerted sub steps to complete the processes from sample collection to LAMP reaction incubation. Following the completion of the reaction, the Bluetooth communicates with Raspberry Pi via Bluetooth to initiate imaging and subsequent movement of the stage for multiplexed pathogen detection. FIG. 11B depicts the electronic CAD layout of all the electronic components enabling the automation of the sample to answer processing of the system. The major constituents involved in the prototype controlled by Arduino UNO and Raspberry Pi are, (i) actuator system (five in number to automate the process of saliva collection and sequential delivery of reagents typically involved in a LAMP assay), (ii) two direct current (DC) heating components to control heating for pathogen lysis and subsequent nucleic acid amplification reaction, (iii) Raspberry Pi 4 (4 GB RAM) coupled with CMOS sensor for imaging of the colorimetric change, (iv) a HC-05 Bluetooth module that enables cross talk between the mobile application and the Arduino UNO, and subsequently between Arduino UNO and Raspberry Pi 4.

The actuators, A1 and A3 were attached with sharp ended tips that assist with breakage of the membrane with a force of 6.2N. Actuators, A4 and A5 were fitted with cylindrical shaped tips to push the extension of the screw and actuate the suction cups. The linear actuator A2 was fitted with a portable pocket solder to carry out the sample lysis step. It is desired to reach 95° C. for 3 min to complete the lysis process. The temperature was controlled from overshooting by employing cycles of linear movement of the actuators. The desired temperature was reached in under 1 min as represented by infrared images in FIGS. 12A-12C. For the carrying out the amplification reaction, it is desired to reach a temperature of 65° C. for 15 min, to execute this, a ceramic heater directly in contact with cartridge was employed. The temperature profile is achieved by employing a proportional-integral-derivative (PID) controller in conjunction with the ceramic heater (FIGS. 12A-12C). Additionally, to ensure loss of liquid due to evaporation engendered by the breaking of the membranes, the tips of actuators A1 and A3 were fitted with silicone O-rings to tightly seal the broken membrane area.

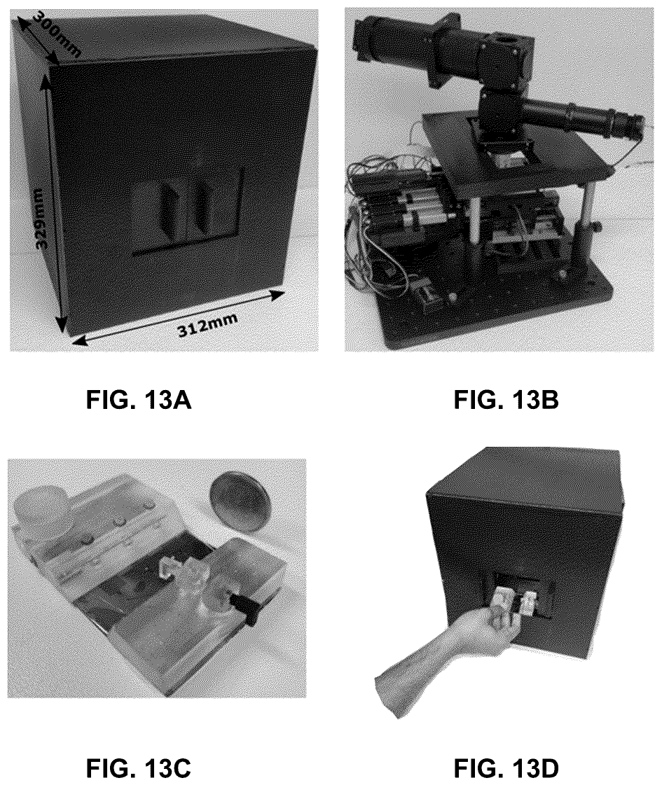

Once the amplification reaction was carried out for 15 min, it was desired to capture the calorimetry by PRICE. The imaging setup was completely controlled by Raspberry Pi 4 microcontroller. The PRICE worked in tandem with the Arduino microcontroller to scan different chambers and different regions in the chambers. This movement was enabled by an X-Y translation stage directly controlled by the Arduino. For the X-translation, a CNC linear stage was employed. For the Y-translation a unique contraption involving a linear manual actuation stage and continuous servo motor. The linear stage moves in a single direction with rotation of a screwhead. This screwhead is attached to the rotating shaft of the servo motor via a 3D printed knob. The cartridge holder is firmly fitted to this linear translation stage. The duration of rotation and the direction of rotation of the servo motor shaft therefore determines the movement of the cartridge. The entire setup is covered with a 3D printed enclosure with a sliding door for insertion of the cartridge (FIGS. 13A-13D).

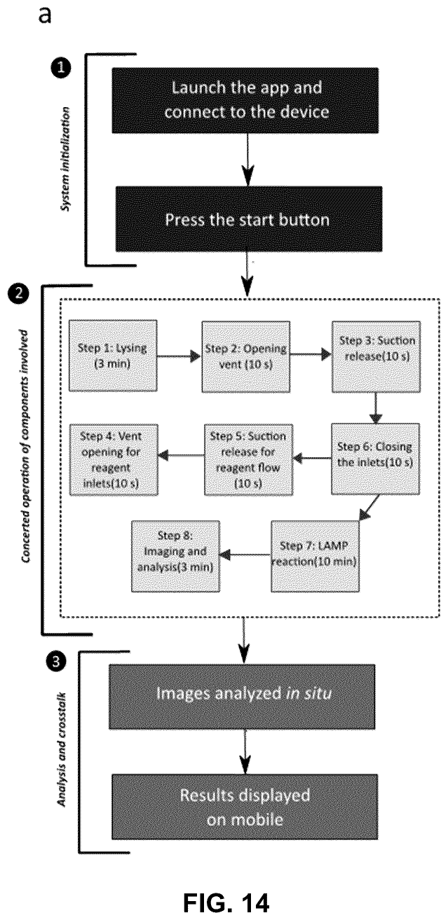

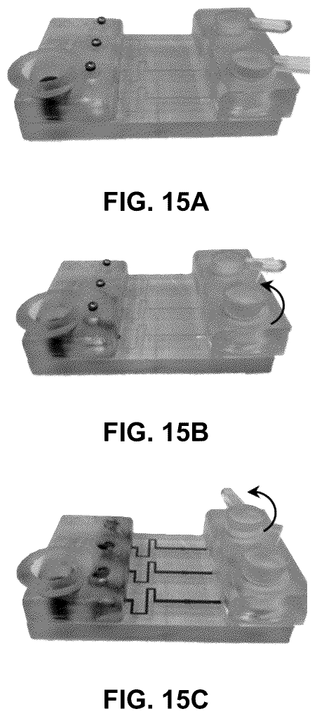

This concerted interplay between (i) imaging (executed by Raspberry Pi 4), (ii) execution of fluidic steps (operation of cartridge) and movement of X-Y translation stage (executed by Arduino UNO) is centrally controlled by a mobile application. Both the Raspberry Pi and Arduino execute commands via Bluetooth commands (FIG. 14). Photographs of the microfluidic cartridge during the assay are shown in FIGS. 15A-15C. FIG. 14 gives an overview of the process flow involved in the operation of the mobile application working in tandem with two major microcontroller modules, namely, Arduino UNO and Raspberry Pi 4. The operation of the application can be broadly categorized into three main subsets. First, (1) system initialization—the crosstalk between the mobile phone and the microcontroller modules is enabled by a stable Bluetooth connection. Hence the first step is establishing a connection between mobile and the modules and subsequently press the button labelled ‘Start’ to send a message to the Arduino and Raspberry Pi 4 to start initializing the process (color coded in navy blue). Following this, in subset (2), the components start operating in a concerted fashion. Each component substep is clocked to enable operation in the defined sequence. The user can monitor the progression of the process on the mobile application (color coded in light blue). Once the assay incubation time is completed, the images are captured and analyzed in substep (3). In brief, RGB values are extracted from the images and analyzed further to display the final result on the screen easily interpretable by the user.

The image of the assay on the platform was captured with the custom-built PRICE setup. In brief, the CMOS sensor captured the image of the detection platform. The raw image was stored in the raspberry Pi for further processing. In addition to controlled illumination, the parameters of image capture, namely, white balance, gain (analog and digital) exposure time, framerate and ISO become important. Among these, white balance and gain values were changed in this study. All the other parameters were fixed and left changed through the experimental process.

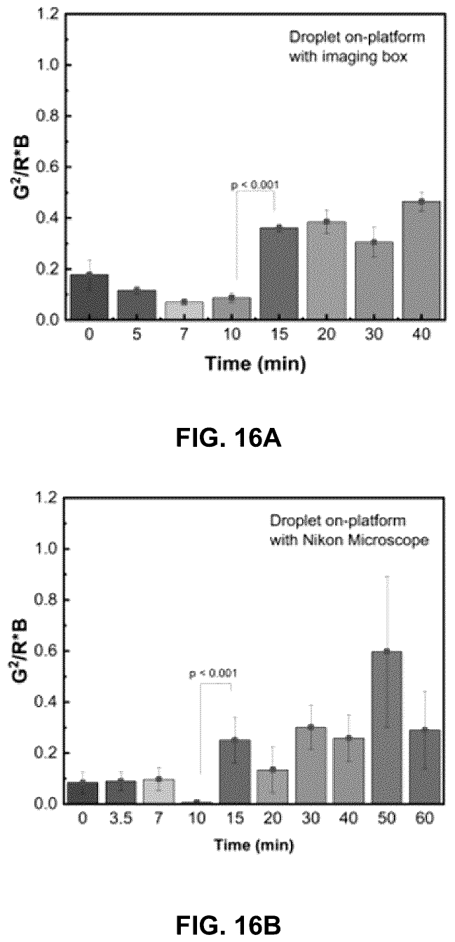

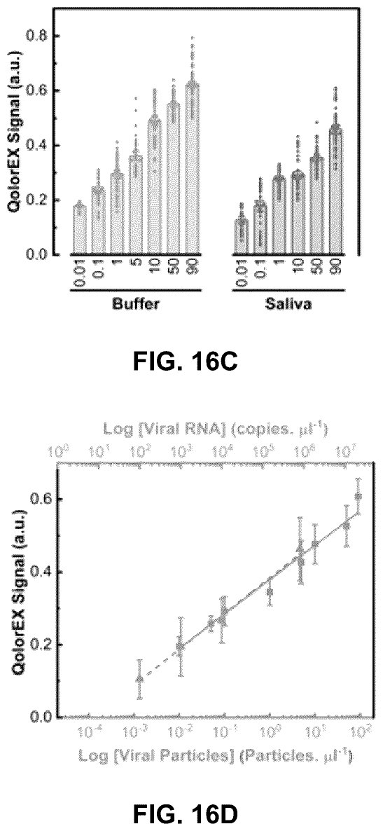

LAMP assay was carried out in Eppendorf tubes for wild type SARS-COV-2 synthetic RNA for different points. Then 1 μL of the droplet was transferred to the detection platform and imaged with the PRICE setup and brightfield Nikon microscope. FIG. 16A shows the G²/R*B analysis for images with the PRICE. There is a steep increase of the G²/R*B at 10 min confirming the presence of viral nucleic acid. The same assay when imaged with Nikon microscope (FIG. 16B) shown the change in G²/R*B at 10 min. This shows good correlation between both the imaging setups. Overall, FIGS. 16A-16B demonstrate that the portable imaging setup is able to capture phenol red mediated colorimetric change for SARS-COV-2 detection at point-of-need. All the analyses were carried out for wild type SARS-COV-2 synthetic RNA at 8*10e5 copies/μL. For these analyses, the RT-LAMP assay was carried out off-chip in an Eppendorf tube and later pipetted out on to color sensitive platform for imaging. FIGS. 16A-16B show the temporal change of G²/R*B parameter for assay droplet on the color sensitive plasmonic platform. The significant change was observed from time point 10 min to 15 min (p<0.001). Hence time point 15 min was considered as a point of differentiation or color change. The images here were capture with a Raspberry Pi HQ CMOS sensor at Red: Blue gain values of 3:3. FIG. 16B is a comparative study with a Nikon™ Eclipse Ni-U microscope. Here, the time point of differentiation was observed to be 15 min. The images were captured at Red: Blue gain values of 1.54:2.11. The graph shows the variation of the parameter (G²/R*B) when the assay liquid is imaged in the fabricated chip (with PDMS bonded fluidic layer) at two different time points 0 min and 40 min. The graph shows significant change (p<0.001) in the parameter for the two time points. The QolorEX signal was recorded for spiked viral load in saliva and buffer samples (FIG. 16C). The linear trend in the signal was shown as a correlation between viral load and signal (FIG. 16D).

It was shown herein that an automated colorimetric setup can perform pathogen detection. The sequential steps of the assay and signal transduction and analysis are automated using three different modules, (i) a portable reflected-light imaging setup with controlled epi-illumination (PRICE), (ii) a microfluidic cartridge and (iii) automation control unit. The QolorEX platform, a specialized nanostructured platform herein developed leverages plasmonic excitation for highly sensitive detection of respiratory infectious pathogen is employed as the key detection technology. First, to capture the colorimetric change, PRICE is designed for imaging the assay chamber. The imaging setup offered superior spatial and spectral control with only a 17% variation in the relative intensity and a resolution and FoV of 4.4 μm and 298 μm, respectively. Next, to eliminate the involvement of the user, a microfluidic cartridge with mechanically actuated PDMS suction membranes is implemented by leveraging additive manufacturing techniques. The flow was shown to be mechanically actuated by a screw-nut mechanism with excellent control over the fluid pumping. This actuation mechanism demonstrated lowest volume of fluid suctioned at 0.1 μl for a 30 degree rotation of the actuating screw. Subsequently, the microfluidic chip also showed perfect extent in mixing lysed sample with the reagents. With the final automation and control module, the cartridge operation was concerted using system of linear actuators and electrothermal heaters connected via Arduino UNO and Raspberry Pi controlled via mobile application. The imaging was implemented in a direct comparison format with a Nikon brightfield microscope, and a quantifiable colorimetric change was recorded in 15 min.

Nucleic acid amplification is the gold standard molecular diagnostic test, but it is not easily deployable due to required lengthy protocols and specialized equipment. The point of care testing to date is limited by versatility and rapidity in reading the amplification signal. Additional testing was performed on the nanoplasmonically boosted nucleic acid amplification. The microfluidic sample collection/preparation to achieve fully automated minute-scale (sample-to answer time of 13 minutes) colorimetric detection of multiple nucleic acid biomarkers at single nucleotide resolution (QolorEX). Here, it is shown that one-step isothermal amplification of RNA/DNA with loop-mediated amplification (RT-LAMP) and rolling circle amplification (RCA) can be boosted three-folds via plasmonic color enhancement generated on the surface of plasmonic nanostructures confined in the microfluidics. This offers a label/probe-free colorimetric approach deployable for the detection of a variety of targets by simple tuning of amplification reagents with a quantitative response as a function of the pathogen load. The versatility of the QolorEX platform was demonstrated through the detection of respiratory viruses such as SARS-COV-2, and Influenza A H1N1, as well as antimicrobial-resistant bacteria such as Escherichia coli (E. coli) and Methicillin-resistant Staphylococcus aureus (MRSA). It was also possible to discriminate between SARS-COV-2 variants by incorporating RCA to detect viral RNA alternatives at the level of single nucleotide polymorphism. The diagnostic capability of QolorEX in clinical setting was also demonstrated by testing 33 saliva samples from COVID-19 patients and achieved quantitative detection of viral RNA in saliva with a detection limit of 5 RNA copies/μL and 95% accuracy on par with qPCR. The simplicity, sensitivity, and robustness of QolorEX's technology is an advantageous platform for the realtime monitoring of pathogenic infections and assist in clinical decision-making.

Accordingly, the QolorEX platform was tested for the detection of Influenza A H1N1, SARS-COV-2 and its Alpha B.1.1.7, Delta B.1.617.2, Gama P.1, Eta B.1.525 and Omicron B.1.1.529 variants. The results with qPCR. To demonstrate the universal application of QolorEX, in addition to the investigations circumambient RNA amplification testing, DNA amplification detection in bacterial infections based on E. coli and MRSA were also studied. For clinical validation, 33 saliva samples from COVID-19 patients and 15 healthy samples were tested with QolorEX. The QolorEX device meets all the ASSURED (affordable, sensitive, specific, userfriendly, rapid, equipment-free, delivered) criteria laid out by World Health Organization (WHO) for developing an ideal biosensor in both developed and developing countries.

The list of materials used is as follows: polystyrene nanobeads (Polystyrene particles (PS-R); Micro Particle GmbH), synthetic SARS-COV-2 RNA (ATCC VR-3276SD; Cedarlane™), SARS-COV-2 B.1.1.7 Alpha variant RNA (ATCC VR-3326D; Cedarlane), MERS-COV (ATCC VR-3248SD; Cedarlane), heat-inactivated SARS-COV-2 (ATCC VR-1986HK; Cedarlane), heat-inactivated Influenza A (0810248CFHI; Cedarlane™), E. coli (#211540, Merlan™ Scientific), colorimetric RT-LAMP master mix and HiFi Taq DNA ligase enzyme (NewEngland Biolabs™), PLPs, RCA primers, and synthetic cDNA SARS-COV-2 targets, MgCl2, KCl, NAD, and Triton X-100 (Sigma Aldrich), LAMP primers, DTT (ThermoFisher Scientific), healthy human pooled saliva (IRHUSL50ML), and healthy human single donor saliva (IRHUSLS5ML) were bought from Innovative Research and stored upon arrival at −80° C., SARS-COV-2 variants (Omicron, Delta, Eta, and Gamma) RNA were obtained from cooperator laboratory at McGill University (Vidal Lab). HCOV 229E RNA was obtained from cooperator laboratory at Lady Davis Institute for Medical Research in Jewish General Hospital (Chen Liang Lab), MRSA DNA was obtained from cooperator laboratory at McGill University Health Centers—MUHC—research institute (Dao Nguyen Lab). All assays were prepared using ultra-pure DNase/RNase-free distilled water (ThermoFisher™ Scientific). Primers' composition and concentrations, and the RCA probes are presented in Tables 1-8.

TABLE 1
SARS-CoV-2 RT-LAMP primer set sequences (targeting ORF 1ab gene)

| | SEQ | | |
|---|---|---|---|
| | ID | | Concentration |
| Primer | NO: | Sequence (5′ to 3′) | (μM) |
| F3 | 1 | CCACTAGAGGAGCTACTGTA | 0.2 |
| B3 | 2 | TGACAAGCTACAACACGT | 0.2 |
| FIP | 3 | AGGTGAGGGTTTTCTACATCACTATATTGGAACAAGCAAAT | 1.6 |
| | | CTATGG | |
| BIP | 4 | ATGGGTTGGGATTAATCCTAAATGTGTGCGAGCAAGAACAA | 1.6 |
| | | GTG | |
| LF | 5 | CAGTTTTTAACATGTTGTGCCAACC | 0.4 |
| LB | 6 | TAGAGCCATGCCTAACATGCT | 0.4 |

TABLE 2
H1N1 Influenza A RT-LAMP primer set sequences (targeting HA gene)

| | SEQ | | |
|---|---|---|---|
| | ID | | Concentration |
| Primer | NO: | Sequence (5′ to 3′) | (μM) |
| F3 | 7 | ACTTGTCAAACACCCAAGG | 0.2 |
| B3 | 8 | GTGATAACCGTACCATCCAT | 0.2 |
| FIP | 9 | GGCCAGTCTCAATTTTGTGCTTTTCAGCCTCCCATTTCAGA | 1.6 |
| | | A | |
| BIP | 10 | TATCCCGTCTATTCAATCTAGAGGCCTACCATCCCCTGTC | 1.6 |
| | | CACC | |
| LF | 11 | GGACATTTTCCAATTGTGATCGGA | 0.4 |
| LB | 12 | GCCATTGCCGGTTTCATTG | 0.4 |

TABLE 3
RCA probe sequences for SARS-CoV-2 variant detection (all 0.4 μM)

| | SEQ | | Target |
|---|---|---|---|
| Mutation | NO | Sequence (5′ to 3′) | variant |
| PLP- | 13 | GAGAATTAGTCTGAGTCTGATAACTAACTACCGGTCAACTTCAAGCTCCT | omicron |
| P681H- | | AAGCCTTGACGAACCGCTTTGCCTGACTGAATGCAGCGTAGGTATCGAC | |
| SARS- | | TACGTGCCCGCCGAT | |
| CoV-2 | | | |
| PLP- | 14 | GGTAATTATAATTACCACCAACCCCCGGTCAACTTCAAGCTCCTAAGCCT | delta |
| L452- | | GACGAACCGCTTTGCCTGACTGAATGCCAGCGTAGGTATCGACAGACTT | |
| SARS- | | CCTAAACAATCTATACC | |
| CoV-2 | | | |
| PLP- | 15 | GATAATCCCAACCCATAAGCCCGGTCAACTTCAAGCTCCTAAGCCTTGA | Wild |
| WT- | | CGAACCGCTTTGCCTGACTGAATGCAGCGTAGGTATCGACCATGGCTCT | type |
| SARS- | | ATCACATTTAG | |
| Cov-2 | | | |

TABLE 4
RCA primers sequences for SARS-CoV-2 variant
detection

| | SEQ | | |
|---|---|---|---|
| | ID | | Concentration |
| Primer | NO: | Sequence (5′ to 3′) | (μM) |
| FOR | 16 | GCTTAGGAGCTTGAAGTTGAC | 1.6 |
| REV | 17 | GCTTTGCCTGACTGAATGCAG | 1.6 |

TABLE 5
cDNA sequences

| | SEQ | |
|---|---|---|
| | ID | |
| | NO: | Sequence (5′ to 3′) |
| WT | 18 | CTTATGGGTTGGGATTATCCTAAATGTGATAGAGCCATG |
| P681H | 19 | TAGTTATCAGACTCAGACTAATTCTCATCGGCGGGCAGTA |
| P681H- | 20 | TAGTTATCAGACTCAGACTAATTCTCCTCGGCGGGCACGTA |
| WT | | |
| L452R | 21 | GGTTGGTGGTAATTATAATTACCGGTATAGATTGTTTAGGAAGTCT |
| L452R- | 22 | GGTTGGTGGTAATTATAATTACCTGTATAGATTGTTTAGGAAGTCT |
| WT | | |

TABLE 6
E. coli LAMP Primer Set (targeting malB Gene)

| | SEQ | | |
|---|---|---|---|
| | ID | | Concentration |
| Primer | NO: | Sequence (5′ to 3′) | μM |
| F3 | 23 | GCCATCTCCTGAATGACGC | 0.2 |
| B3 | 24 | ATTTACCGCAGCCAGACG | 0.2 |
| FIP | 25 | CATTTTGCAGCTGTACGCTCGCAGCCCATCATGAATGTTG | 1.6 |
| | | CT | |
| BIP | 26 | CTGGGGCGAGGTCGTGGTATTCCGACAAACACCACGAAT | 1.6 |
| | | T | |
| LF | 27 | CTTTGTAACAACCTGTCATCGACA | 0.4 |
| LB | 28 | ATCAATCTCGATATCCATGAAGGTG | 0.4 |

TABLE 7
Methicillin-resistant S. Aureus LAMP Primer Set (targeting mecA Gene)

| | SEQ | | |
|---|---|---|---|
| | ID | | Concentration |
| Primer | NO: | Sequence (5′ to 3′) | μM |
| F3 | 29 | GGCTCAGGTACTGCTATC | 0.2 |
| B3 | 30 | TTGTTATTTAACCCAATCATTGC | 0.2 |
| FIP | 31 | ATGCCATACATAAATGGATAGACGTCAAACAGGTGAATTATT | 1.6 |
| | | AGCACTT | |
| BIP | 32 | CCGAAGATAAAAAAGAACCTTGCTTTTTTGAGTTGAACCTGG | 1.6 |
| | | TG | |
| LF | 33 | CATATGAAGGTGTGCTTAC | 0.4 |
| LB | 34 | CAAGTTCCAGATTACAACTT | 0.4 |

TABLE 8
RT-PCR primers for patient sample viral load
quantification (PCR product size 108)

| | SEQ ID | |
|---|---|---|
| Primer | NO: | Sequence (5′ to 3′) |
| 12669 | 35 | ATGAGCTTAGTCCTGTTG |
| Fw | | |
| 12759 | 36 | CTCCCTTTGTTGTGTTGT |
| Rv | | |
| 12696 | 37 | AGATGTCTTGTGCTGCCGGTA |
| b | | |
| probe | | |

The SARS-COV-2 RT-LAMP primers used herein to target the ORF1ab gene. H1N1 RT-LAMP primers were designed through the NEB LAMP Primer Design Tool targeting highly conserved sequences of the Hemagglutinin (HA) gene of the H1N1 influenza A virus. The LAMP recognition part was evaluated by Basic Local Alignment Search Tool (BLAST) and no sequence variations have been seen in 100 hits provided by the NCBI website. The nominated LAMP primers were selected according to the optimized parameters offered by the Primer Explorer V5 protocol.

H1N1 RT-LAMP primers were designed through the NEB LAMP Primer Design Tool targeting highly conserved sequences of the Hemagglutinin (HA) gene of the H1N1 influenza A virus. The LAMP recognition part was evaluated by Basic Local Alignment Search Tool (BLAST) and no sequence variations have been seen in 100 hits provided by the NCBI website. The nominated LAMP primers were selected according to the optimized parameters offered by the Primer Explorer V5 protocol.

The P681H and L452R mutation sites were determined according to CoV-GLUE-Viz and GISAID and PLPs recognition parts were designed to be specific to the mutations. In addition, the PLP target site for WT SARS-COV-2 detection was the ORF1ab gene which is the same as the targeting site for SARS-COV-2 LAMP primers. The PLPs are designed in a way that the SNP is distinguished by the upstream of PLP which is providing the 3′-hydroxyl group at the ligation junction base-paired next to the phosphorylated 5′ end on a target strand. The veracity of PLP circularization upon SNP detection has been determined using Thermostable Ligase Reaction Temperature Calculator provided by New England Biolabs (NEB) website. Thereafter, the PLPs were evaluated using the Mfold web server to avoid undesirable secondary structure, especially in the PLP recognition site. RCA forward and reverse primers were designed to be hybridized to the spacer part of PLPs that connects two specific arms of PLP altogether. PLPs selectivity was confirmed through a gel electrophoresis experiment.

For RT-LAMP assays a standard reaction volume of 20 μL was used. It contained 2 μL 10× primer mix, 10 μL 2× master mix, 7 μL Rnase-free water, and 1 μL RNA sample. Heat-inactivated viral samples were first thermally lysed at 95° C. for 3 minutes and then mixed with the assay. This was followed by incubation at 65° C. for different periods to visualize color change versus time for different samples. The PLP ligation reaction was performed in a final volume of 10 μL including 1 μL synthetic complementary DNA (cDNA) of SARS-COV-2 RNA genome, 1 μL of 1 μM PLP, 2 μL UltraPure Distilled Water and 5 μL 2× no-Tris-HCl HiFi Taq DNA ligase ligation solution (20 mM MgCl2, 20 mM KCl, 2 mM NAD, 0.1% Triton X-100, 20 mM DTT, pH 8.50) and 1 μL HiFi Taq DNA ligase enzyme. The ligation mixture was first incubated at 95° C. for 5 min for DNA denaturation and then cooled down to PLPs annealing temperature (which are 60, 58, 55° C. for P681H, L452R, and WT PLPs, respectively) to let PLPs hybridize with cDNA and ligate via HiFi enzyme in a thermocycler (Analytik Jena, Germany). Thereafter, the ligation reaction was 12 μL of WarmStart™ Colorimetric LAMP 2× Master Mix, 1.6 μM RCA reverse, and forward primers in a final volume of 24 μL. The RCA amplification reaction was performed at 65° C. for different periods to visualize color change versus time for different samples.

For bacterial DNA Extraction, E. coli samples were cultured overnight at 37° C. in Luria Broth (LB) media. Bacteria concentration was determined using a Spectronic™ 21D spectrophotometer. Aliquots of different concentrations of 107 CFU·mL⁻¹, 10⁵ CFU·mL⁻¹, 10⁴ CFU·mL⁻¹, 10³ CFU·mL⁻¹, 10² CFU·mL⁻¹, and 10 CFU·mL⁻¹ were prepared by suspending E. coli cultures in LB media. E. coli DNA was extracted by boiling cultures at 95° C. for 10 min. Methicillin-resistant S. aureus DNA was obtained from the McGill University Health Centre using the chemical lysis method. All DNA sample concentrations were measured using a Nanodrop™ 2000 Spectrophotometer and suspended in Universal Buffer 48 (Bio Basic Inc., ON, CA) to achieve desired concentrations.

QolorEX_{LAMP} assay For SARS-COV-2 tested spiked solutions (RNase-free water and healthy saliva) of 8×105 RNA copies. μl⁻¹ —5 RNA copies. μl⁻¹ of SARS-COV-2 RNA and 90 PFU. μl⁻¹—0.01 PFU. μl⁻¹ for heat-inactivated SARS-COV-2 to fit in a biologically relevant range. Similarly, a study was performed for Delta B.1.617.2, Omicron B.1.1.529, Eta B.1.525, and Gamma P.1 variants RNA with the concentration of 8×10⁵ RNA copies. μl⁻¹. Alpha B. 1.1.7 variant was studied with a concentration of 104 RNA copies. μl⁻¹. For selectivity studies, RNA from MERS CoV, HCoV, and Influenza A H1N1 viruses were tested.

QolorEX_{LAMP} assay for H1N1 studied spiked solutions (RNase-free water and healthy saliva) of 8×105 RNA copies. μl⁻¹ —5 RNA copies. μl⁻¹ of Influenza A H1N1 RNA. For selectivity studies, RNA from multiple viruses (SARS-COV-2, MERS CoV, and HCoV 229E) were tested at concentrations of 8×10⁵ RNA copies. μl⁻¹.

QolorEX_{LAMP} assay For E. coli studied spiked solutions (RNase-free water) of 70 ng. μl⁻¹—0.2 ng·μl⁻¹ of E. coli DNA. For selectivity studies, DNA from multiple bacteria (E. coli, MRSA, and Pseudomonas Aeruginosa) were tested at the concentration of 50 ng·μl⁻¹.

QolorEX_{LAMP} assay For MRSA studied spiked solutions (RNase-free water) of 50 ng·μl⁻¹—0.2 ng·μl⁻¹ of MRSA DNA. For selectivity studies, DNA from multiple bacteria (MRSA, E. coli, and Pseudomonas Aeruginosa) were tested at the concentration of 50 ng·μl⁻¹.

QolorEX_{RCA} assay was done in spiked solutions (RNase-free water and healthy saliva) of 10⁶ cDNA copies·μL⁻¹—5 cDNA copies·μL⁻¹ of synthetic cDNA of P681H, L452R, and WT SARSCOV-2 sequences. For selectivity, the P681H PLP was evaluated in the presence of P681H, WTP681H, and L452R cDNA. The same strategy was employed for selectivity testing of L452R PLP using L452R, WT-L452R, and P681H cDNA targets as well as WT PLP in the presence of WT, P681H, and L452R cDNA sequences. All the cDNA targets were assessed at the concentrations of 10⁵ cDNA copies·μL⁻¹.

Image processing was performed with a dataset comprised of triplicate images from the conditions studied. The processing consisted in cropping the outer 20% of the original RBG image to remove the coffee ring effect. Followed by a blue filter application, where pixels with a hue value between 85 and 140 (blue range) are removed and replaced by the mean value of the rest of the image. The blue-filtered image is then thresholded by replacing the 25% less saturated pixels with the mean value of the rest of the filtered image. Finally, the processed image is cut into 20 sub-images from which several features are extracted consequential to the implementation of formulas. The modification made to the formulas consists of interchanging the greyscale intensity with the intensity of each RGB channel 74. A total of 18 values are extracted from each sub-image corresponding to the mean color value, standard deviation, mode, skew, energy, and entropy for each of the RGB channels.

For the automation of the real human samples, a supervised machine learning algorithm was implemented to classify the images into two classes healthy and patient. An SVM with a rbf kernel was established with its hyperparameters C and gamma assessed by a Bayesian search and an overfitting absence validated via a 5-fold cross-validation. The database for this study is integrated by 33 patients and 15 healthy controls, for every sample, studies were conducted in triplicates, acquiring a total of 9 images per timepoint. The datasets are divided into 2 classes: healthy (negative) and patient (positive). Then they are divided into distinct training and testing sets. The training set consists of 2 thirds of the vectors from patients 1, 7, 9, 11, 15, 19, 21, 23, 25, 29, 31 and negatives 2, 3, 4, 5, 6, 7, 8, 9, 11, 13 and 15; the test set is integrated by the remaining vectors. The SVM produces a prediction for each vector of the test set to be either healthy or patient.

SARS-COV-2 clinical samples including 18 saliva samples and 15 nasopharyngeal swab samples were collected from adult patients with COVID-19 symptoms such as fever, fatigue, and dry cough through the University Health Network's PRESERVE-Pandemic Response Biobank (REB #20-5364). All samples tested positive for SARS-COV-2 using RT-PCR. Moreover, the viral load in the saliva samples was evaluated by qPCR (QuantStudio 12K Flex, ThermoFisher™). The samples were assessed at a Level 2+ facility situated in the Lady Davis Institute at the Jewish General Hospital, Montreal Canada.

Electrochemical measurements were performed in a conventional three-electrode cell utilizing Autolab PGSTAT204 potentiostat/galvanostat. The plasmonic platforms were used as the working electrode, while Ag/AgCl and platinum wire served as the reference and counter electrodes, respectively. The potential of cyclic voltammetry tests ranged from −1 to 1 V compared to the reference electrode with a scan rate of 50 mV·s⁻¹. Measurement of the photoresponse was done employing the chronoamperometry technique under chopped ambient visible light (light on/off cycles: 5 s) at a bias potential of 1 V vs. Ag/AgCl in an aqueous nucleic acid amplification assay solution (10 parts LAMP master mix, 2 parts 10× primer stock, 7 parts RNAse free water, and 1 part target RNA sample).

Results are conferred as the mean value±the standard error for triplicate measurements. OriginPro (OriginLab, 2021) software package is used for statistical analysis. Limits of detection and linear ranges are calculated using linear regression methods including the line slope and the standard error of the intercept. Statistical significance is evaluated using a oneway analysis of variance (ANOVA) with post hoc Tukey's test for mean comparison. Datasets difference is considered statistically significant for p<0.05. Paired Comparison Plot (version 3.60, OriginLab) graphing application is used to generate the figures using conservative p values.

Clinical throat swab samples were collected from the West China Hospital of Sichuan University (Ethical Approval no. 2020(100)) and frozen extracted RNAs from these samples were provided by the hospital for MARVE and in-house RT-qPCR testing. RNA samples were thawed on ice, divided into 5 μL aliquots and stored at −80° C. until use. Negative throat swab specimens were acquired from healthy donors in the Deng laboratory. Influenza viruses were kindly provided by a collaborator at the Institute of Microbiology, Chinese Academy of Sciences, Beijing, China.

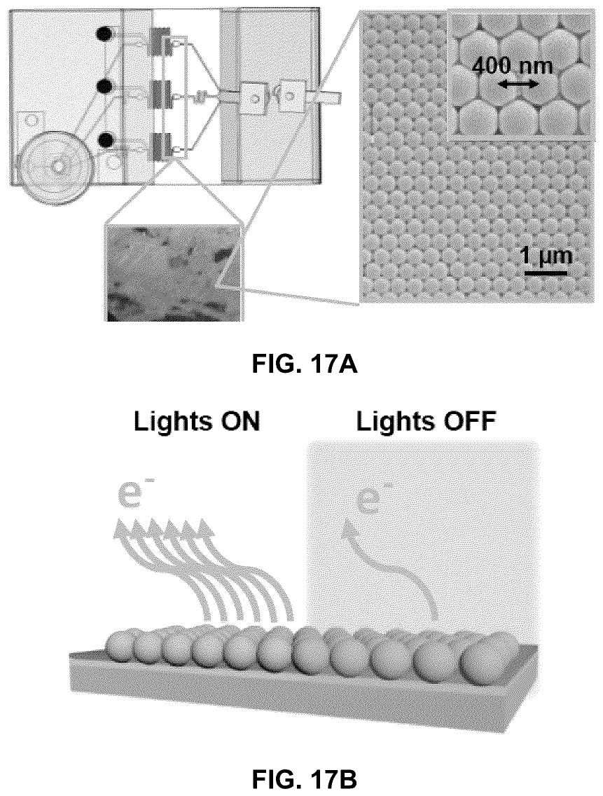

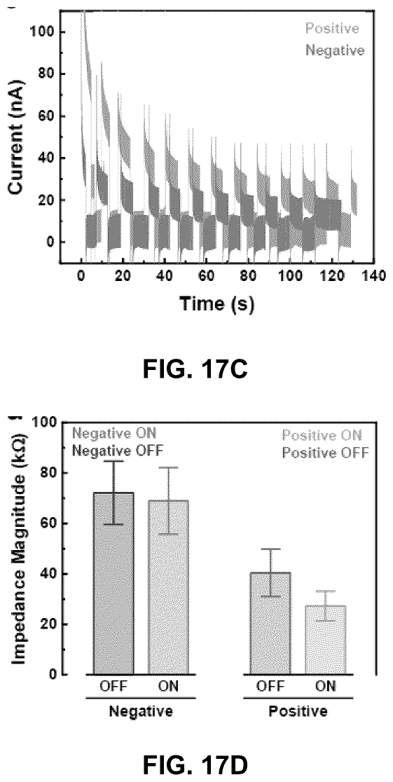

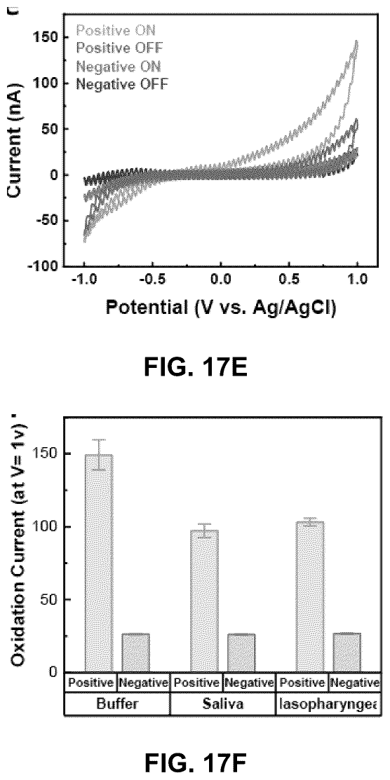

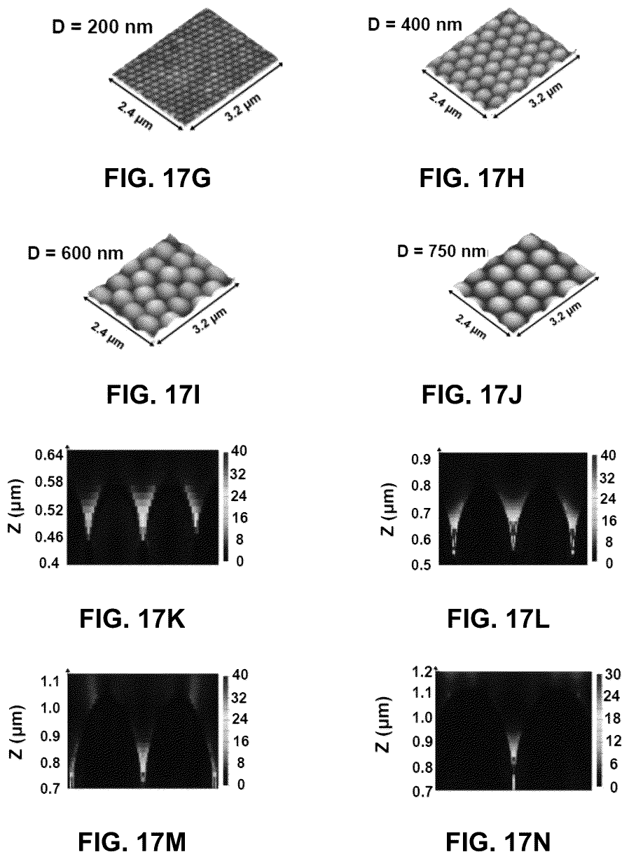

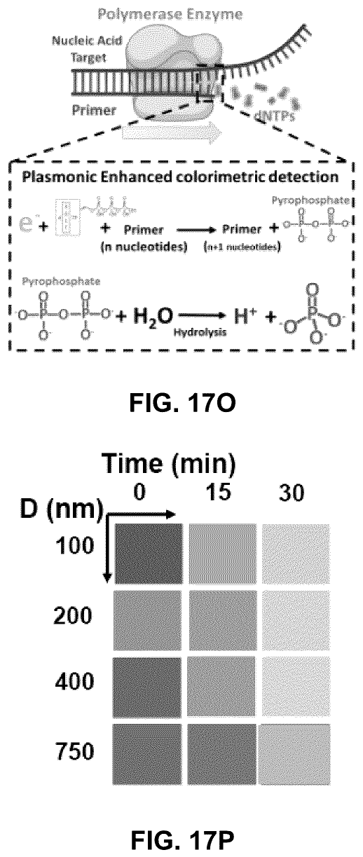

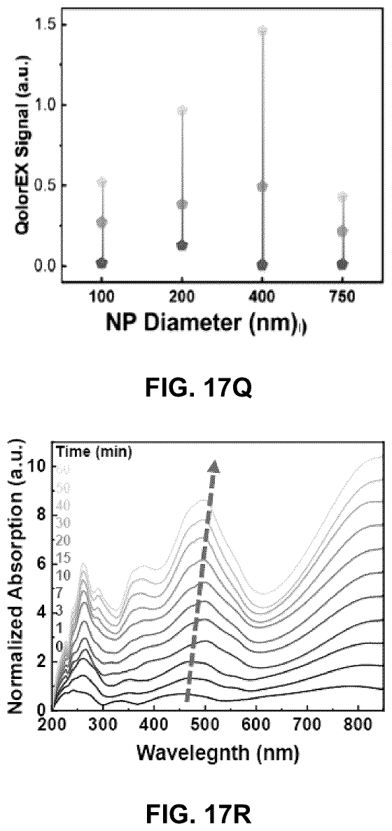

The QolorEX sensing chamber was designed to display plasmonic effects tuned by geometric and material parameters. To express plasmon resonance in large areas, fabless polystyrene nanoparticle self-assembly was used to construct the assemblies on biocompatible layered materials (FIG. 17A). The rate of free electron injection into the media is heavily dependent on the electromagnetic (EM)-field enhancement of the plasmonic surface. The process of electron injection relies on the iridescence of light to activate plasmonic resonance (FIG. 17B).

To investigate electron engagement with the amplification assay, the kinetics of the reaction in the presence and absence of the emancipated plasmonic electrons via electrochemistry was studied. By employing real-time chronoamperometry in the presence/absence of the target nucleic acid, it was demonstrate that the electron injection under illumination directly affects the amplification reaction, and does not involve the side reactions, like phenol red oxidation (FIG. 17C). Electrochemical impedance spectroscopy validates the enhanced reduction of interface resistance when the amplification target is introduced to the media. With active electron injection under illumination, the positive amplification assay revealed lower surface resistance in comparison with the dark state, resulting in the higher kinetics of the amplification reaction due to the electron injection by the plasmonic surface (FIG. 17D). To verify the participation of the excess electron flux in the oxidation reaction when the amplification target is present, a cyclic voltammetry test was designed to compare the redox cycle in the absence and presence of light. The oxidation peak amplification was higher when illuminated in the positive state, which supports our hypothesis of electrons involvement in the amplification process (FIG. 17E). This experiment was also repeated in different body fluids and the oxidation current amplification peaks in buffer, saliva, and nasopharyngeal fluid were compared under illumination to investigate the impact of the media. Body fluids have a higher viscosity than the buffer and thus represented more resistance to the electron transfer resulting in lower oxidation current amplification peaks in saliva and nasopharyngeal fluid compared to the buffer (FIG. 17F).

Next, the sensing platform was optimized to maximize the electromagnetic field enhancement and consequently surface electron emancipation. A series of platforms with different diameters of polystyrene nanoparticles (ranging from 200 to 1000 nm) were fabricated, demonstrating a repeatable array of curved surface topography with distinguished pitch (FIGS. 17G-17J). To theoretically optimize the EM field enhancement of plasmonic platforms, a series of numerical simulations were performed using a finite-difference time-domain (FDTD). The electric field distribution was simulated in the plane-wave excitation with a wavelength of 380 nm-720 nm. The 2D color map of the EM-field distribution demonstrated higher enhancement in the grooves of polystyrene nanoparticles (FIG. 17K-17N). To complete the optimization, a separate investigation with respect to the visibility of the acidity-dependent media color of phenol red was conducted. The phenol red redox reaction leading to a color change from magenta to yellow in the media is a result of an increment in the acidity of the media as a consequence of a chemical reaction such as nucleic acid amplification reaction (FIG. 17O). The colorimetric readout images at different time points of the assay were captured over the background plasmonic color for multiple substrates fabricated with nanoparticles with different diameters (FIG. 17P). To quantify the gamut of the color change in the media, the raw colorimetric readout was automatically processed for eliminating artifacts and subdividing them into 20 mini-images for a minimum of 60 mini-images per time point. The red, green, and blue (RGB) content of the images along with 15 other color parameters was extracted to calculate the enlargement of the yellow color in the media. A transduction signal was adapted based on the unique green component of the yellow color emphasizing over the combination of red and blue components in the magenta color. Thus, the QolorEX signal was measured using the ratio between the square of the green value to the product of the red and blue values (Equation 6). The comparison of the QolorEX transduction signal demonstrated a wider gamut of the media color change on the plasmonic platform with a pitch of 400 nm (FIG. 17Q). A complementary UV-Visible test was performed to illustrate the absorption wavelength variation over the gradual change of the media color with a scaled acidity that represents the time span of 60 minutes in the presence of the nucleic acid amplification assay (FIG. 17R).

$$QolorEX signal = {Green}^{2} \cdot {( Red . Blue )}^{- 1} \qquad 6$$

Where Green, Red, and blue represent the intensity of each image channel, respectively.

QolorEX enables multiplex analysis of RNA/DNA targets when coupled with RT-LAMP assay to establish the diagnostics capability of QolorEX. The assay incorporates a thermal lysis step to release nucleic acids (95° C., 3 minutes), followed by incubation at 65° C. for the isothermal amplification reaction. As discussed in the previous section, the plasmonically boosted amplification accelerates the H+ release, leading to quantitative colorimetric signal change in the presence of phenol red. The diagnostic capability of QolorEX LAMP was demonstrated using a paradigm of viral respiratory infections such as Influenza and SARS-COV-2.

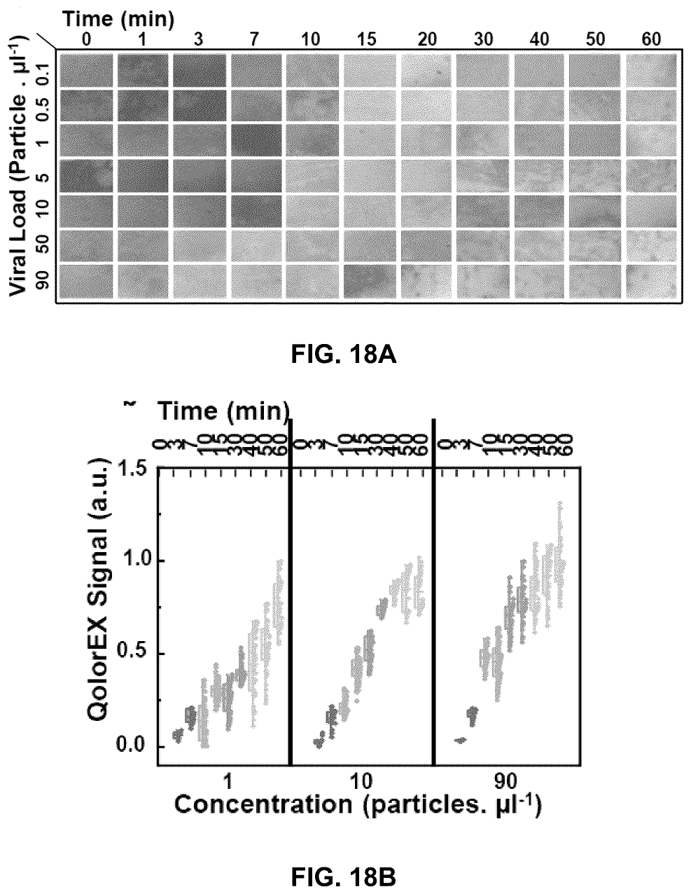

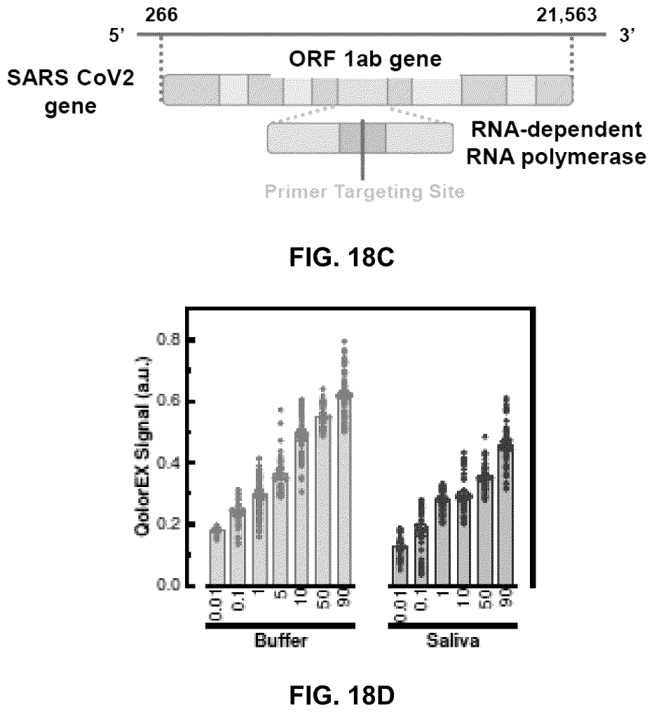

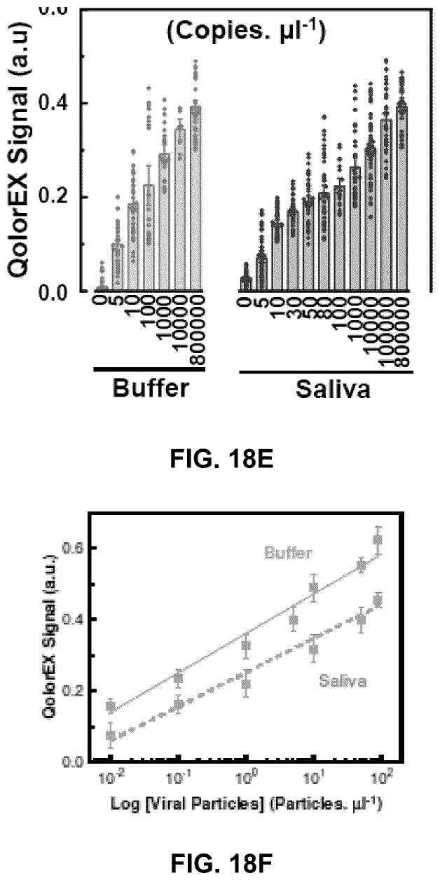

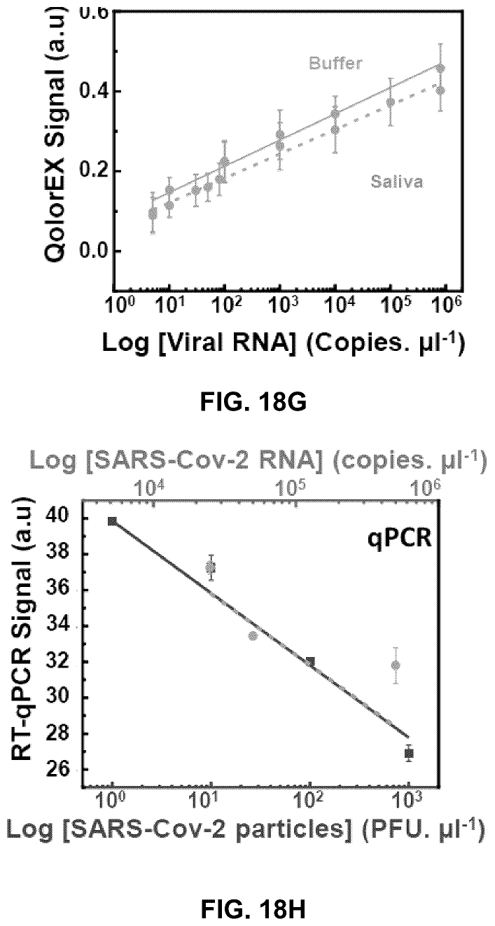

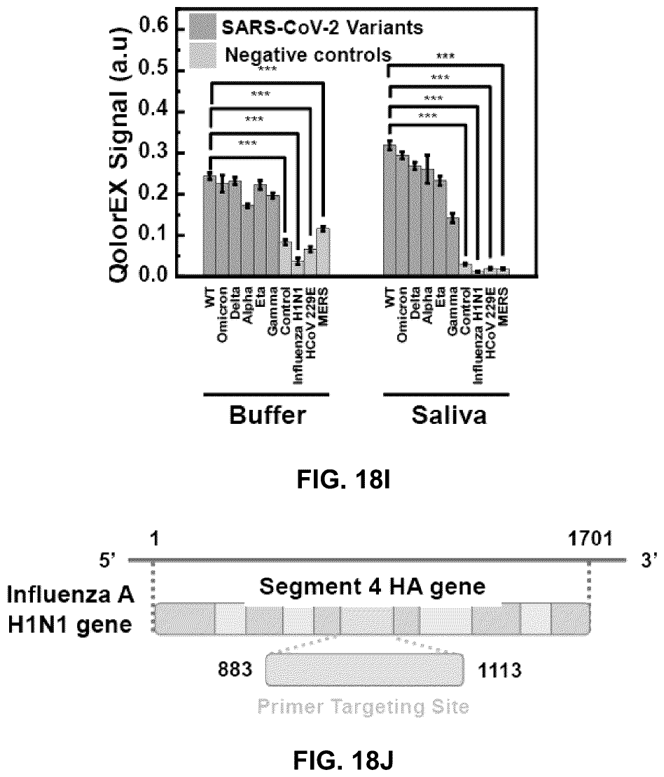

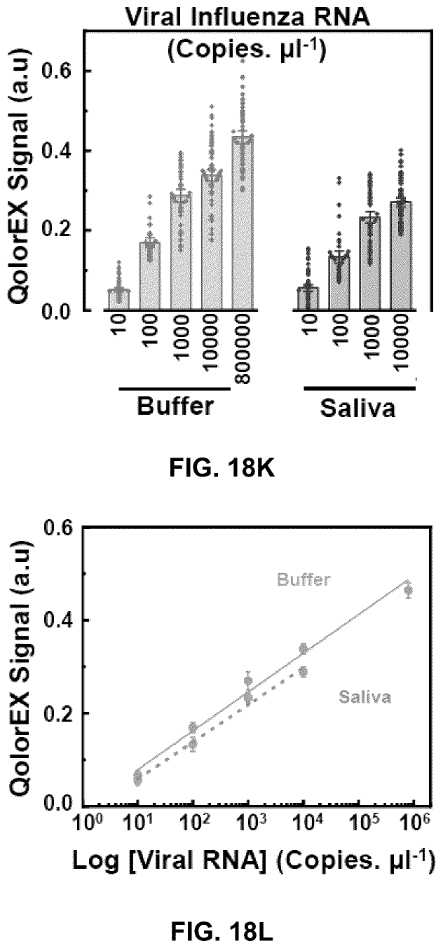

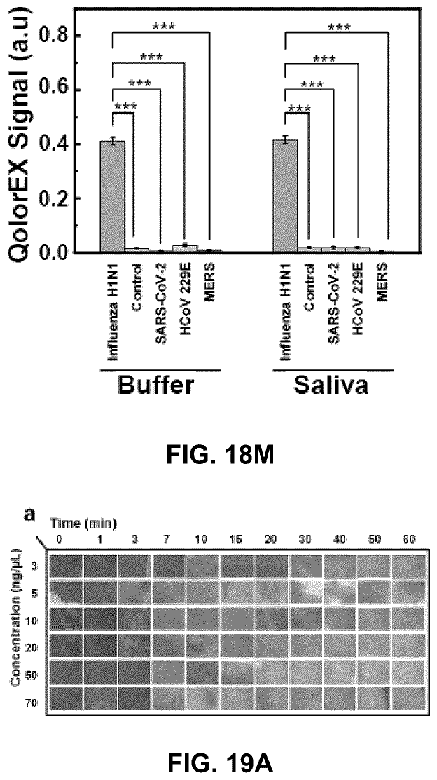

First, the sensitivity of the assay with SARS-COV-2 viral particles (wild-type strain) was establish in a series of dilutions (0.01 to 90 viral particles/μL) within the physiological range. Sequential images of the color-sensing chamber were acquired over 60 min to create a mosaic color matrix (FIG. 18A). QolorEX LAMP successfully detected different concentrations of SARS-CoV-2 viral particles as shown by the gradual color change of the raw images during the 0 minutes to 60 minutes time lapse from magenta to yellow colors. A positive detection signal shows a consistent increase over time with a higher signal increase during the 60-minute incubation period associated with higher sample viral loads (FIG. 18B). The gene target is the SARS-COV-2 open reading frame 1ab gene (ORF1ab) as per the recommendations of the World Health Organization (WHO) 60. Highly selective SARS-COV-2 RT-LAMP primers targeting the RNA-dependant RNA polymerase (RdRp) sequence of the ORF1ab gene (FIG. 18C) are used for the assay.

QolorEX LAMP for SARS-COV-2 generated a differentiable colorimetric signal for all tested concentrations of SARS-COV-2 samples. The signal has a positive correlation with the concentration of the heat-inactivated viral particles within the physiological relevant range of 0.01 to 90 viral particles/μL in both buffer and human saliva media FIG. 18D. Similarly, the signal has a direct correlation with the concentration of the viral RNA within the physiological range of 5 to 8×10⁵ RNA copies/μL in buffer and human saliva FIG. 18E. The colorimetric signal in buffer and saliva has a linear correlation with the concentration of heat-inactivated SARS-COV-2 particles (RParticles buffer 2=0.98, Rparticles saliva 2=0.98) as shown in FIG. 18F. Furthermore, buffer and saliva samples spiked with SARS-COV-2 RNA have a linear signal trend with increasing target concentration (RRNA buffer 2=0.98, RRNA saliva 2=0.97) as shown in FIG. 18G.

The serial dilutions of SARS-Cov-2 samples (heat-inactivated and RNA) were tested with a qPCR assay FIG. 18H as a gold standard reference to compare the QolorEX performance. The limit of detection (LOD) of QolorEX LAMP for SARS-COV-2 (5.45 RNA copies/μL in buffer and 5 RNA copies/μl in saliva) lies sufficiently below the requirements of the WHO for point-of-care tests 38 and is even lower than the sensitivity of the PCR primers proposed by the WHO for SARS-COV-2 detection. Thus, QoloEXLAMP demonstrates applicability for early-stage diagnosis from saliva.

To establish the selectivity of the QolorEX LAMP for SARS-COV-2, the positive signals of different SARS-COV-2 variants (Wild type, Omicron B.1.1.529, Delta B.1.617.2, Alpha B.1.1.7, Eta B.1.525, and Gamma P.1) were compared in buffer and human saliva to the signals of other viral infections which has the potential to interfere with SARS-COV-2 detection either for similar molecular composition or for similar patient symptoms. Thus, Influenza A H1N1 virus, human coronavirus 229E (HCoV-229E), and Middle East respiratory syndrome coronavirus (MERSCOV) are tested along with negative control (no RNA). The colorimetric signal for SARS-COV-2

RNA (wild type and variants) demonstrated a higher value than all the other tested samples in both buffer and human saliva media (FIG. 18I). A null comparison was performed between the results of the colorimetric selectivity test. It demonstrated a significant difference between the SARS-COV-2 signal and the other viruses (p<0.001), suggesting a highly selective detection of SARS-COV-2 RNA. Differentiation between the different SARS-COV-2 variants proved to be challenging using the RT-LAMP assay as the colorimetric signal output was similarly high for all of them. Thus, the QolorEX LAMP should be beneficial for the universal detection of SARS-COV-2 RNA while other colorimetric assays such as RCA can be used for differentiation between different SARS-COV-2 variants.

To further investigate the universal application of QolorEX, a highly selective RT-LAMP primer set was incorporated for sensitive detection of Influenza A H1N1 RNA (QolorEX LAMP for H1N1) through targeting the Segment 4 Hemagglutinin gene (FIG. 18J). The device generated a quantifiable colorimetric signal for all tested concentrations of Influenza A H1N1 RNA within the range of 5 to 8×10⁵ RNA copies/μl in both in buffer and human saliva media FIG. 18K. The colorimetric signal has a linear correlation with the concentration of Influenza A H1N1 RNA in both buffer and saliva (Rbuffer 2=0.98, Rsaliva 2=0.98) as shown in FIG. 18L. The QolorEXLAMP for H1N1 achieved a limit of detection of 5.2 RNA copies/μL in buffer and 4.02 RNA copies/μL in saliva. Moreover, QolorEXLAMP for H1N1 has shown selective detection of Influenza A H1N1 RNA when tested with SARS-COV-2 RNA, human coronavirus 229E (HCoV-229E), and Middle East respiratory syndrome coronavirus (MERS-COV). This is evident through the null comparison (FIG. 18M) on the result of the selectivity test demonstrating a significant difference between the Influenza A H1N1 signal and other viruses (p<0.001).

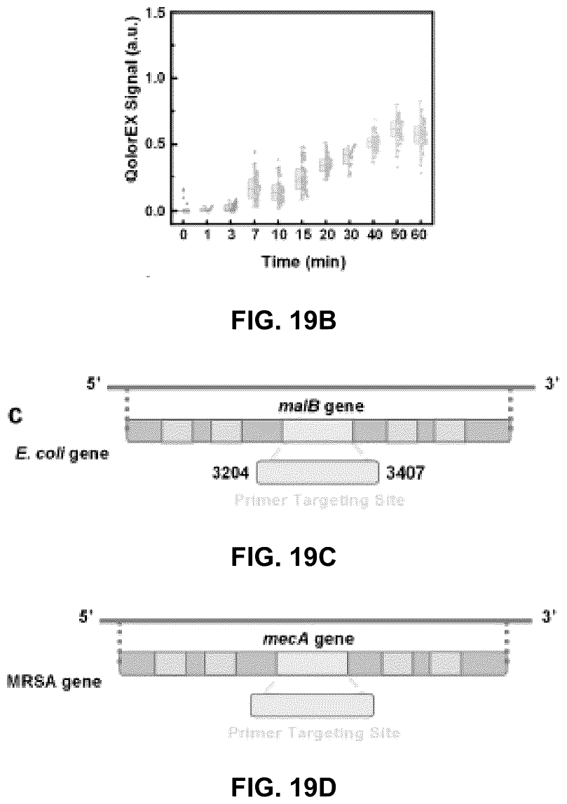

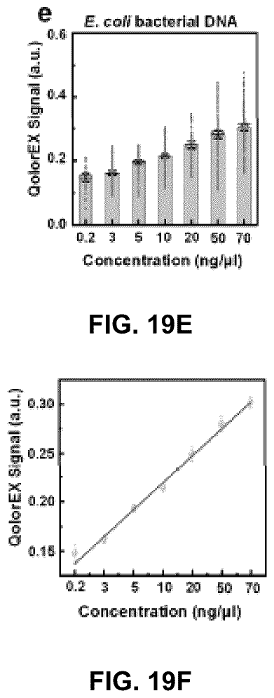

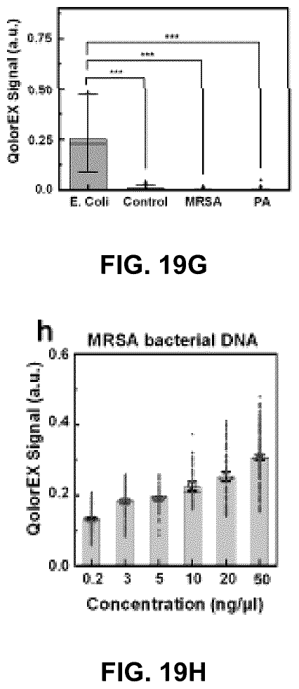

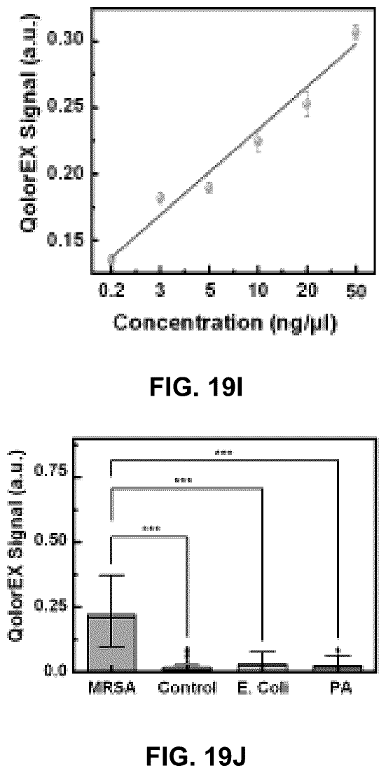

In addition to viral respiratory infections, the QolorEX_{LAMP} was employed for DNA profiling of antimicrobial resistant E. coli and MRSA, as a proof of concept for DNA amplification detection. The QolorEX_{LAMP} for E. coli detected color changes for DNA concentrations ranging from 0.2 to 70 ng/L (FIGS. 19A-19B). The QolorEXLAMP for E. coli targeted the malB gene (FIG. 19C) for selective detection of E. coli bacteria, and for targeting mecA in the MRSA gene (FIG. 19D). The device generated a quantifiable colorimetric signal for all tested concentrations of E. coli DNA within the range of 0.2 to 70 ng/μL in buffer media (FIG. 19E). The colorimetric signal has a linear correlation with the concentration of E. coli DNA (R2=0.99) as shown in (FIG. 19F) with a limit of detection of 1.4 ng/μL. Moreover, QolorEX_{LAMP} for E. coli is capable of uniquely identifying E. coli DNA when challenged with E. coli, MRSA, and Pseudomonas aeruginosa (PA) DNA (FIG. 19G).

The QolorEX_{LAMP} for MRSA targeted the mecA gene (FIG. 19D) for selective detection of MRSA bacteria. The device generated a quantifiable colorimetric signal for all tested concentrations of MRSA DNA within the range of 0.2 to 50 ng/μL in buffer media (FIG. 19H). The colorimetric signal has a linear correlation with the concentration of MRSA DNA (R2=0.96) as shown in FIG. 19I with a limit of detection of 2.2 ng/μL. Moreover, QolorEX_{LAMP} for MRSA is capable of uniquely identifying MRSA DNA when tested with MRSA, E. coli, and Pseudomonas aeruginosa (PA) DNA (FIG. 19J).

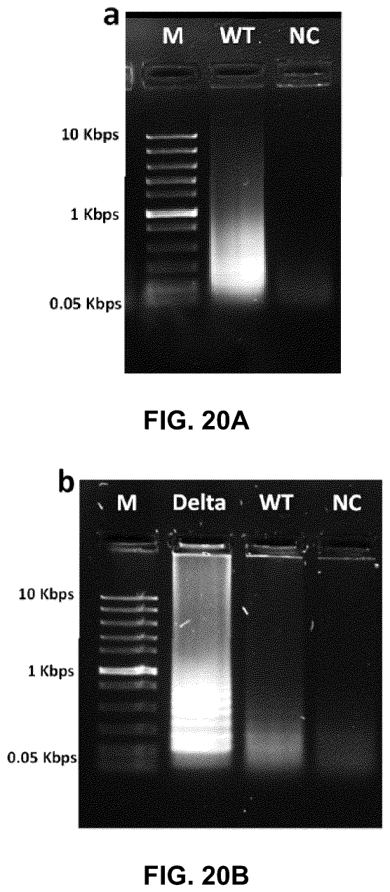

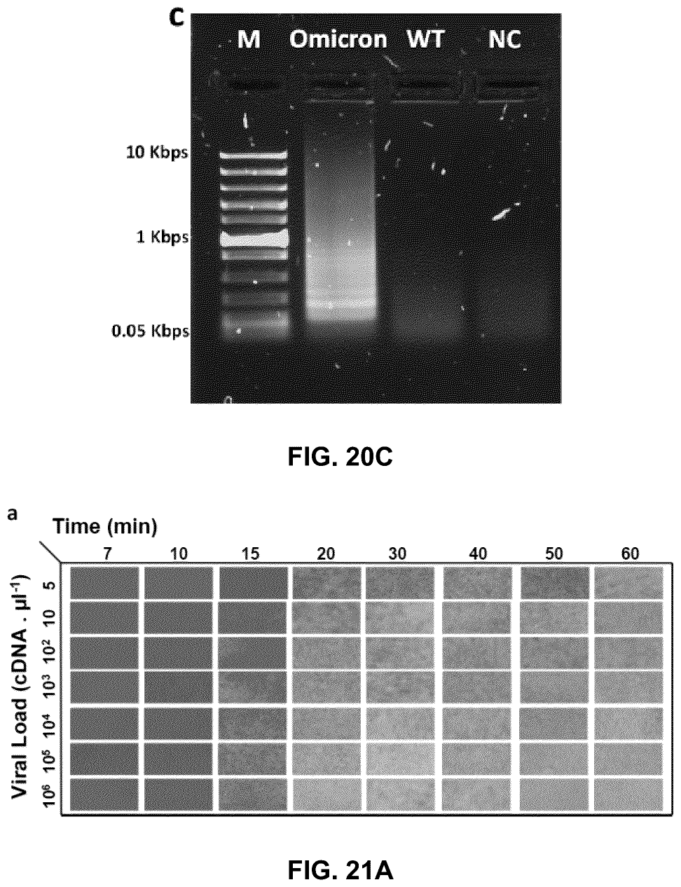

The versatility of the QolorEX platform can be extended to variants and subtypes when coupled with a highly sensitive rolling circle amplification assay (RCA). The RCA assay utilizes a highly efficient HiFi Taq DNA Ligase, which shows surged discrimination between mismatched and accurate base pairs at either 3′ or 5′-side of ligation. It was demonstrated that by utilizing three probes, the QolorEX system can differentiate wild-type (WT) SARS-COV-2 from Delta (B.1.617.2) and Omicron (B.1.1.529) variants (FIGS. 20A-20C). Two distinct common mutations with high association with these variants have been targeted. P681H is a non-synonymous mutation caused by C23604A single nucleotide polymorphism (SNP) which leads to the amino acid change of proline to histidine in the SARS-COV-2 spike protein. This mutation has been identified in the current variants of concern Alpha (B.1.1.7) and both omicron subvariants including BA. 1 and BA.2. P681H is associated with increased viral infectivity by reducing O-glycosylation which results in increased furin cleavage. The other non-synonymous spike protein mutation investigated in this study was L452R (resulting from T22917G SNP) which has a surged association with the Delta (B.1.617.2) variant and is linked with the high transmissibility. In this study, to detect P681H and L452R mutations that are caused by a single base change, RCA-based padlock probe (PLP) technology has been employed. Thus, the ligation step can be accomplished only in the presence of the target variant. The generated covalently closed circular PLP serves as a circular DNA template for the isothermal RCA reaction.

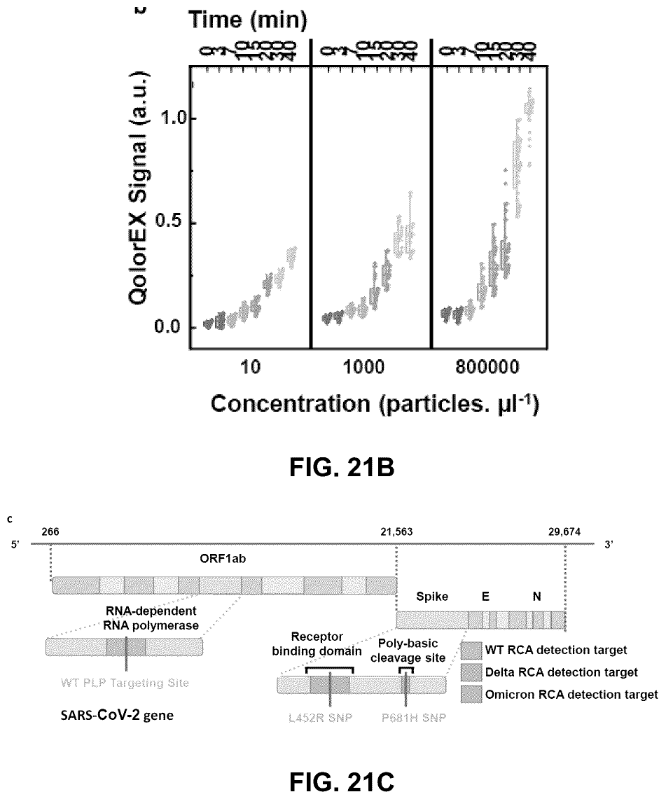

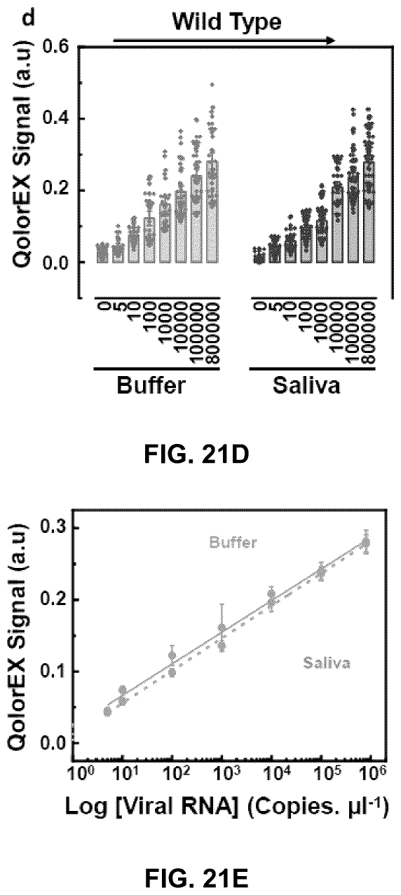

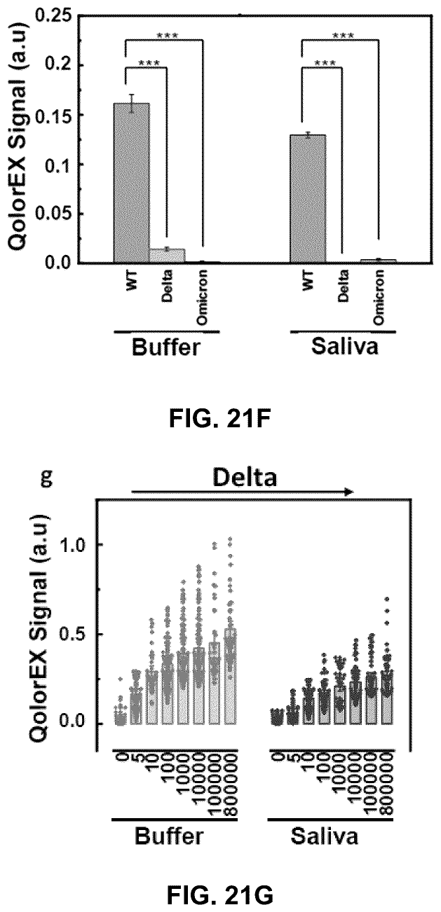

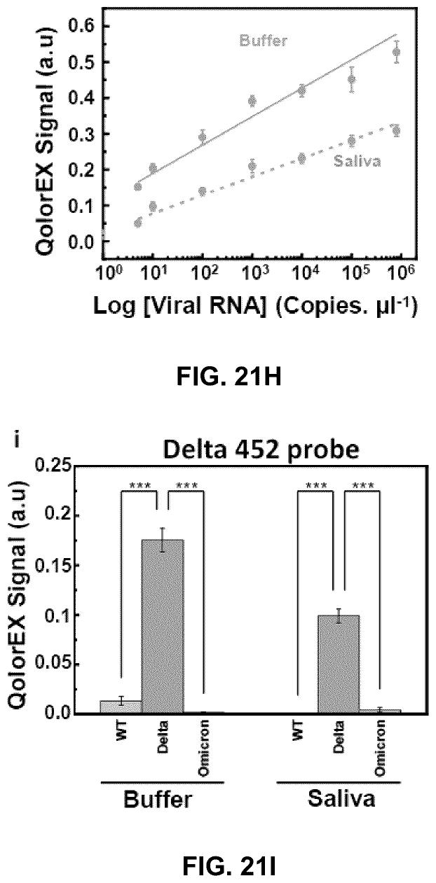

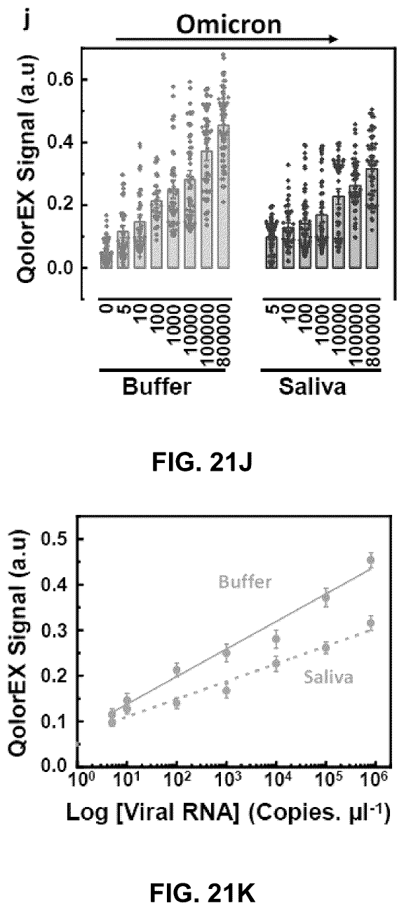

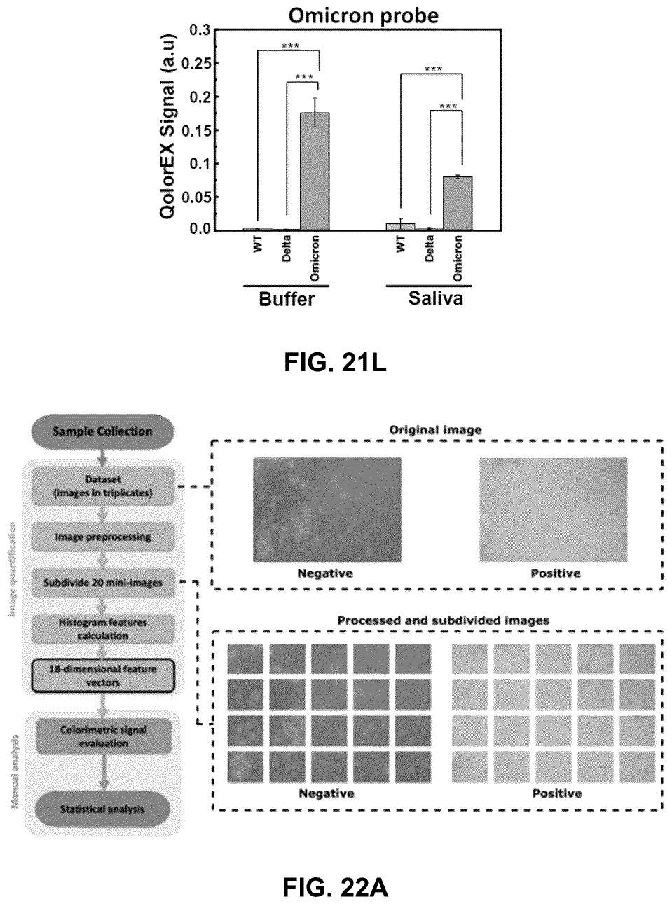

The RCA-based raw colorimetric readout for different concentrations of SARS-COV-2 cDNA shows a gradual color change during the 0 minutes to 60 minutes time lapse (FIG. 21A). Similar to the RT-LAMP assay, the raw colorimetric readout is automatically processed and the QolorEX colorimetric signal is evaluated. Positive detection signals show a consistent increase over time (FIG. 21B) with higher cDNA concentrations show an overall higher colorimetric signal. For selective RCA detection of SARS-COV-2 wild-type, RNA PLP-WT targeting the ORF1ab gene (FIG. 21C) was tested (QolorEX_{RCA-WT}). QolorEX_{RCA-WT} generated a quantifiable colorimetric signal for all tested concentrations of SARS-COV-2 cDNA within the range of 5 to 8×10⁵ cDNA copies/μL in buffer and human saliva media FIG. 21D. The colorimetric signal has a linear correlation with the concentration of SARS-COV-2 cDNA in both buffer and saliva (R_{buffer}²=0.98, Rₛₐₗᵢᵥₐ²=0.99) as shown in FIG. 21E with a limit of detection of 6.11 cDNA copies/μL in buffer and 6.37 cDNA copies/μL in saliva. Moreover, QolorEX_{RCA-WT} has shown selective detection of SARS-COV-2 wild type when tested with SARS-COV-2 cDNA, SARS-COV-2-Delta variant cDNA, and SARS-COV-2 Omicron variant cDNA. This is evident through the null comparison (FIG. 21F) on the result of the selectivity test demonstrating a significant difference between the SARS-COV-2 wild-type signal and other variants (p<0.001).

A PLP targeting the L452R mutation (FIG. 21C) provided sensitive detection of the SARS-COV-2-Delta variant (QolorEX_{RCA-Delta} assay). The colorimetric signal of SARS-COV-2-Delta variant cDNA in the range of 5 to 8×10⁵ cDNA copies/μL was assessed in buffer and human saliva, revealing an increasing trend with cDNA concentration (FIG. 21G). The signal has shown a linear relation with the Delta variant cDNA concentration in buffer and human saliva (R_{buffer}²=0.95, Rₛₐₗᵢᵥₐ²=0.96) as shown in FIG. 21H with a limit of detection of 6.84 cDNA copies/μL in buffer and 6.56 cDNA copies/μl in saliva. The QolorEX colorimetric signal in the saliva is 39%-43% lower compared to the buffer. This is due to the less regulated starting pH and higher viscosity of saliva compared to buffer, which increases the resistance towards electron transfer. Yet, the higher signal loss with the Delta PLP confreres that the padlock prop performance is impacted by the challenges posed by the saliva matrix. However, QolorEX_{RCA-Delta} maintained selective detection towards SARS-COV-2 Delta variant cDNA with a statistically significant signal difference in comparison to Omicron and wild-type SARS-COV-2 cDNA (FIG. 21I).

Omicron SARS-COV-2 variant cDNA was selectively detected using an RCA assay (QolorEX RCAOmicron assay) using a PLP targeting the P681H mutation (FIG. 21C). QolorEX RCA-Omicron detected SARS-COV-2 Omicron variant cDNA in the range of 5 to 8×10⁵ cDNA copies/μL in both buffer and saliva (FIG. 21J). Similar to the Delta PLP, the Omicron PLP performance is impacted by the complex saliva sample (up to 31% lower signal amplitude). Yet, the device maintained a quantifiable linear correlation with the Omicron variant cDNA in buffer and saliva (R_{buffer}²=0.97, Rₛₐₗᵢᵥₐ²=0.97) as shown in FIG. 21K with a limit of detection of 5.97 cDNA copies/μl in buffer and 5.36 cDNA copies/μl in saliva. QolorEX_{RCA-Omicron} has selective detection towards SARS-COV-2 Omicron variant cDNA with a statistically significant signal difference in comparison to Delta and wild-type SARS-COV-2 cDNA (FIG. 21L). The versatile application of the QolorEX system is solely dependent on the choice of the reagents, making it amenable to be used in different settings by untrained users for the identification of viral subtypes.

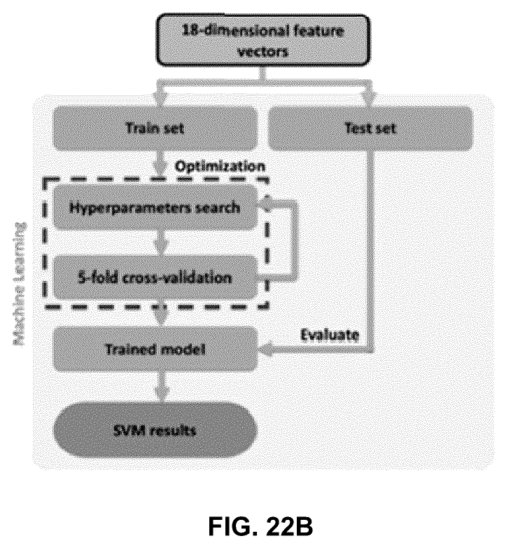

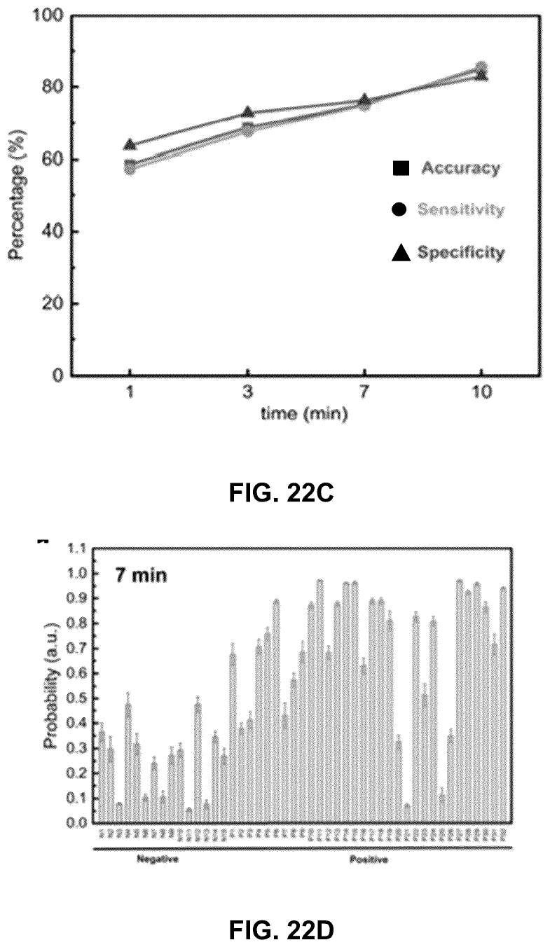

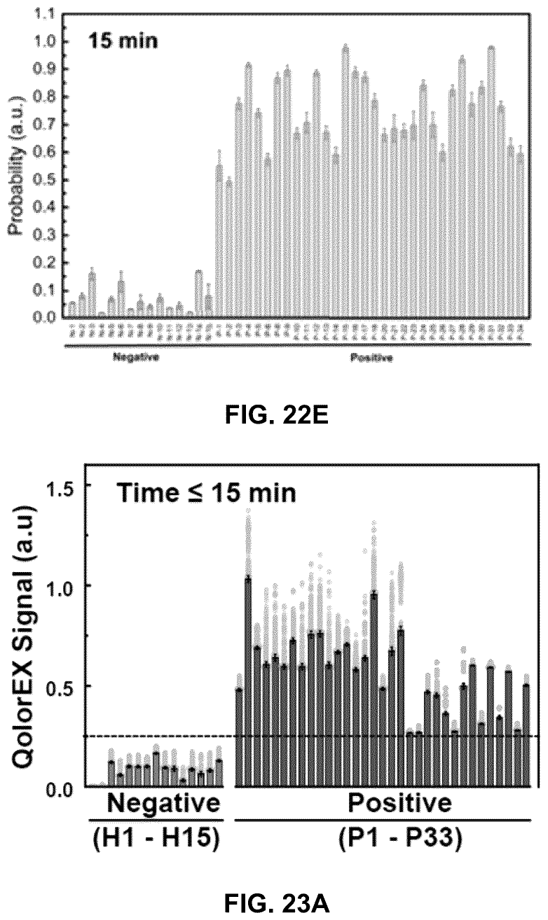

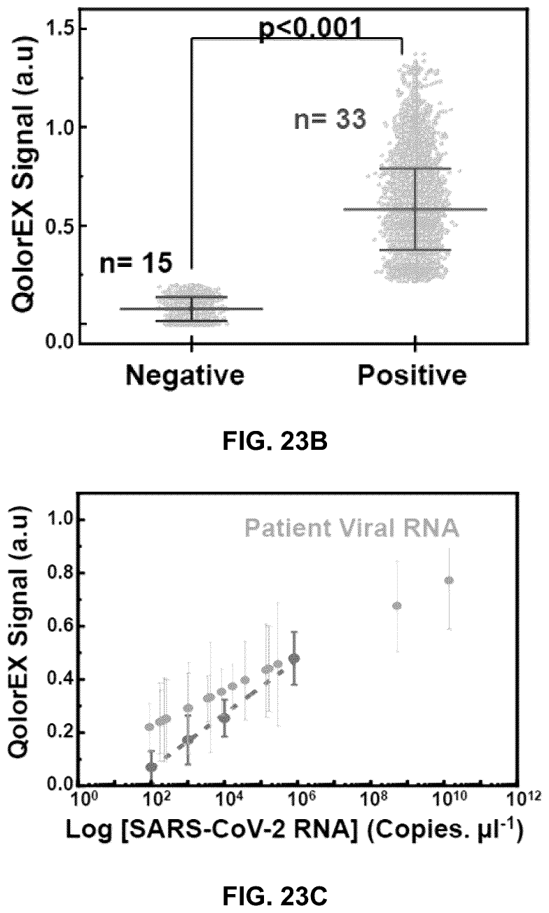

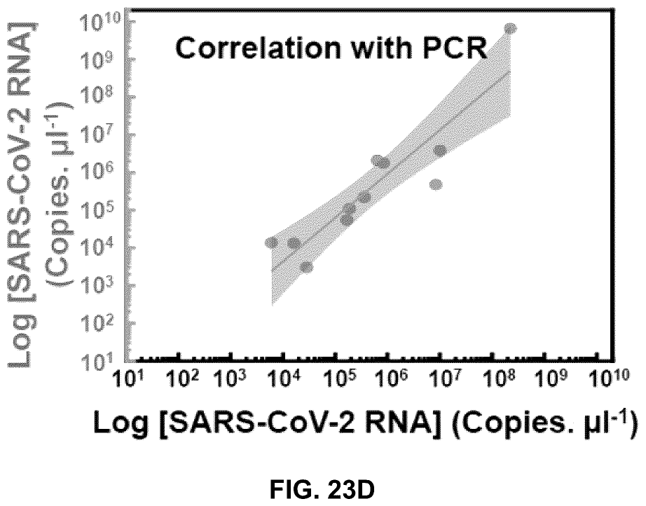

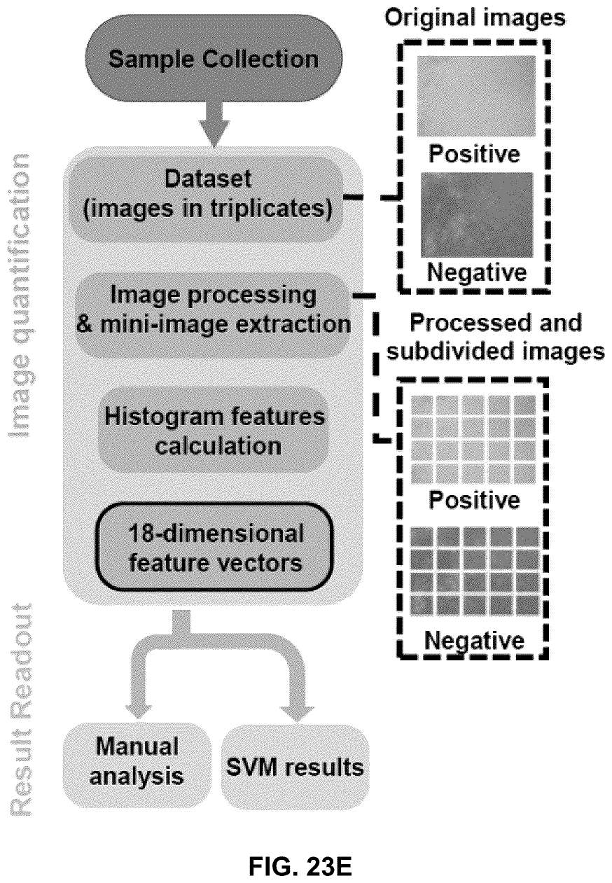

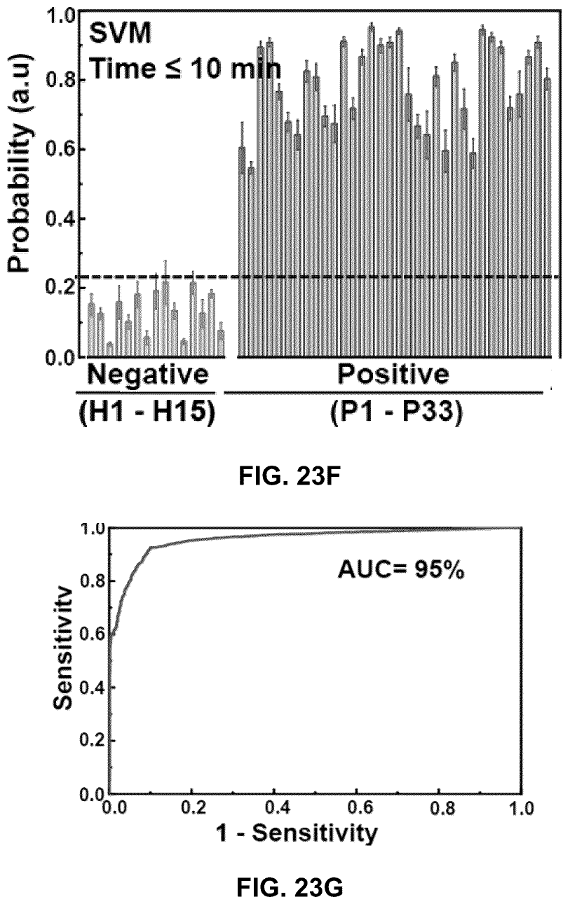

Real human samples are highly complex, so the evaluation of the QolorEX device with patient samples can determine its efficacy when challenged with untreated human biofluids. Due to the availability of testing samples in the past two years, QolorEX was validated with COVID-19 patient samples. With a two-step operation, the patients simply introduce their saliva into the QolorEX microfluidic cartridge and place the cartridge inside the imaging box. Inside the box, the sample will be processed and imaged in an automated fashion, and diagnostic results will be displayed on a cell phone or a computer. A set of raw human samples obtained from 33 patients clinically diagnosed with the wild-type SARS-COV-2 strain were analysed (FIGS. 22A-22E). Furthermore, a set of 15 SARS-COV-2 negative raw human samples were used in comparison with the SARS-COV-2 positive patient samples to establish the colorimetric signal threshold between patient and healthy samples (FIG. 23A). A post hoc Tukey's test reveals a statistically significant contrast (P<0.001) between the colorimetric signal of the SARS-COV-2 positive patient samples and SARS-COV-2 negative healthy samples (FIG. 23B). The positive sample's colorimetric signals were compared with the QolorEX LAMP signal calibration curve (FIG. 23C) to estimate the viral load distribution of SARSCOV-2 positive samples. Accordingly, positive samples showed a high correlation with the assay tested linear range. The patient viral load estimations based on QolorEX LAMP were studied in comparison to the standard qPCR test. The estimated viral loads were highly correlated with SARS-COV-2 positive patient samples (n=33) (FIG. 6D), having a similar median value of (3.6×10⁵ and 2.2×10⁵ RNA copies/μL). Subsequently, a machine-learning algorithm was used to classify the clinical samples into two classes: healthy (negative) and patient (positive). Each image per sample is subdivided into 20 mini-images and was used for the analysis of the distinct patient sample for a minimum of 60 mini images per time point per patient (FIG. 23E). The first 5 incubation time points were analyzed via a supervised binary SVM algorithm to determine the best results (FIGS. 22A-22E). The 10 min incubation time point presented the optimum point for detection (FIG. 22C). Accordingly, this SVM was implemented to obtain the probability of SARS-Cov-2 infection based on the images for each patient and healthy samples at the 10 min time point. This allowed a 75% reduction in detection time compared to the original RT-LAMP assay (10 mins compared to 40 mins). The average probability of each clinical sample was implemented to predict SARS-COV-2 infections (FIG. 23F) and established a threshold of 0.21 as the cut-off value to differentiate between healthy and patient samples. The cumulative true positive and true negative of patient samples are 100% and 100% respectively. The receiver operating characteristic (ROC) curve (FIG. 23G) of the classification of positive and negative samples shows an area under the curve of 0.95 per test, demonstrating the satisfactory performance of the SVM algorithm connected to the QolorEX system.

As demonstrated herein, the QolorEX system combines rapidity, clinically relevant sensitivity, specificity, and versatility for detection of a variety of pathogens (viruses and bacteria) in a multiplex automated fashion at the point of care on par with current FDA-approved molecular diagnostic tests. The first key feature of the QolorEX is the plasmonic color-sensing substrate confined in microfluidics that allows for ultra-rapid colorimetric signal transduction (10 min) by accelerating the amplification rate in RT-LAMP and RCA, and allows for ultrasensitive and specific detection of a few copies of genomic RNA/DNA in one-step amplification. The plasmonic color-sensing substrate oscillates upon illumination with white light, leading to the injection of electrons into the media that is consumed by the amplification assay, accelerating the reaction rate and enabling a 75% decrease (three-fold) in detection time compared to the original RT-LAMP assay. Unlike fluorescent read-out, which is commonly used in reading the amplification signals, QolorEX is a label-free colorimetric approach with a quantitatively linear scaling response as a function of the pathogen load that only requires tuning amplification reagents. By testing different respiratory viruses (SARS-COV-2, Influenza A H1N1) and antibiotic-resistant bacteria (E coli, MRSA), the versatility of the QolorEX was demonstrated for the specific detection of different pathogens (viruses and bacteria) as well as the differentiation between different target variants and subvariants (e.g. WT, Delta B.1.617.2, and Omicron B.1.1.529 for Covid-19) through detection of single nucleotide polymorphism. In the case of viral respiratory infections, the ability of QolorEX to differentiate between variants and subvariants would assist with the management of the virus spread and facilitate decision-making and planning globally. QolorEX is thus a versatile tool deployable for the detection of new pathogens and emerging viral variants as it only requires adjustment in amplification primers and reagents. The second feature of the QolorEX is the integrated microfluidic cartridge and the imaging box that allows for automation of sample collection, RNA/DNA extraction, amplification, and multiplex detection in a two-steps action by untrained users in 13 minutes (3 min lysis and 10 min detection). The automated fluid actuation system in the microfluidic cartridge incorporates the use of mechanically driven sub-millimeter-sized thin suction cups for generating negative pressure to drive and mix the sample and assay reagents in parallel fluidic compartments. This eliminates the need for auxiliary components such as pumps or complex chip design as required by capillary-driven systems. In addition, the imaging box custom-designed x-y translation stage with micron resolution holds the microfluidic cartridge and operates in tandem with controllers and linear actuators to achieve full process automation. Moreover, the imaging box reflected light microscopy module with controlled illumination, gives QolorEX similar performance as commercial microscopes using Koehler illumination in a much smaller dimension and a fraction of the cost. The final colorimetric event is captured by imaging the detection chamber using a CMOS sensor housed in the portable setup. Using a simple supervised machine learning data interpretation (SVM) connected to the signal transmission system of QolorEX, the results are displayed on a cellphone or a computer. All the key features of QolorEX allow for an automated user-friendly operation for lay users and testing patients simultaneously for multiple targets at the point of care.

The innovative design aspects of the QolorEX address limitations in the current point-of-care diagnostic tests in the areas of assay rapidity, versatility, multiplex detection of pathogenic strains and mutations, process automation, and ease of use for lay users. The QolorEX testing device was established in a clinical setting by successful validation with untreated samples (saliva) obtained from 33 patients clinically diagnosed with the wild-type SARS-COV-2 strain against 15 SARSCOV-2 negative samples. Accordingly, QolorEX achieved clinically relevant sensitivity and specificity with 95% accuracy on par with qPCR as required by WHO for point-of-care tests. The multiplexity aspect was tested by running QolorEX for every sample against Influenza A H1N1 and all known SARS-COV-2 variants to date (WT, Alpha B.1.1.7, Delta B.1.617.2, Gama P.1, Eta B.1.525, and Omicron B.1.1.529. With a two-step operation, the patients simply introduce their saliva into the microfluidic cartridge and place the cartridge inside the imaging box for further sample processing and imaging in a fully automated fashion. The cell phone interface has the potential for simple interpretation and communication of the test results for harmonized data collection and rapid evaluation in national and international large-scale trials. These types of systems are paramount for the spread management of respiratory infections.

### Example 2

Antimicrobial resistance (AMR) poses a grave threat to global health and remains a research priority. Overuse of antibiotics significantly contributes to the rise of AMR in human infections. Addressing this critical issue, the present example provides QolorAST, an ultrasensitive and fully automated platform designed for rapid bacterial identification and phenotypic antibiotic susceptibility testing.

QolorAST integrates a high sensitivity colorimetric detection based on plasmonic color-printing, microfluidic design, automated microfluidic device for confinement and reagent handling, custom illumination and image acquisition, as well as a supervised machine learning, support vector machine (SVM) method for rapid and accurate bacterial identification and phenotypic AST readouts. Central to its functionality is a plasmonic nanostructured material enabling ultra-sensitive optical readouts during the conversion of resazurin to resorufin-a pH-sensitive dye serving as a vital indicator of bacterial viability and growth during antibiotic exposure.

This versatile system adeptly determines minimum antibiotic inhibitory concentrations for 12 bacterial species against 7 antibiotics, showcasing its adaptability. By harnessing plasmonic color platforms, QolorAST achieves early detection, reducing genotypic identification and phenotypic profiling times to just 15 and 30 minutes, respectively. This is a monumental advancement, compared to the conventional 3-4 days with existing methods, that is achieved in a portable, automated, and multiplex fashion.

In rigorous validation through a double-blinded clinical study involving 47 clinical specimens from patients suspected of urinary tract infections, QolorAST demonstrated a 90% essential agreement and a 96% category agreement. QolorAST is therefore an improvement over the use of 96 well plate assays. By replacing such assays, QolorAST significantly slashes the time-to-result for antibiotic susceptibility testing. Its cost-effectiveness and efficiency mark a paradigm shift in global healthcare and controlling the pathogenic bacterial drug efficacy.

Conventional medical systems used in health care facilities are important keys to fight against pathogenic infections. Yet resource-limited settings, pose unique challenges due to interruption of electrical power, shortage of skilled professionals, and the lack of reliable automatic data processing systems. The conventional routine for infectious disease treatments involves empirical antibiotic prescription or long (2-3 days) man power intensive antibiotic susceptibility tests (AST) based on phenotypic bacterial growth. Therefore, a low-cost, rapid, automated, and easy-to-use AST operation can offer a user-friendly point-of-need-testing setting while remarkably reducing the miss prescription of antibiotics.

Colorimetric based assays are well established in clinical settings. They provide ease of operation, ability to be implemented in low resource settings, and no need for expensive reagents. Resazurin, is a pH sensitive and weakly fluorescent dye characterized by its dark blue color in its oxidative state while rendering fluorescent pink color upon reduced to resorufin in the presence of intercellular NADH. Traditionally, resazurin was used for testing cell viability indicators but due to its pH sensitive properties it can be utilized in genotypic detection based on pH sensing. Yet, traditional colorimetric assays lack analytical sensitivity and rapidity to output a quantifiable result and therefore suit unchaperoned point of need applications. Sensitivity in colorimetric sensing largely relies on the resolution of pigmented color that is captured, while the rapidity of the sensor depends on how fast the color change occurs according to the chemical reactions.

Non-pigment color systems, operating based on various physical resonances such as thin-film interference, Mei resonances, and surface/gap plasmons attracted huge interest in different applications including color displays, optical anti-counterfeiting, and sensing. According to Abbe's classical diffraction limit theory, an optical microscope ideally can resolve juxtaposed color elements down to a pitch of λ/2NA.

To explore these possibilities, QolorAST was developed, an automated point-of-need system coupled with a genotypic loop mediated isothermal assay (LAMP) for bacterial identification (ID) and a phenotypic resazurin reduction assay for antibiotic susceptibility profiling (AST). QolorAST uniquely utilizes nanoplasmonic colorimetric structures to enable rapid detection of the onset of color change and identify AST in less than 30 mins. The core principle of QolorAST signal generation is based on the reduction of the dark blue resazurin to light pink resorufin on top a plasmonic color printing platform where the plasmonic color is initially inhibited by the dark blue resazurin but is fully detectable at the early stages' reduction process. The resazurin reduction can be initiated through pH change (genotypic QolorAST assay) or due to the metabolic activity of viable bacterial cells (QolorAST phenotypic AST assay). It is demonstrated in the present example that the rapid plasmonic colorimetric detection leads to rapid identification (<15 mins) and phenotypic AST profiling (<30 mins). To fully automate the process, an autonomous imaging box was developed to allow integrated incubation, fluid actuation and imaging. The imaging box utilizes a unique cyclic filtration/actuation process to allow repeated and precise control over the temporal sample release. Finally, a supervised machine learning code was utilized for autonomous data analysis. Overall, QolorAST provides a complete solution towards bacterial identification (ID) and phenotypic AST profiling in less than 30 mins in comparison with 48 hours for the current conventional methods.

QolorAST combines unique technological innovations of high sensitivity colorimetric detector and econonomic 3D-printed microfluidic design, with well-validated genotypic ID and phenotypic AST readouts (LAMP and bacterial viability-based assays) and custom image acquisition and machine learning (support vector machine). The QolorAST device features two components that together present an automated, integrated and cost-effective approach to sample preparation, detection, and drug susceptibility test at the point-of-care or point-of-need. The microfluidic cartridge is a user-friendly platform with attached accessories for urine reservoir, preloaded reagent storage and flow actuation that automates the assay process when placed inside the colour reading module. The microfluidic cartridge includes two chambers; (i) a “mixing chamber” including urine reservoir, and preloaded reagent storage which is used to enrich bacteria, mixing, and the infusion of antibiotics; (ii) a “detection chamber” that is equipped with a plasmonic colour printed microchip for sensing. These two chambers are separated by paper filters. The QolorAST colour reading module that is a portable battery-operated platform that consists of linear actuators and a motorized stage for automated sample processing, and an illumination-coupled imaging system that operates with a Bluetooth-interfaced smartphone application. The antimicrobial resistance test involves four key stages using a microfluidic device which is discussed in greater detail below. Briefly, the first step, urine sample loading involves introducing the sample and ensuring even distribution within the inlet by covering the orifice, agitating, and using the inlet filling button, moving the sample towards the mixing junction with a suction membrane. Second, the imaging system adjusts to 37 degrees, autonomously mixing the sample with growth media and advancing it towards filters by raising the suction membrane to a first level (Level 1 (L1)). Third, a filtration process eliminates bacteria from the mixed solution, raising the suction membrane to a higher Level (L2) to bring the solution to the colorimetric window. In the fourth stage, imaging is performed for all 24 chambers by moving the stage beneath the objective, and the suction membrane is returned to L1 to reintroduce the filtered solution and combine it with bacteria. Steps 2 to 4 can be repeated sequentially as needed thanks to the bidirectional flow rendered possible by the suction membrane. Accordingly, it is possible to determine the fluorescence at different timepoints during the same assay by flowing the sample into the detection chamber and then back to the mixing chamber to continue reacting with the colour or other detection agents.

In this example, resazurin was used as a well-established bacterial viability-based assay. Resazurin is a well-known colorimetric assay that is widely used in clinical colorimetric read-out systems to identify the viability of the cells. Resazurin assay functions in two steps, first, the assay is absorbed by the membrane of the cell, and second, over the metabolic reactions in the live cells the Resazurin molecule is reduced to Resorufin. Consequently, the color of the cell medium will change from navy blue to light pink after a few hours evidencing a YES/NO metabolic sensor. This phenomenon is detected for more than four hours using the conventional method. However, the partially reduced resazurin can be sensitively detected via the QolorAST device integrated with plasmonic platform. This is thanks to the plasmonic features embedded in the detection chamber, allowing for rapid and sensitive colorimetric response based on the refractive index changes in the media. Unlike the conventional Resazurin assay paragons, QolorAST detection chamber executes a quantifiable color gamut providing information concerning the pathogen concentration, and antibiotic efficacy dose. The plasmonic parameters of the QolorAST were investigated via different physical characterization methods. The light interaction with the plasmonic platform is the key parameter in determining the superlative color gamut that in turn enables higher resolution in colorimetric AST. Therefore, a comprehensive theoretical study was performed via finite-difference time-domain (FDTD) to optimize the geometrical parameters with a deeper understanding. Unlike the conventional use of resazurin assay which indicates the color transition from blue to pale pink upon absorption within the cell membrane and gets reduced by the metabolic reactions within the cells, the detection chamber ratifies a wide gamut of high-resolution colors, from dark blue to green, which generates a quantifiable and sensitive measure of the live cells. Sensitivity in colorimetric sensing largely relies on the resolution of pigmented color that is captured, while the rapidity of the sensor depends on how fast the color change occurs according to the chemical reactions. The light interacting with resonances associated with the discrete harmonic energy states are structurally engineered, and could offer new opportunities to enhance the colorimetric sensing. The plasmonic enhanced color-generation strategy involves the patterning of various geometrical metallic nanostructures and investigates the hue and gamut of colors experimentally. The optimization of the plasmonic platform included the selection of material, nanoparticle diameter, and thickness of the metallic layer. Moreover, the morphology was characterized via SEM and AFM microscopy. The reflectance spectra of plasmonic platforms with different nanoparticle diameter was experimentally investigated. The 400 nm diameters particle platform showed the widest gamut change during the reduction of resazurin to resorufin. This was further confirmed through a theoretical FDTD study to visualize the local EM-field enhancement and identify the modes of excitation for platforms with different nanoparticle diameters. Finally, the microfluidic device parameters were optimized to enable endurance of the plasmonic detection chamber.

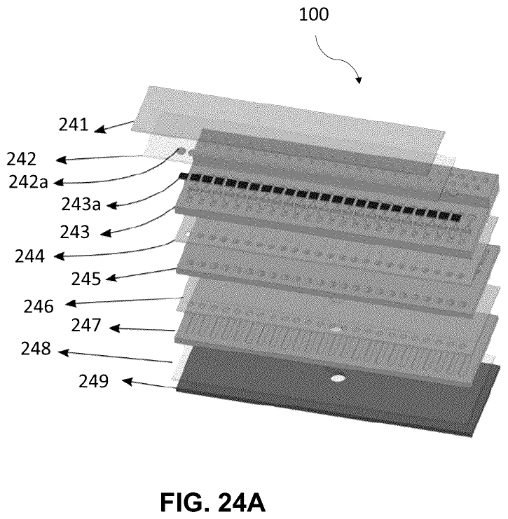

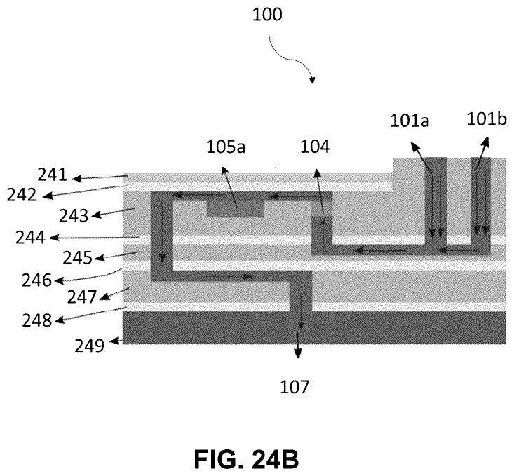

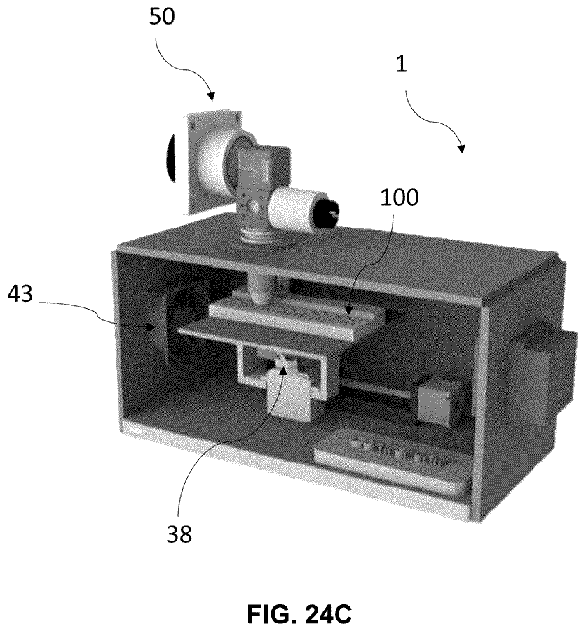

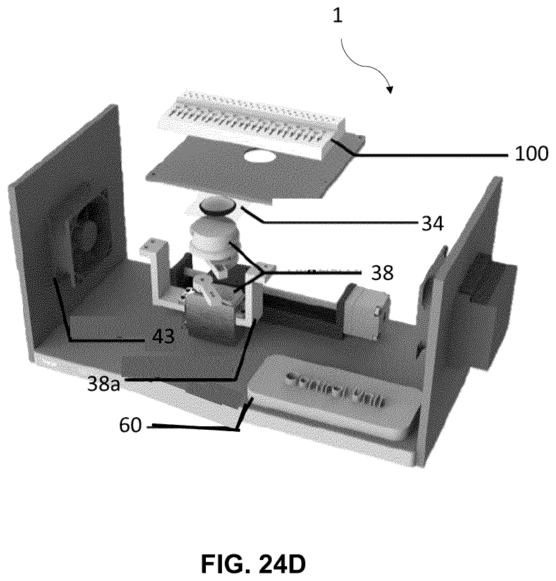

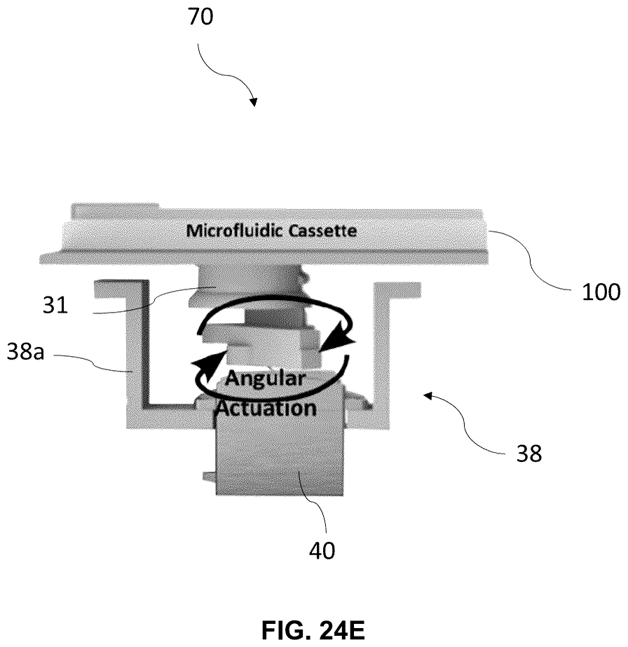

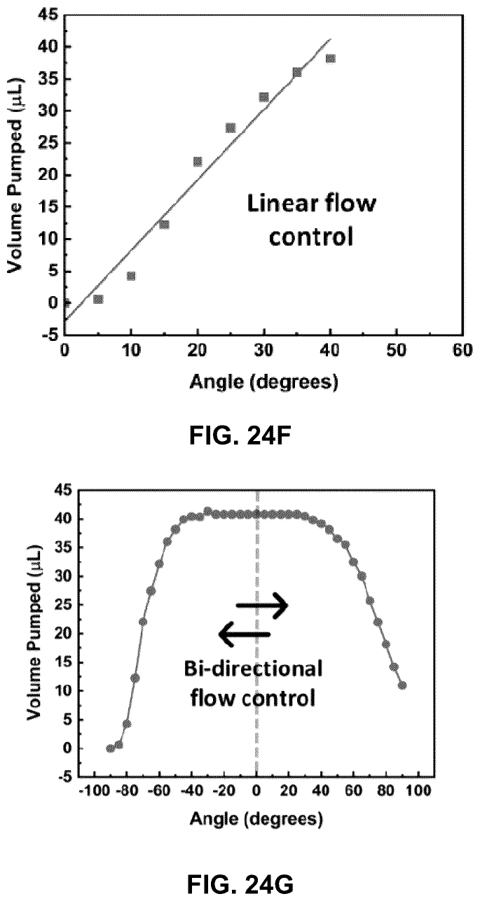

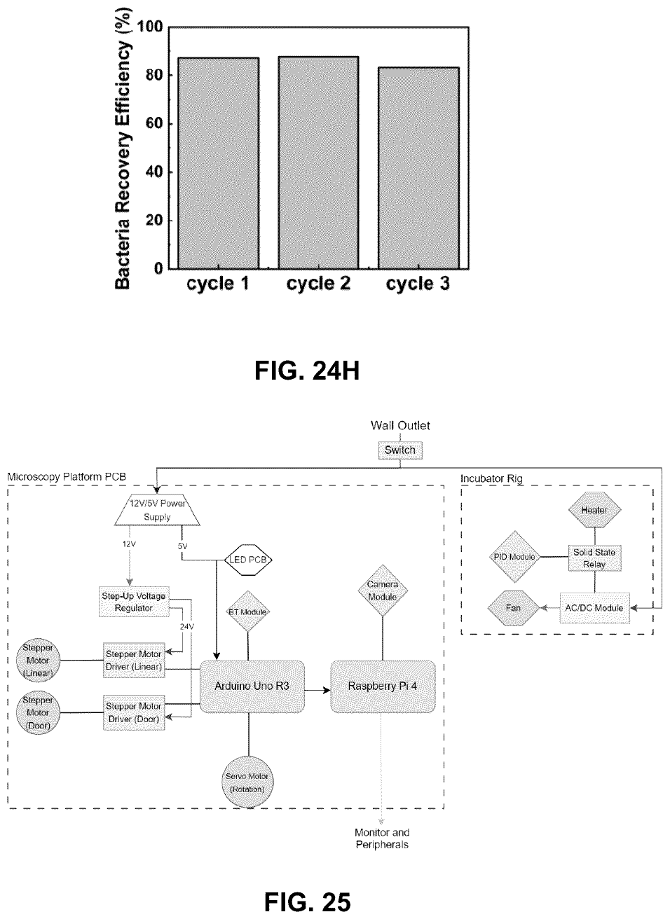

For QolorAST, a microfluidic device was developed with three primary objectives: First, to facilitate the mixing of urine samples with antibiotics and detection reagents. Second, to filter the sample, producing a bacteria-free solution suitable for imaging. Finally, to position the bacteria-free solution over the colorimetric detection chamber. The design of this microfluidic device has the capacity to conduct twenty-four independent tests concurrently within separate channels. The microfluidic device 100 as shown in FIG. 24A consisted of nine distinct layers, including a thin glass layer 241, a paramagnetic finishing layer 249, and three 3D-printed layers 243, 245, 247 that are bonded together using four adhesive layers 242, 244, 246, and 248.

The first 3D-printed layer 243 serves as the reservoir for the urine sample and detection reagent, as well as the location for the filters and colorimetric platforms (FIG. 24B). The second 3D-printed layer 245 accomplishes the mixing of the urine sample with the detection reagent with a ratio of 4:1 and conveys the resulting solution beneath the filter 104. After passing through the filter the solution reaches the sensing chamber and passes over the plasmon nanosurface 105a. The third 3D-printed layer 247 provides additional volume reservoirs situated after the colorimetric window. Since all channels are actuated using a common suction system (where all channels ultimately connect to a single source at a junction point), these extra volume sample reservoirs have a role preventing unintentional mixing of solutions in separate channels at the junction point. The first 3D-printed layer 243 is covered by a thin glass layer 241, ensuring a clear view for colorimetric imaging. The bottom of the microfluidic device 100 is covered with a paramagnetic layer 249, which establishes a strong and detachable connection between the microfluidic device 100 and the imaging system having a magnetic surface. The layers are securely bonded together using patterned pressure-sensitive adhesives (PSA) 242, 244, 246 and 248.

The 3D-printed components are designed using CAD software (SolidWorks 2022 SP5) and fabricated using a Stereolithography-SLA 3D printer (FormLabs-FormLab). The PSA patterns are designed using CAD software (Graphtec Studio) and transferred onto biocompatible PSA material (Adhesive Research-ARcare 90445Q) using a cutting plotter (Graphtec-CE7000-40). The filters 104 with a 0.45-micron pore size hydrophilic polyethersulfone membrane (Pall) are punched and securely bonded to the microfluidic device using the plotted PSA. The paramagnetic layer 249 is made from tight tolerance air hardening A2 tool steel bar (McMaster-Carr) with 1.6 mm thickness.

The antimicrobial resistance test was conducted using the microfluidic device of FIGS. 24A-24B and was performed in four primary stages. First, the sample loading begins by introducing the urine sample through an opening located at the device's top via a tape. Then, the orifice is covered with another tape and the device is agitated to ensure even distribution of the urine sample within the inlet. The inlet filling button is activated to move the urine sample towards the mixing junction. Subsequently, the growth media inlet and suction ports are opened, and the microfluidic device is placed the device inside the imaging system FIG. 24C. Second, the temperature of the imaging system is adjusted to 37 degrees to facilitate bacteria growth. The imaging system will autonomously mix the urine sample with the growth media, advancing the sample towards the filters by raising the mixing suction cup to a specific level (L1). After mixing, allow the bacteria to grow beneath the membrane for a designated duration. Third, us afiltration process where the mixed solution is passed through the filter to eliminate bacteria from the solution. Bring the solution to the top of the colorimetric window by raising the mixing suction cup to a higher level (L2). Fourth, imaging is executed for all 24 chambers by moving the stage beneath the objective. By returning back the mixing suction cup at level L1, reintroduce the filtered solution and combine it with bacteria. The steps 2 through 4 can be repeated and tested sequentially.

The automated QolorAST setup is depicted in FIGS. 24C-24D. The setup is broadly comprised of two main modules, (i) image capture module 50, and (ii) incubation and process automation module 70. The major components of the image capture module 50 are previously described in Example 1, and the incubation and automation module 70 is shown in FIG. 24E. An angular actuation turns the screw 31 with angular servos 38a. The image capture module employs an epi-imaging format for capturing the colorimetric signal from the plasmonic nanostructured platform. The incubation and automation module performs two main operations, a. bi-directional microfluidic pumping and b. incubation for the colorimetric reaction. These capabilities enable filtration of bacteria from the sample upon mixing with the resazurin-antibiotic mixture followed by incubation in the detection chamber and capture of colorimetric event. Repetition of this process for multiple cycles/timepoints necessitates a precise and controlled bi-directional microfluidic pumping capability. An angular actuation of a suction membrane 34 which acts as a modular elastomeric chamber for control of the fluidic pumping in the cassette. The core principle is the manipulation of the fluidic pressure in the cassette via control of volume of air under compression in the elastomeric chamber. This volume pumped is correlated as a function of angle rotated by the servo motor (FIG. 24F). The linear correlation enables precise control over fluid pumping via digital programming a microcontroller—here an Arduino UNO. Further, the angular actuator confers symmetric and repetitive flow control of the fluid in two directions (FIG. 24G). This enables multiple repetitive cycles of filtration, incubation, and detection in an automated fashion. The filtration and subsequent recovery of the bacteria in the sample is demonstrated with a fluorescent E. coli spiked sample (FIG. 24H). To optimize the filtration and recovery of the bacteria for repetitive cycles, Asymmetric Super Micron Polysulfone (MMM) filter was employed with a pore size of 0.45 μm. The asymmetric filter exhibited low biomolecule binding affinity while being highly wettable. The system reached a recovery efficiency of 86% when loaded with a concentration of 10⁴ CFU/ml fluorescent E. coli.

A custom PCB was designed to minimize the electronics' size footprint and improve the system's rigidity. An Arduino Uno R3 was used to run most of the components operating the microscopy platform for the imaging apparatus. FIG. 25 illustrates a high-level overview of the connections between motors used to run the movement of the microscopy platform and the microcontrollers. Two Allegro-A4988 stepper motor drivers were connected to a Pololu Fine-Adjust Step-Up Voltage Regulator to obtain 24V for powering the stepper motors. One mini Nema 11 bipolar stepper motors was used to move the sample linearly about the X-axis, while the other was used to open a door to the imaging apparatus for loading samples. A small 25 kg DSSERVO servo motor was used to rotate the sample along its planar axis. An HC-05 Bluetooth module was connected to the Arduino for wireless communication. A small custom LED PCB was also connected to the Arduino which operates a Lumileds white 4000K mid-power LED for illuminating the sample. Lastly, a Raspberry Pi 4 was connected to a high-quality Raspberry Pi camera module, and the microcontroller itself is connected to a monitor and peripherals (keyboard and mouse) to view the sample in real-time.

Additionally, a smaller incubator set-up was connected separately which ran the same Yosoo heater and fan combined device but was connected to the Inkbird ITC-100 PID module for discrete temperature control. Both this incubator and the microscopy platform PCB were connected to a two-plug power bar with a built-in switch and fuse protection. Therefore, the entire system is turned on and off via this switch which allows for it to remain plugged into a wall, but it does not draw power until the user decides to do so.

The outer enclosure of the setup was built using 0.25 inch thick Clear Scratch and UV-Resistant Cast Acrylic Sheets (#8505K755, Mcmaster carr). The epi-illumination imaging set-up was employed for imaging the media over the nanostructured platform. The setup features an illumination column with a LED placed at the focal point of a diffuser convex lens. The collimated beam then reaches a beam splitter that projects the light onto the back aperture of the objective (TU Plan Fluor EPI ×20, Nikon). The captured image is focused using a tube lens (f=200 mm) onto a CMOS sensor (Sony IMX477R, 12.3 MP, Raspberry Pi.) and processed further by Raspberry Pi 4 (Raspberry Pi).

The electronic system of the apparatus consists of three main blocks: the incubation block, which includes a small space constant temperature fan heater (PTC heater, Yosoo), a solid state relay (SSR-25 DA, Jekewin), an AC/DC power supply (S-60 W-12, YXDY), and a PID temperature controller (ITC-100VH, Inkbird); the imaging block, which includes a single-board computer (Raspberry Pi 4 Model B, Raspberry Pi), and a 12.3 MP high quality camera (697-1, Raspberry Pi); and the axis movement block, which includes a microcontroller board (UNO R3, Arduino), two stepper motor drivers (A4988, Pololu), two stepper motors (11HS12-0674S, NEMA), a servo motor (DS3225, DSSERVO), a HC-05 Bluetooth module (1258, Canada Robotix), and a 12/5V power supply (TOL-15664, SparkFun). The system's workflow involves the Bluetooth module receiving commands to move the sample via the stepper motors and servo to pre-set positions while the camera module displays the sample through the microscope to a monitor. Independently, the incubator block maintains a temperature of 37° C. which can be adjusted via the PID temperature controller.

The fabrication of the QolorAST microfluidic was done as follows. The detection chamber (3 mm×3 mm×1 mm), microfluidic channels and inlet/outlet ports (01.5 mm) were designed using CAD software (SolidWorks 2022 SP5, licensed by CMC) and fabricated using a Stereolithography-SLA 3D printer (FormLabs-FormLab3). The PSA patterns are designed using CAD software (Graphtec Studio 2) and transferred onto biocompatible PSA material (Adhesive Research-ARcare 90445Q) using a cutting plotter (Graphtec-CE7000-40). The filters with a 0.45-micron pore size hydrophilic polyethersulfone membrane (Pall) are punched and securely bonded to the microfluidic device using the plotted PSA.

Plasmonic platforms were fabricated using a fabless nano-patterning technique. A generic approach is used to develop a colloidal self-assembly monolayer (SAM) of nanoparticles at a water/air interface 48, followed by transferring the resulted honey-comb patterns to the silicon (Si) substrate. Next, a ZnO thin film (120 nm) is deposited, followed by a thin aluminum layer (10 nm) to provide a tunable localized surface plasmon resonance with a white background. Last, the plasmonic platform is integrated with the microfluidic cartridge.

The fast colorimetry strategy based on the plasmonic substrate involves patterning of metallic nanostructures with sizes smaller than of diffraction limit of light to support plasmonic oscillations as described in greater details above. Unlike the organic-dye color filters, the plasmonic color filters offer advantages such as high color tunability, sensitive color changing based on medium permittivity, and low color degradation rate. Amongst the plasmonic nanostructures used for plasmonic color production are nanodisks, ellipses, nanocubes, and multimers made of plasmon-supported materials such as using gold, silver, and aluminum. The geometrical nanostructures and materials can be designed to resonate at a specific optical frequency leading to the production of different colors across the visible spectrum. Direct-write technologies such as e-beam lithography and focused ion-beam lithography are the most commonly used patterning techniques allowing for high resolution and placement accuracy, however, they are time-consuming, expensive, and do not allow large scale production. Fabless approaches such as sacrificial polymeric nanoparticle templates, controlled phase separation, mesoporous particles assembly, and colloidal particles self-assembly have been found promising alternatives for large-area patterning.

The imaging studies of the present Example were all performed by collecting images in triplicates for each timepoint (from 0-60 min) and condition combination, integrating a database for each bacteria studied. Each image in the datasets is cropped to 80% of its original dimensions to avoid the coffee-ring effect, followed by a brightness normalization. Additionally, defects on the images are removed by implementing a threshold that removes 25% lower saturated pixels and replaces them with the mean value of the rest of the image, having as an output standardized images.

In the manual color signal evaluation, for each image, the code selected 30 areas at random, read, and averaged their RGB values. The G/B color feature was calculated by dividing the Green channel value by the blue channel value (Eq. 1) and depending on a pre-established threshold the Green channel was modified by doubling or dividing by half its value, and so the color feature was recalculated as Gmod/B (Eq. 2) prior to statistical analysis. For the CIE plots, the RGB values were converted into XYZ, followed by the x and y values calculation which were scattered on the CIE1931 color space to analyze the color change through time. All images were processed and analyzed through python and MATLAB™ scripts.

$$G / B = \frac{{G}_{value}}{{B}_{value}}$$

$${G}_{mod} / B = \frac{{G}_{mod - value}}{{B}_{value}}$$

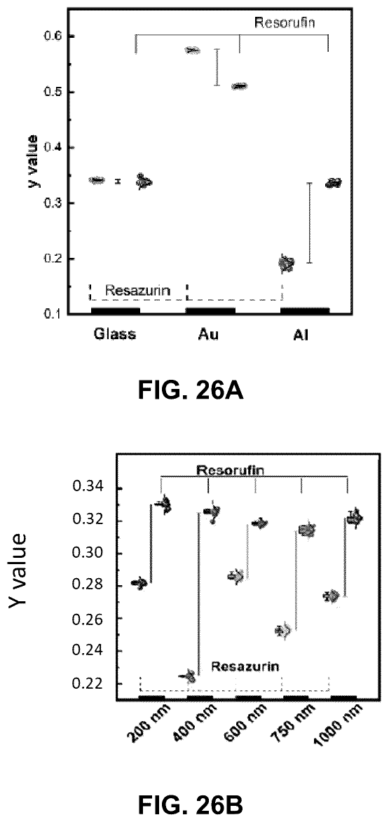

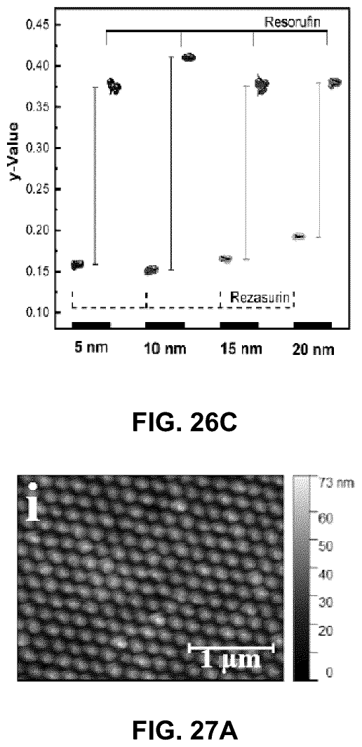

One of the characteristic parts of QolorAST is the detection chamber embedded with plasmonic nanostructures to determine the viability of bacteria infused with antibiotics in the presence of Resazurin assay. It was herein methodically investigated the optimized characteristics of the PC platform experimentally and theoretically. It is essential to remember that the color of the plasmonic platform other than the refractive index of the media depends on the choice of the metallic layer and the geometrical features of the plasmonic nanostructures i.e. size and pitch of nanoparticles. Silver, gold, and aluminum are the most commonly used. First, the choice of the metallic layer was studied. Silver was excluded due to its antibacterial properties which would interfere with the AST resulting in false negatives. Next, the color change from resazurin to resorufin was studied using glass platform, 750 nm Au platform, and 750 nm Al platform. To investigate the wideness of color gamut between the resazurin and resorufin, RGB values were extracted from the microscopy images and converted to x-y coordinates on standard CIE 1931 chromaticity diagram using standard conversion models. The Al platform showed a wider color gamut compared to Au and glass platforms demonstrated by the greater change in the y-value of 0.17 for the Al platform compared to 0.075 and 0.01 for the Au and glass platforms respectively (FIG. 26A). Thus, the metal of choice is Al which has the widest color gamut, long shelf life due to the formation of a thin oxide layer 18, and low cost. Second, the effect of the size and pitch of nanoparticles was studied. In a close-packed lattice of the self-assembled nanoparticles, the diameter of the nanoparticles also determines the pitch of the lattice, therefore, platforms made of polystyrene (PS) nanoparticles with diameters from 200 nm to 1000 nm were investigated in different media. To investigate the optimized geometrical size of the plasmonic monolayer, first, the color of the plasmonic PS monolayers in different media; air, water, LB, Resazurin, and Resorufin, was captured under a highly controlled environment through bright-field microscopy with a ×100 air objective and a digital CCD color camera (refer to the methodology for further specifications). The absorption efficiency of the plasmonic nanoparticles in each medium with a specific refractive index determines the vitality of the generated color. The energy of the beam incident is removed from the beam path upon its interaction with the plasmonic matter by absorption and scattering. It was found that the color sensitivity of the plasmonic platform depends on the diameter of the PS nanoparticles. In each media, the same self-assembled plasmonic substrate was used to eliminate the shape factors, structural defects, and other matrix effects. The lattice made by 400 nm nanoparticles demonstrated a larger color gamut between Resazurin (navy-blue) to Resorufin (cyan-green). To confirm it, the y-value of 30 random points were derived from each platform in Resazurin and Resorufin and plotted via a dot-plot graph (FIG. 26B) demonstrating the highest distance between the y-value of the platform in Resazurin versus in Resorufin is attributed to 400 nm PS nanoparticles. Last, the optimum thickness of the Al layer was investigated. Accordingly, 400 nm plasmonic platform with 5 nm, 10 nm, 15 nm, and 20 nm Al thickness were tested for color change between Resazurin and Resorufin. The 10 nm Al film exhibited the widest color gamut between Resazurin and Resorufin from a chromaticity diagram, and confirmed by the y-value dot plot FIG. 26C.

For characterizing the surface morphology of the nanoparticle monolayers tapping mode atomic force microscopy (AFM) and scanning electron microscopy (SEM) techniques were performed. Optical characterization was carried out with a Lambda 750 UV/Vis/NIR Spectrophotometer (PerkinElmer). The incident and collected light beams had normal incidence to the platform. Also, we performed optical imaging under a highly controlled environment using Nikon Eclipse LV150 (Nikon) with a ×100, 0.9 NA air objective and Nikon digital sight ds-fi1 CCD camera. The fundamental fluid flow characteristics of the microfluidic cartridge were studied using COMSOL Multiphysics (V5.6).

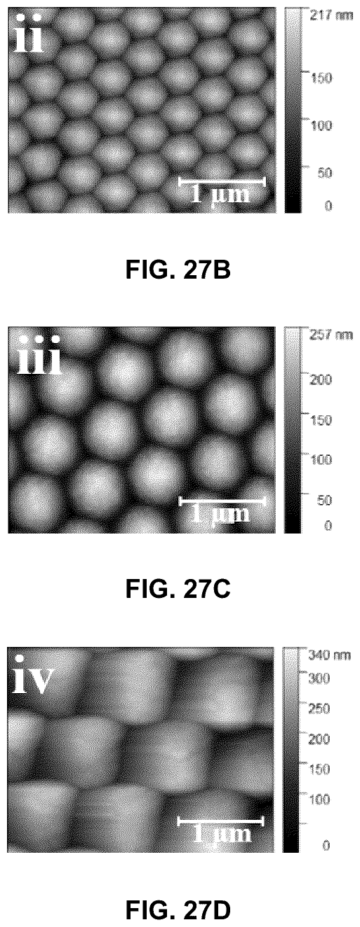

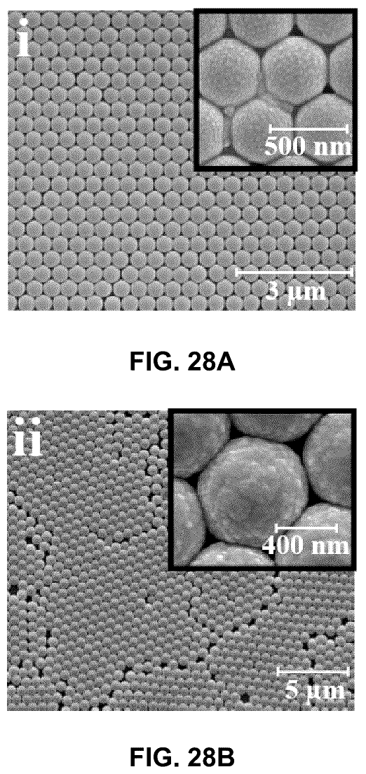

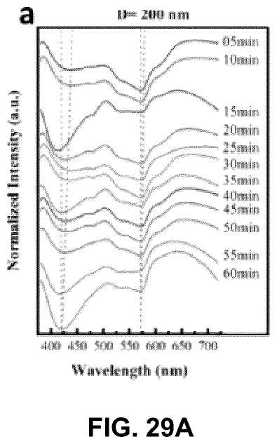

AFM micrographs for 200 nm, 400 nm, 750 nm, and 1000 nm platforms are shown in FIGS. 27A-27D respectively. These images show the hexagonally structured lattice of the nanoparticles self-assembled monolayer. SEM scans of the 400 nm and 750 nm platform are shown in FIGS. 28A-28B respectively. Different magnification powers were used to give both wider and more detailed views of the assembly quality and compactness of the nanoparticles self-assembled monolayer.

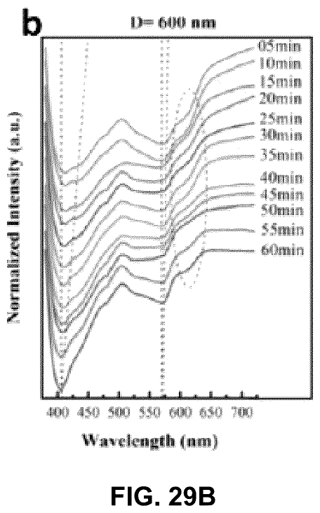

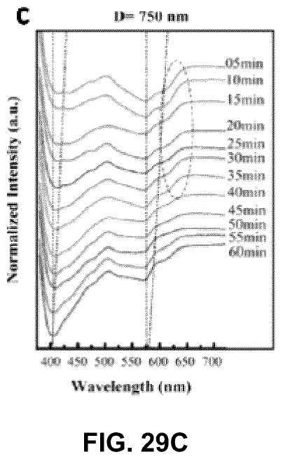

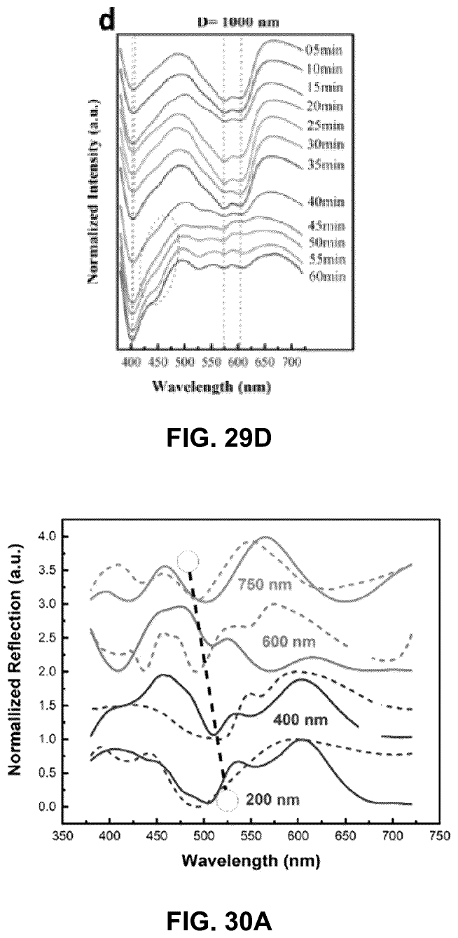

The reflectance spectra was investigated for the 200 nm, 600 nm, 750 nm, and 1000 nm plasmonic platforms performed in water-based media (FIGS. 29A-29D). The origin of the different resonances can be attributed to the two-fold role of the plasmonic structures. Local resonances are responsible for color shifts. Localized surface plasmon resonance (LSPR) given by dipolar coupling between adjacent structures and surface plasmon resonance (SPR) from the structured array gives rise to hot-spots regions located by the space given by the cavity length and space in between structures, also known as nanocavity. In our system, the periodic bumps formed by nanoparticles act as coupling elements to excite propagating surface plasmons (SPs) on the surface. Since the Al layer is ultrathin, these SPs couples to the top metallic-liquid interface. The light re-radiated from those coupled plasmons interferes with the directly reflected light and generates resonance dips in the reflection spectrum. At shorter wavelengths, a sharp reflectance dip is expected to translate the lattice resonance. Opposite, at longer wavelengths the dips attributed to high-order mode are expected to be broader. The penetrated propagating SP modes are subjected to alter by changing the refractive index (RI) of the medium. The additional informetric dip correlated to Resazurin media is demonstrated by a dotted line. For the color-sensitive sensing application described herein, we chose the second spectral feature (dip) that showed the best sensitivity towards the changes in the refractive index of the liquid media. The high order mode dip exhibits a blue shift along with the reduction of Resazurin to Resorufin. The 400 nm plasmonic platforms show the widest high order dip blue shift for Resazurin to Resorufin reduction (ΔDip=36 nm) compared to the 200 nm, 600 nm, 750 nm, and 1000 nm platforms with a blue shift of 2.5 nm, 3 nm, 31 nm, and 5 nm. This indicates that the 400 nm plasmonic platform generates a wider color gamut during Resazurin to Resorufin reduction and thus allows more sensitive detection of color change.

A FDTD theoretical simulation was also performed. A strong EM field generated in plasmonic nanopatterns is of importance to control the hue and saturation of the generated color. These effects in the device were investigated via a simulation study based on the finite-difference time-domain (FDTD) module of Lumerical Solutions. The visualization of the local EM-field enhancement is of interest to identify the modes of excitation and therefore help with the design of the optimized colorimetric substrates. The EM-field contour plots were simulated using a plane wave with wavelength in the visible range (400-700 nm) excitation. The simulation resulted top-view and side contour plots of a self-assembly nanoparticle pattern illuminated with a Gaussian beam centered at 532 nm wavelength in transverse electric (TE) and transverse magnetic I modes, revealing the total EM-field enhancement, (|E|/|E₀|).

The conventional metric to study the superiority of the structure is the absorption efficiency which is the ratio of the absorption cross-section to the geometric cross-section. The absorption efficiency for a cylindrical particle illuminated along its axis is given by

$${Q}_{abs} = \frac{4 {σ}_{abs}}{π {d}^{2}}$$

where d is the diameter of the nanoparticle and σ_{abs} is the absorption cross-section which can be calculated by dividing the power absorbed by nanoparticle over the incident irradiance. Based on the absorption cross-section and the absorption efficiency for different sizes of nanoparticles the electric field distribution is changed on the plasmonic surface which can be simulated using the FDTD module of the LUMERICAL software package. To theoretically study the electric field of plasmonic platforms, a series of simulations were performed. The electric field distribution was simulated in the plane-wave excitation with a plane wave in the visible range (wavelength of 400 nm-700 nm) for D varying from 200 nm, 400 nm, 600 nm, and 750 nm.

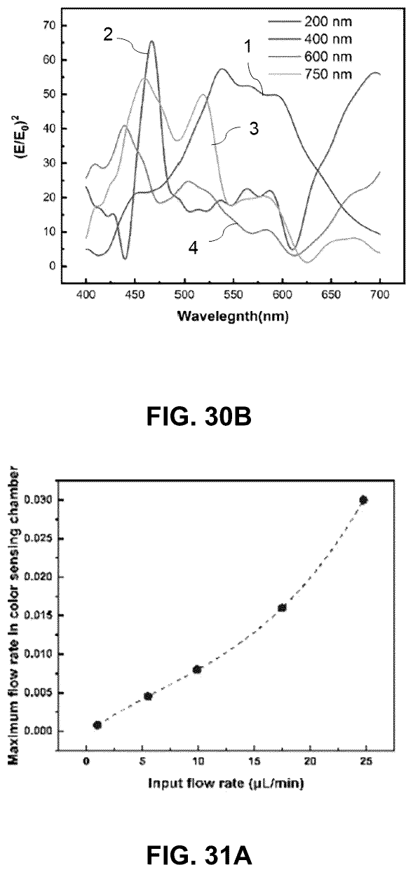

The experimental and simulated broad-band reflectance spectra (FIGS. 30A-30B) shows analogs spectra demonstrating a sharp absorption between 500-540 nm correlated to the diffraction mode. For PS nanoparticles with a diameter larger than 250 nm the diffraction mode blueshifts when D increases, as governed by the dispersion characteristics of SPR. The peaks in the measured spectra were broader than the corresponding simulation results, likely due to ensemble averaging and higher scattering losses in the Al layer.

With noticeable hotspot along the nanocavities formed by the pitch of the SAM, which directly correlates to the diameter of the nanoparticle, the EM-field distribution demonstrates over enhancement factor at the nanocavities of the SAM in TE mode.

A numerical simulation study of the fluid flow inside the microfluidic chip was conducted. The microfluidic system provides the ability to filter the bacteria sample as well as providing accurate control of fluidic flow rate and pressure over the self-assembly monolayer (SAM). Bacteria is captured using the a paper filter; therefore, a pure liquid is passing over SAM which reduces a potential error coming from exposing bacteria to the platform. Additionally, the accurate control over fluid flow helps to keep the inlet pressure in a safe range. High shear stress results in detachment of SAM and subsequently failure of detection.

COMSOL Multiphysics 5.5 was used to simulate the fluid flow inside the microfluidic cartridge. Constant fluid flow is considered as an inlet boundary condition and zero relative pressure (ambient pressure) is set as an outlet boundary condition, respectively. Water was used as the simulation media.

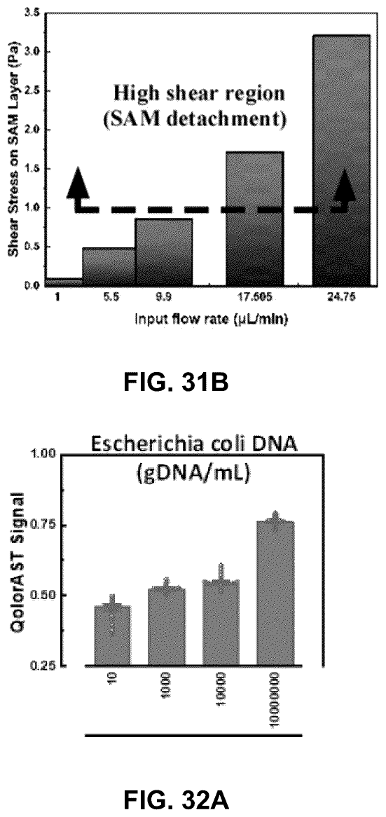

The simulation results show an overall pressure of 8 Pa. The shear stress was examined for different input flow rates on top the SAM layer in the detection chamber. The detachment of SAM starts at 1 Pa. The determination of a safe flow rate was thoroughly studied. The contour of the flow rate was observed for four different input flow rates: (i) 1 μL min⁻¹, (ii) 10 μL min⁻¹, (iii) 17.5 μL min⁻¹, and (iv) 25 μL min⁻¹. The maximum flow velocity inside the PC chamber increases with the increase of the input flow rate (FIG. 31A). The study of the critical Shear Stress which would lead to the detachment of the SAM is shown in FIG. 31B, where the results from the simulated Shear Stress over the SAM layer for different input flow rates are shown. Moreover, based on this simulation results, a safe input flow rate was determined to be 10 μL min⁻¹.

The QolorAST system utilizes a harmonized automated pipeline with the purpose of overcoming inconsistencies in the images derived from sources of variations such as the quality of the platform and microfluidic fabrication. The workflow starts with the image collection in triplicates for each bacteria at specified conditions. Each image is treated to correct for the coffee-ring effect, brightness, and defects; producing standardized images ready for further processing through our manual QolorAST evaluation or through machine learning. The manual QolorAST signal evaluation was calculated from randomized areas of each image. The color features were then used for the statistical analysis which was as follows. Results were conferred as the mean value±the standard error as mentioned in the image processing section. OriginPro (OriginLab, 2021) software package was used for statistical analysis. Limits of detection and linear ranges were calculated using linear regression methods, including the line slope and the standard error of the intercept. Statistical significance was evaluated using a one-way analysis of variance (ANOVA) with post hoc Tukey's test for mean comparison. Datasets difference was considered statistically significant for p<001. Paired Comparison Plot (version 3.60, OriginLab) graphing application is used to generate the figures using conservative p values.

The incorporation of machine learning in healthcare can be beneficial for diagnostic and surveillance tasks, especially in low-resource settings, where there is no access to high-end medical and high throughput, automation and diagnosis accuracy are essential. The standardized images are each subdivided into 20 mini-images. The modified Sergyan formulas were used to extract a total of 18 color features, corresponding to the mean color value, standard deviation, mode, skew, energy, and entropy for each of the RGB channels of each mini-image21. The 18 values of the 20 mini images integrate the dataset of a sample, the library that contains them all is then divided into 70% for training the machine learning model and 30% for testing it. A support vector machine (SVM) with radial basis function (rbf) kernel was optimized, trained, and validated to classify the images into a positive (color changed) and a negative class (no color change).

The images from the harmonized database are subdivided into 20 mini-images to be analyzed per condition. By implementing the modified Sergyan formulas, where the greyscale intensity was replaced with the color channel intensity, 18 color features were extracted. The 18 color features correspond to the mean color value, standard deviation, mode, skew, energy, and entropy for each of the RGB channels of the mini-image. The collection of values integrates the dataset of a sample, the library containing all datasets is then divided 70% for training the machine learning algorithm and 30% for testing it.

A supervised vector machine (SVM) algorithm was implemented to determine the probability of the image belonging to a color-changed (positive) or non-color-changed (negative) class. The optimization of the C and gamma hyperparameters of the model was determined via Bayesian search, and the kernel radial basis function (rbf) was selected. A 5-fold cross validation was implemented to validate that the algorithm did not overfit. The training set was appropriately labeled to a color-changed (positive) or non-color-changed (negative) and separated into two classes according to the ground truth and clinical annotations.

For the preclinical experiments, the training of the SVM included images taken from various bacteria (E. coli, Enterococcus, MRSA, and PA) for the positive class included the bacteria images were taken from the resistant condition (color change condition) and the negative class included bacteria with antibiotics in a susceptible condition or at 0 min when no color change is present. For the clinical samples phenotypic study, 70% of the urine samples in “No-antibiotic” condition, specifically U05, U10, U14, U28, U32, U35, U37, U49, U53, and U56 integrated the positive class and U01, U04, U16, U20, U25, U26, U29, U30, U38, and U39 integrated the negative samples. The test set was integrated for the remaining vectors. The antibiotic MICs for the clinical samples (Cipro and Nitro) were analyzed with the model trained in the “No-antibiotic” condition, as this model is optimized to predict the probability of color change of the image.

To evaluate the antibiotic MIC in the preclinical or clinical sample studies, the SVM tests each antibiotic concentration for each sample and produces a prediction which is organized in a table, where the MIC can be observed as well.

The SVM outputs a prediction on each of the vectors of the data set belonging to the positive class. The predictions are plotted as the probability of belonging to the positive class or the negative class.

Ampicillin-resistant E. coli strain mm294 was cultured overnight at 37° C. in Luria broth (LB) media supplemented with 100 μg/mL Ampicillin. Methillin-resistant S. aureus (USA 300 SCCmec Type IV), and Ciprofloxacin-resistant P. aeruginosa were streaked on LB miller agar overnight at 37° C. and resuspended in water aliquot. Next, the bacterial concentration was determined by optical density technique using a Spectronic 21D spectrophotometer. Subsequently, aliquots of different concentrations were prepared for the antibiotic susceptibility testing experiments in LB media. Biotyper spectra (MALDI Bruker).

Acinetobacter baumannii, Enterococcus faecalis, Enterococcus faecium, Streptococcus agalactiae, Enterobacter cloacae, Klebsiella pneumoniae, Streptococcus pneumoniae, E coli MG1655, and E coli Trimethoprim resistant were streaked on LB miller agar overnight at 37° C. and resuspended in water aliquot. Next, the bacterial concentration was determined using optical density technique. Subsequently, aliquots of different concentrations were prepared for the antibiotic susceptibility testing experiments in CamHB growth media.

For the LAMP assay, a standard reaction volume of 25 μL was used. It consisted of 2.5 μl 10× primer mix, 12.5 μl 2× master mix, 9 μl Rnase-free water supplemented with 0.25 mg/ml resazurin, and 1 μL RNA sample. The primers are presented in the table 9 below. Bacterial samples were (E. coli spiked solutions of 7.2×10⁶ gDNA copies·ml⁻¹ to 7.2 gDNA copies·ml⁻¹ equivalents to 107 cfu·ml⁻¹-10 cfu·ml⁻¹) first thermally lysed at 60° C. for 5 minutes and then mixed with the assay. This was followed by incubation at 65° C. for different periods to visualize color change versus time.

TABLE 9
E. coli LAMP primers sequences

| | SEQ ID | | Concentration |
|---|---|---|---|
| Primer | NO: | Sequence | μM |
| F3 | 38 | GCCATCTCCTGATGACGC | 0.2 |
| B3 | 39 | ATTTACCGCAGCCAGACG | 0.2 |
| FIP | 40 | CATTTTGCAGCTGTACGCTCGCAGCCCATCATGAATGTTG | 1.6 |
| | | CT | |
| BIP | 41 | CTGGGGCGAGGTCGTGGTATTCCGACAAACACCACGAAT | 1.6 |
| | | T | |
| LF | 42 | CTTTGTAACAACCTGTCATCGACA | 0.8 |
| LB | 43 | ATCAATCTCGATATCCATGAAGGTG | 0.8 |

Aliquots of different concentrations were prepared (5×10⁵ CFU ml⁻¹, 10⁵ CFU ml⁻¹, 10⁴ CFU ml⁻¹, 10³ CFU ml⁻¹, 10² CFU ml⁻¹, and 50 CFU ml⁻¹) of E coli mm294, MRSA, PA, E coli MG1655, E coli Trimethoprim resistant, A. baumannii, E. faecalis, E. faecium, S. agalactiae, E. cloacae, K. pneumoniae, and S. pneumoniae. Growth media supplemented with 0.02% resazurin were used and aliquots were incubated at 37° C. for different periods starting from 0 minutes incubation till 60 minutes with a time step of 5 minutes. for the standard control study bacteria were inoculated at different concentrations (5×10⁵ CFU ml⁻¹, 10⁵ CFU ml⁻¹, 10⁴ CFU ml⁻¹, 10³ CFU ml⁻¹, 10² CFU ml⁻¹, and 50 CFU ml⁻¹) in 96 well plates and incubated 37° C. overnight. Next day resazurin solution was added to the plates, incubated in a shaker incubator for 30 mins, and subsequently the plates were evaluated using a plate reader (TECAN M100).

For resistant bacterial samples, aliquots of 5×10⁵ CFU ml⁻¹ of Amp resistant E. coli mm294, MRSA, and Ciprofloxacin Resistant P. aeruginosa were prepared. A resazurin solution of 0.02% resazurin (R7017, Millipore Sigma, Ontario, Canada) supplemented with 100 μg ml⁻¹ Ampicillin, 4 μg ml⁻¹ Oxacillin, and 2 μg ml⁻¹ Ciprofloxacin for Amp. Resistant E. coli, Oxacillin-resistant S. aureus, and Cipro. Resistant PA respectively was used. The aliquots were incubated at 37° C. different periods starting from 0 minutes incubation till 60 minutes with a time step of 5 minutes.

For susceptible bacterial samples, aliquots were prepared of 5×10⁵ CFU ml⁻¹ of Amp resistant E. coli mm294, MRSA, and Ciprofloxacin Resistant P. aeruginosa. A resazurin solution of 0.02% resazurin (R7017, Millipore Sigma, Ontario, Canada) supplemented with 50 μg/mL Kanamycin, 1 μg/mL Ciprofloxacin, and 4 μg/mL Gentamicin for E. coli mm294, MRSA, and Cipro. Resistant PA respectively was used. The aliquots were incubated at 37° C. different periods starting from 0 minutes incubation until 60 minutes with a time step of 5 minutes.

To evaluate the QolorAST minimum inhibitory concentration (MIC) aliquots of 5×10⁵ CFU ml⁻¹ Amp resistant E. coli with resazurin/kanamycin solution were used. Solutions with different kanamycin concentrations of 1 μg/mL, 2 μg/mL, 4 μg/mL, 8 μg/mL, 16 μg/mL, 32 μg/mL, and 50 μg/mL were used to determine the MIC dose. 5×10⁵ CFU ml⁻¹ Oxacillin-resistant S. aureus aliquots were prepared using resazurin/oxacillin solution using different concentrations of oxacillin antibiotic (16 μg/mL, 32 μg/mL, and 64 μg/mL). 5×10₅ CFU ml⁻¹ Cipro. Resistant PA aliquots were prepared using resazurin/ciprofloxacin solution using different concentrations of ciprofloxacin antibiotic (8 μg/mL, 16 μg/mL, and 32 μg/mL). In addition, the MIC test was performed for aliquots of 5×10⁵ CFU ml⁻¹ Amp WT E. coli using the same conditions at different concentrations of Ciprofloxacin (0.015625 μg/mL, 0.03125 μg/mL, and 0.0625 μg/mL), Nitrofurantoin (4 μg/mL, 8 μg/mL, and 16 μg/mL), Trimethoprim (2 μg/mL, 4 μg/mL, and 8 μg/mL) and Trimethoprim/Sulfamethoxazole (0.125/2.375 μg/mL, 0.25/4.75 μg/mL, and 0.5/9.5 μg/mL). The same experiment was done for Trimethoprim-resistant E. coli MIC determination at different concentrations of Trimethoprim (2 μg/mL, 4 μg/mL, and 8 μg/mL) as well as for Enterococcus faecalis and faecium using different concentration of Vancomycin (16 μg/mL, 32 μg/mL, and 64 μg/mL) and (32 μg/mL, 64 μg/mL, and 128 μg/mL), respectively.

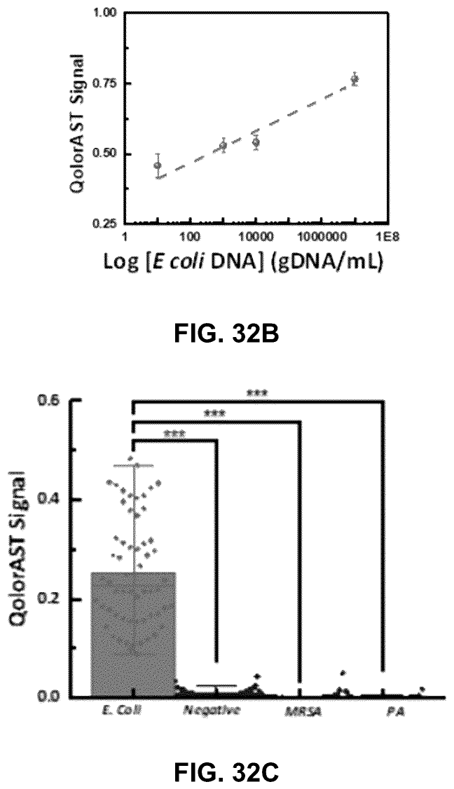

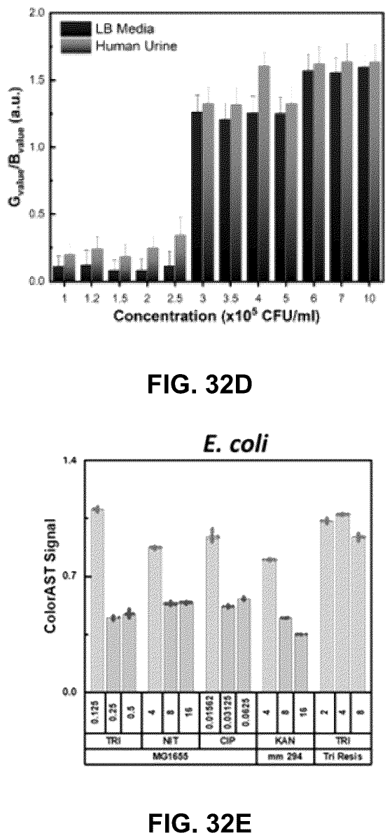

Through the established analysis pipline QolorAST diagnostic capabilities tested using a colorimetric LAMP assay for genotypic bacterial identification (ID), and a resazurin reduction assay for phenotypic antibiotic susceptibility testing (AST). The QolorAST LAMP assay evaluated gDNA extracted from different physiologically relevant concentrations (10-107 CFU/mL) of E coli as a model organism due to it prevalence in urinary tracts infections. The detection chamber colorimetric readout creates a color matrix that shows a color change from blue to green over a 60 min incubation. The QolorAST signal shown a positive linear correlation with E coli gDNA in the range of 7.2 to 7.2×10⁶ gDNA/ml which covers the physiological range for UTIs (FIGS. 32A-32B). To establish the selectivity of QolorAST genotypic E coli detection, the positive signal of E coli was compared with different bacterial gDNA, including MRSA and P. aeruginosa. Through a null comparison of the selectivity (FIG. 32C), a significant difference between the E coli signal and the signal from other bacteria was observed (p<0.001).

Phenotypic QolorAST rapid AST performance was established through 10⁵ cfu/mL of E coli, MRSA, and Pseudomonas aeruginosa (bacterial strains confirmed using MALDI/TOF and PCR) with two sets of antibiotics, one set where the bacteria is resistant to the antibiotic and another set where the bacteria is susceptible. The resistant set included ampicillin, oxacillin, and ciprofloxacin while the susceptible set included Kanamycin, ciprofloxacin, and gentamicin for challenging E coli. MRSA and PA respectively. The resistant sets showed a consistent color change from blue to green with wider gamut shown in the CIE 1931 chart while susceptible sets show consistent blue color and limited gamut in the CIE 1931 chart. For the resistant sets the QolorAST signals showed a dose response fit indicative of color change. The inset of color change was dependant on the bacterial species where E coli shows the fastest color change at 15 mins followed by MRSA and PA at 30 mins. Since phenotypic QolorAST AST utilizes a metabolic resazurin assay, the difference in the onset of color change can be attributed to difference in metabolic activity between different bacterial strains. This can be conferred through the faster doubling time of E. coli (20 mins) compared to MRSA and PA (30 mins).

To validate QolorAST applicability to operate at the point-of-need using direct human patient samples were evaluated a set of diverse healthy human samples (urine, serum, and nasal swab in Amies transport buffer) spiked with bacteria (Table 10).

TABLE 10
Donors for urine, serum and nasal swab samples

| Sample type | Donor ID | Age (years) | Gender |
|---|---|---|---|
| Human Urine | Urine 1 | 31 | Male |
| | Urine 2 | 4 | Male |
| | Urine 3 | 29 | Male |
| | Urine 4 | 27 | Female |
| | Urine 5 | 24 | Female |
| Human Serum | Serum 1 | 26 | Male |
| | Serum 2 | 20 | Female |
| | Serum 3 | 32 | Male |
| | Serum 4 | 37 | Male |
| | Serum 5 | 42 | Male |
| | Serum 6 | 49 | Female |
| Nasal swab | Nasal Swab 1 | 31 | Male |
| | Nasal swab 2 | 24 | Female |
| | Nasal Swab 3 | 34 | Male |
| | Nasal swab 4 | 30 | Female |

For clinical MIC, bacteria were streaked on LB agar overnight and resuspended in a water aliquot. The aliquot was measured, and the bacteria concentration was adjusted to of 106 CFU ml⁻¹ in LB media. A 96 well plate with an antibiotic gradient from 128 μg/ml to 0.125 μg/ml in a 2-fold concentration dilution step was prepared with a positive control with no antibiotics. Next, the bacteria were introduced to each well of the 96 well plate for a final bacteria concentration of 5×10⁵ CFU ml⁻¹. The well plates were cultured overnight the minimum inhibitory concentration was determined as the antibiotic concentration that didn't show any signs of bacterial growth.

To obtain spiked human samples, first human urine was centrifuged at 5000 rcf for 5 minutes to remove large particles. It was subsequently spiked with 5×10⁵ CFU ml⁻¹ and mixed with a solution of Resazurin to a final concentration of 0.02%. No antibiotics were added for the control aliquots, 32 μg/mL Ampicillin was added for resistant aliquots and 16 μg/mL Kanamycin was added for susceptible aliquots. The aliquots were incubated at 37° C. different periods starting from 0 minutes incubation till 60 minutes with a time step of 5 minutes.

Second, human serum samples obtained from healthy donors (Table 10) were heat-inactivated using the protocol suggested by the supplier. Briefly, serum was heated to 56° C. in a water bath for 30 min. subsequently, the samples were removed and left to cool to room temperature. The heat-inactivated human serum samples were spiked with 102 CFU ml⁻¹ MRSA and mixed with a solution of Resazurin to a final concentration of 0.02%. No antibiotics were added for the control aliquots. Since Oxacillin tends to bind to serum proteins (93% of the drug is bounded to serum proteins) 57 μg/mL Oxacillin was added for resistant aliquots to have an effective concentration of 4 μg/mL. Similarly, 1.38 μg/mL Ciprofloxacin (28% of the drug is bounded to serum proteins) was added for susceptible aliquots to have an effective concentration of 1 μg/mL. The aliquots were incubated at 37° C. different periods starting from 0 minutes incubation until 60 minutes with a time step of 5 minutes.

Third, human nasal swab samples were collected from healthy volunteers and preserved in liquid Amies transport media. The samples were spiked with 102 CFU ml⁻¹ MRSA and mixed with a solution of resazurin to a final concentration of 0.02%. No antibiotics were added for the control aliquots, 4 μg/mL Oxacillin was added for resistant aliquots and 1 μg/mL Ciprofloxacin was added for susceptible aliquots. The aliquots were incubated at 37° C. different periods starting from 0 minutes incubation until 60 minutes with a time step of 5 minutes.

According to the Infectious Diseases Society of America (IDSA), 105 CFU ml⁻¹ and 10₂ CFU ml⁻¹ were spiked in-vivo in urine, serum, and nasal swab of donors to simulate urinary tract infection, wound infection, and pneumonia by MRSA, respectively. Human urine was spiked with different concentrations of E. coli (FIG. 32D). As a control the healthy human biofluids were screened as received. The QolorAST signal of E coli spiked urine from different individuals showed a dose response fit (R²=0.988) in agreement with the response of E coli in LB media. Last, a minimum inhibitory concentration (MIC) test for different E coli strains spiked in urine vs. different antibiotics was performed (Trimethoprim, Nitrofurantoin, Ciprofloxacin, and Kanamycin) to evaluate their resistance profile. Based on the CLSI MIC cut off values E coli MG1655 was susceptible towards trimethoprim (MIC 0.312/ml, CLSI cut offs S≤8 μg/ml and R≥16 μg/ml), nitrofurantoin (MIC 8 μg/ml, CLSI cut offs S≤32 μg/ml and R≥128 μg/ml), and ciprofloxacin (MIC 0.03125 μg/ml, CLSI cut offs S≤0.25 μg/ml and R≥1 μg/ml). E coli mm 294 was susceptible to kanamycin (MIC 8, CLSI cut offs S≤16 μg/ml and R≥64 μg/ml), and E coli Trimeth resistant strain was confirmed against Trimethoprim (MIC>8 μg/ml, CLSI cut offs S≤8 μg/ml and R≥16 μg/ml) (FIG. 32E).

A minimum inhibitory concentration (MIC) was performed to study the QolorAST broad applicability in detecting bacterial resistance profiles and ensuring timely and efficient antimicrobial theraby. 12 bacterial species were tested (A. baumannii, E. cloacae, S. pneumoniae, K. pneumoniae, E. faecalis, E. faecium, MRSA, P. aeruginosa, S. agalactiae, E coli mm294, E coli MG1655, and Trimethoprim resistant E coli) and 7 different antibiotics (Ampicillin, Colistin, Gentamicin, linezolid, Ciprofloxacin, Oxacillin, and Trimethoprim). The antibiotics cover major bacterial inhibition mechanisms as inhibition of protein synthesis, cell wall synthesis, and/or DNA synthesis.

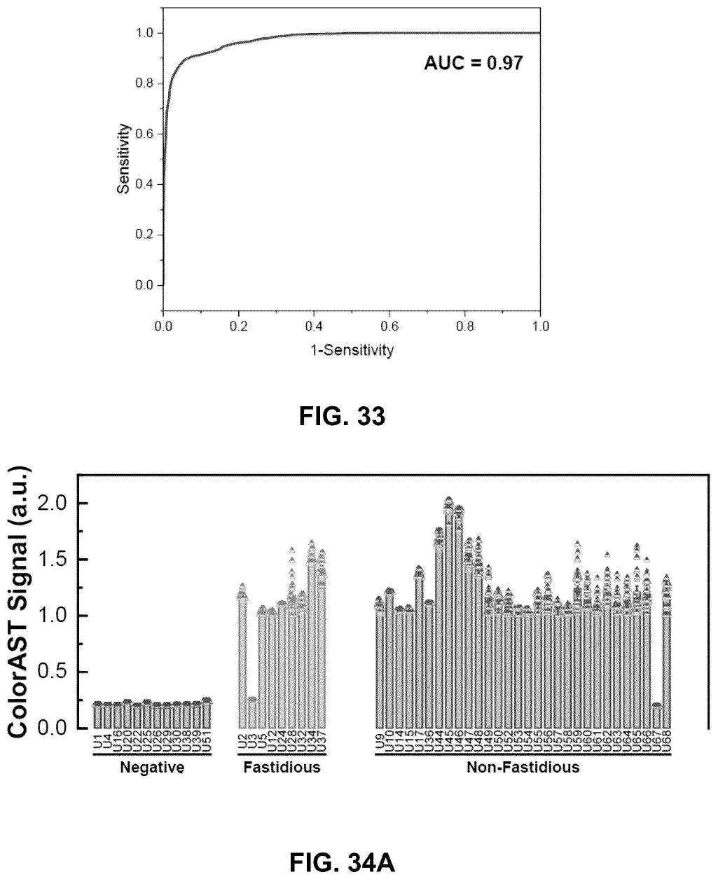

QolorAST exploited two methodologies: Manual MIC (MA-MIC) and support vector machine MIC (SVM-MIC). The MA-MIC is based on the direct QolorAST signal for different concentrations of antibioatic where the first concentration shows a no growth signal is considered the MIC (FIG. 33). The SVM-MIC was carried out with a rbf kernel that was optimized and trained to predict the color change of the preclinical images using our library of bacteria images collected under different conditions including images where color is changed, color transitioning, and no color change. The SVM successfully classified the condition's bacteria-antibiotic in the concentration range studied. The average probability of belonging to the color-changed (positive) class are presented in Table 11.

TABLE 11
Minimum inhibitory concentration (MIC) for versatile resistant
strains of bacteria via QolorAST device vs. conventional method

| | | QolorAST MIC | | Broth | MA- |
|---|---|---|---|---|---|
| | | Manual | SVM | Microdilution | MIC/SVM- |
| | | (MA- | (SVM- | MIC | MIC/MIC |
| Bacteria/Antibiotic | | MIC) | MIC) | (MIC) | Category |
| A. baumannii | [symbol] | >128 | >128 | >128 | R/R/R* |
| | | 8 | 8 | 8 | R/R/R |
| E. cloacae | | >128 | >128 | >128 | R/R/R |
| | | 4 | 4 | 4 | R/R/R |
| S. pneumonia | | >128 | >128 | >128 | R/R/R* |
| | | >128 | >128 | >128 | R/R/R* |
| K. pneumonia | | >128 | 128 | >128 | R/R/R |
| | | 8 | 8 | 8 | R/R/R |
| E. Faecalis | | >128 | >128 | >128 | R/R/R* |
| | | 2 | 2 | 2 | S/S/S |
| E. Faecium | | 64 | 64 | 64 | R/R/R |
| | | 1 | 1 | 1 | S/S/S |
| PA | | 8 | 8 | 8 | R/R/R |
| | | 0.5 | 0.5 | 0.5 | S/S/S* |
| MRSA | | 64 | 64 | 64 | R/R/R |
| | | 1 | 1 | 0.5 | S/S/S |
| S. agalactiae | | 128 | >128 | 128 | R/R/R* |
| | | 0.125 | 0.125 | 0.125 | S/S/S* |
| E. coli mm294 | | >128 | >128 | >128 | R/R/R |
| | | 0.125 | 0.125 | 0.125 | S/S/S |
| E. coli MG1655 | | >128 | >128 | >128 | R/R/R* |
| | | 0.125 | 0.125 | 0.125 | S/S/S |
| E. coli Tri resis. | | >128 | >128 | >128 | R/R/R |
| | | 0.125 | 0.125 | 0.125 | S/S/S |

[symbol]

indicates data missing or illegible when filed

Both the MA-MIC/SVM-MIC results were benchmarked against the conventional broth microdilution (BMD) MIC results. The essential agreement were established between the standard CLSI based MIC and MA-MIC/SVM-MIC where a variation of two fold concentration in the antibiotic MIC was adeemed acceptable. Moreover, the bacterial susceptibility criteria (category agreement) was investigated using standard MIC cut off values to determine the bacteria profile for being susceptible (s), intermediate (I), or resistant (R). For A. baumannii, data suggests heightened resistance to ampicillin (MIC=>128) relative to colistin (MIC=8), as evidenced both manually and through SVM. A similar trend is discernible for, with distinct resistance patterns against the ampicillin and colistin tested. S. pneumonia showed significant resistance to both ampicillin and colistin with MIC values of larger than 128. K. pneumonia's MIC values showed that the bacteria exhibits enhanced susceptibility to ampicillin over colistin. Concurrent observations are made for E. Faecalis and E. Faecium, highlighting their antibiotic susceptibility profiles. In the case of PA, MIC outcomes for ciprofloxacin and gentamicin are 8 and 0.5, respectively. This indicated the potential efficacy of these antibiotics against PA, though clinical breakpoints classify only gentamicin as susceptible. A general trend is that weaker QolorAST signals in the greater concentrations of antibiotic concentrations suggest a lower MIC value and thus, great susceptibility to the bacteria tested. MRSA showcases resistance to oxacillin but susceptibility to ciprofloxacin, with minor discrepancies observed in MIC values between standard and the two QolorAST methods, potentially attributable to experimental variations. MIC values for S. agalactiae, E. coli mm294, E. coli MG1655, and E. coli Tri resis further delineate their antibiotic susceptibility profiles. More specifically, S. agalactiae was found to be resistant to colistin and susceptible to oxacillin, and the same trend found antibiotics for E. coli mm294, E. coli MG1655, and E. coli Tri resis that were tested against ampicillin, ciprofloxacin, oxacillin, and trimethoprim. Notwithstanding variations in QolorAST signal intensity across different concentrations, it was observed that there is a notable coherence between MIC values and QolorAST signals, signifying robust result precision. This accuracy was further proofed through achieving 100% essential agreement (EA) and 100% categirocal agreement (CA) in comparison to the standard CLSI based BMD MIC by both MC-MIC and SVM-MIC showing a superior performance to current devices. Additionally, the optimized SVM algorithm (SVM-MIC) reached an accuracy of 90.6% and receiver operating characteristic (ROC) showed an area under the curve (AUC) of 0.97. QolorAST provided a rapid and accurate (EA 100% and CA100%) MIC testing solution compatible with a wide range of bacterial species and antibiotics.

To evaluate the QolorAST performance in clinical settings, a double-blinded clinical study at the McGill University Health Center (MUHC) was performed. 47 patients suspected of urinary tract infections, admitted to MUHC emergency clinics between August 2022 to August 2023 were tested. Specimens were consented, collected from the patients and the experiments were done in microbiology labs in MUHC. Each specimen were divided in 3 to be tested in parallel in the central laboratory of the hospital (quantification, identification and MIC), in the research laboratory (quantification, identification and MIC for 2 antibiotics) and with QolorAST genotypic/phenotypic assays in microbiology lab at MUHC. The device has 24 chambers where the media/resazurin/antibiotic mixes as well as the patient samples are injected mixed. In this part the effect of two main antibiotics including Nitrofurantoin at concentrations of 256, 128, 64, 32, 16, 8, 4, 2, 1, 0.5, and 0.25 μg/mL and Ciprofloxacin at concentrations of 32, 16, 8, 4, 2, 1, 0.5, 0.25, 0.125, 0.06, and 0.03 μg/mL and control without antibiotic were investigated. Therefore, reagent loading port was preloaded with media, specific concentration antibiotic and resazurin at final concentration of 0.25 mg/mL and urine was added to urine loading port. Thereafter, by pressing the pushing button the urine was mixed with the rest of solution at a volumetric ratio of 1:4 which would be the starting point for incubation and imaging of the samples. The samples were incubated at 37° C. at different timepoints starting from 0 to 60 minutes with a time interval of 10 minutes and the imaging was performed as described above.

For the standard testing the urine specimens were diluted 1/1000 using CamHB and both the original concentration and a 1/1000 dilution of the specimen were plated on BAP with a 1 μL calibrated loop and incubated for 18-20h at 37 C with 5% CO₂. The CFU/L concentration is then calculated for all the isolates coming from each specimen. For each isolate, the MIC is also determined for 2 antibiotics: Ciprofloxacin (0.03 to 128 μg/mL) and Nitrofurantoin (0.125 to 256 μg/mL). The isolates quantification is standardized to 1×10⁶ CFU/mL prior to be incubated with the range of different concentrations of antibiotics diluted in CAMHB for MIC. At the end of the process, the inoculum quantification is checked by counted CFU from serial dilutions of the inoculum. A growth positive control (inoculum with no antibiotic), a wild type strain of E. Coli (MG1655) and E. Faecalis are also included and processed in the same way as the isolates for each experiment. Finally, each isolate is plated on BAP to control their monoculture state and to be identified by MALDI.

MALDI-TOF MS was performed using an Ulttraflextreme TOF/TOF mass spectrometer (Bruker Daltonics, Leipzig, Germany), in accordance with the manufacturer's instructions, and with Flexcontrol software 3.4 Build 169.5 (Bruker Daltonics) for the automatic acquisition of mass spectra in the linear positive mode within the range 2 to 20 kDa. The mass spectrometer was calibrated at each run by using the BTS standard (Bruker Daltonics), as described by the manufacturer. Calibration masses were: RL29, 3636.8, RS22, 5095.8 Da; RS34, 5380.4 Da; RS33meth, 6254.4 Da; RL29, 7273.5 Da; RS19, 10229.1 Da; RNase A, 13682.2 Da; myoglobin, 16952.5 Da.

For optimization studies we employed physical characterization techniques as atomic force microscopy (AFM) and scanning electron microscopy (SEM). For AFM we used Bruker, MultiMode8 system while we used FEI Quanta 450 environmental scanning electron microscope for SEM.

Optical characterization was carried out with a Lambda 750 UV/Vis/NIR Spectrophotometer (PerkinElmer). The incident and collected light beams had normal incidence to the platform. Also, we performed optical imaging under a highly controlled environment using Nikon Eclipse LV150 (Nikon) with a ×100, 0.9 NA air objective and Nikon digital sight ds-fi1 CCD camera. The fundamental fluid flow characteristics of the microfluidic cartridge were studied using COMSOL Multiphysics (V5.6).

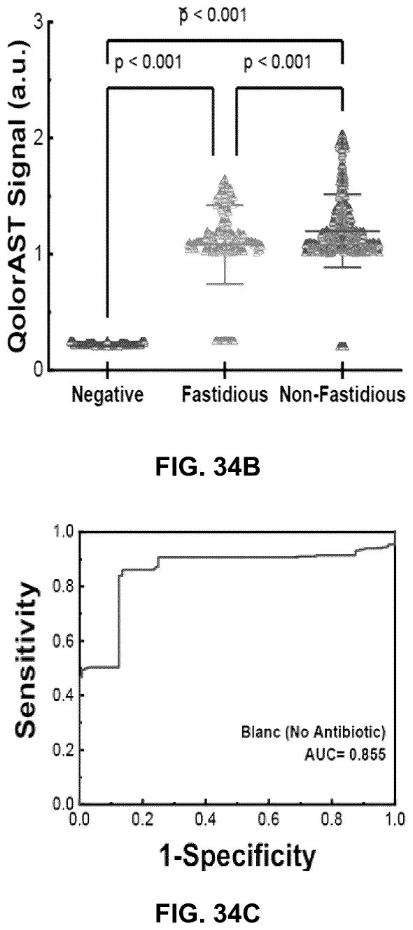

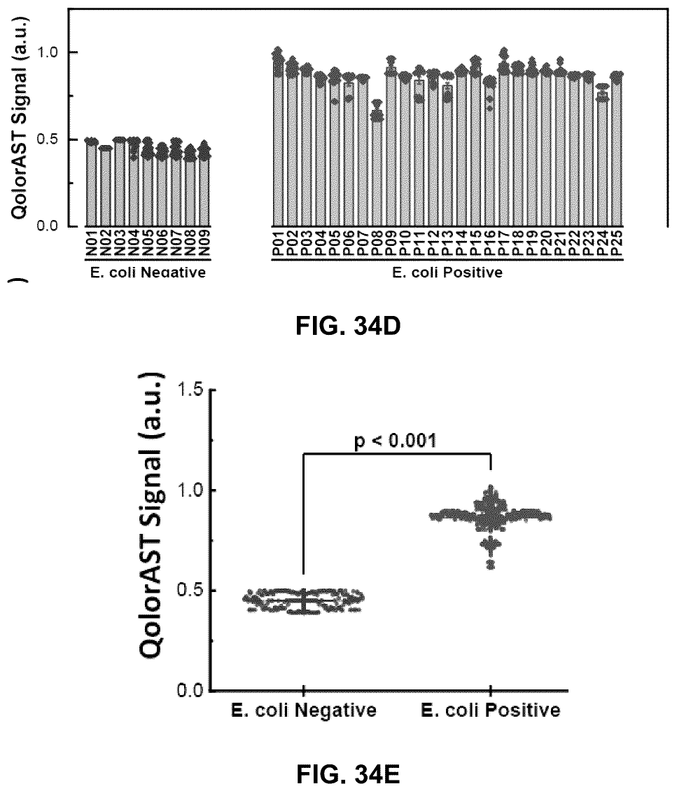

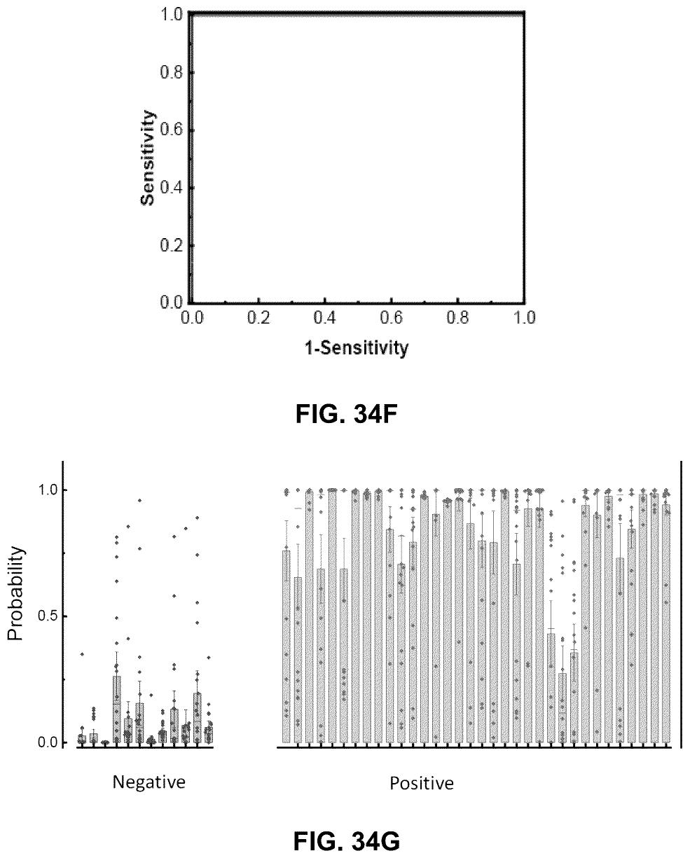

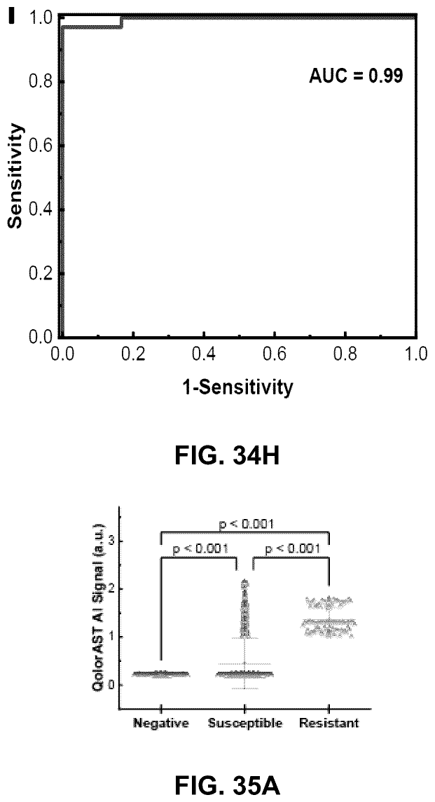

Samples were tested in parallel using two methods: conventional (Matrix-assisted laser desorption/ionization-time of flight—MALDI/TOF—for bacterial identification and CLSI BMD method for AST) and QolorAST (genotypic for bacterial ID and phenotypic AST). Thirteen patients suspected of UTI (27.66%) did not show bacterial growth while nine (19.15%) and twenty-five (53.19%) specimens showed growth patterns in consistence with fastidious and no-fastidious (E. coli) bacterial strains respectively (FIG. 34A). A post hoc Tukey's test revealed a statistically significant signal contrast (P<0.001) between the negative, fastidious, and non-fastidious samples (FIG. 34B). The receiver operating characteristic (ROC) curve (FIG. 34C) of the classification shows an area under the curve of 0.855. This is further confirmed through QolorAST genotypic ID where twenty-five (53.19%) specimens where confirmed as E. coli (FIG. 34D). QolorAST genotypic signal has statistically significant contrast (P<0.001) between negative and E coli infected samples (FIG. 34E). Moreover, the ROC curve (FIG. 34F) of the genotypic classification shows an AUC 1 confirming a good agreement with standard culture-based methods. Subsequently, we used the images of negative, fastidious, and not fastidious samples to establish a new training for the SVM to classify the specimens into no growth (negative) and growth (positive) classes. We implemented a detection time of 30 mins and a cutoff threshold of 0.6 to differentiate between positive and negative specimens (FIG. 34G). The SVM code achieved cumulative true positive and true negative of patient samples of 100% and an AUC of 0.99 (FIG. 34H).

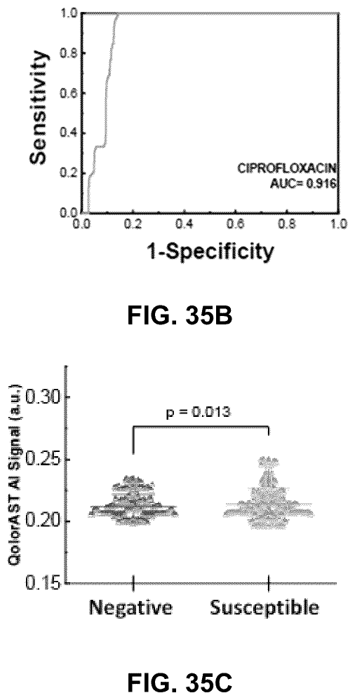

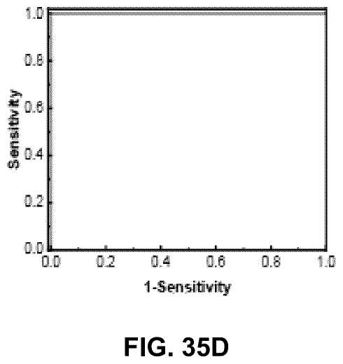

Sdsd Using QolorAST phenotypic assay the specimens were tested with two antibiotics Ciprofloxacin (Cip) and Nitrofurantoin (Nit) to determine the minimum inhibitory concentration (MIC) and drug resistance profiles. The SVM produced a prediction for each antibiotic at the concentrations tested (Table 12), six out of twenty five (24%) of the E. coli infected samples shown intermediate or high resistance to ciprofloxacin. QolorAST SVM readout shows a statistically significant contrast (P<0.001) between negative, ciprofloxacin susceptible and ciprofloxacin resistant specimens (FIG. 35A). The ROC curve (FIG. 35B) of the AST profile classification shows an AUC of 0.916.

TABLE 12
Quantified MIC for patients diagnosed with E. coli

| | | QolorAST MIC | | Broth | MA- |
|---|---|---|---|---|---|
| | | Manual | SVM | Microdilution | MIC/SVM- |
| Patient #/ | | (MA- | (SVM- | MIC | MIC/MIC |
| Antibiotic | | MIC) | MIC) | (MIC) | Category |
| 49 | [symbol] | <0.08 | <0.01 | <0.01 | S/S/S |
| | | 8 | 8 | 8 | S/S/S |
| 50 | | 0.06 | 0.06 | 0.06 | S/S/S |
| | | 8 | 8 | 8 | S/S/S |
| 51* | | <0.03 | <0.03 | <0.03 | S/S/S |
| | | <0.25 | <0.25 | 16 | S/S/S |
| 52 | | <0.03 | <0.03 | <0.03 | S/S/S |
| | | 16 | 16 | 16 | S/S/S |
| 53 | | <0.03 | <0.03 | <0.03 | S/S/S |
| | | 4 | 4 | 6 | S/S/S |
| 54 | | >32 | >32 | >32 | R/R/R |
| | | 4 | 4 | 4 | S/S/S |
| 55 | | 1 | 1 | 1 | R/R/R |
| | | 8 | 8 | 8 | S/S/S |
| 56 | | <0.03 | <0.03 | <0.03 | S/S/S |
| | | 8 | 8 | 8 | S/S/S |
| 57 | | <0.03 | <0.03 | <0.03 | S/S/S |
| | | 8 | 8 | 8 | S/S/S |
| 58 | | >32 | >32 | >32 | R/R/R |
| | | 8 | 8 | 8 | S/S/S |
| 59 | | <0.03 | <0.03 | <0.03 | S/S/S |
| | | 16 | 16 | 16 | S/S/S |
| 60 | | 0.5 | 0.5 | 1 | R/R/R |
| | | 4 | 4 | 16 | S/S/S |
| 61 | | <0.03 | <0.03 | <0.03 | S/S/S |
| | | 4 | 4 | 4 | S/S/S |
| 62 | | <0.03 | <0.03 | <0.03 | S/S/S |
| | | 6 | 6 | 6 | S/S/S |
| 63 | | <0.03 | 0.25 | 0.25 | S/S/S |
| | | 4 | 4 | 4 | S/S/S |
| 64 | | <0.03 | <0.03 | 0.06 | S/S/S |
| | | 8 | 8 | 8 | S/S/S |
| 65 | | <0.03 | <0.03 | <0.03 | S/S/S |
| | | 8 | 8 | 8 | S/S/S |
| 66 | | <0.03 | <0.03 | 0.06 | S/S/S |
| | | 8 | 8 | 8 | S/S/S |
| 67* | | <0.03 | <0.03 | <0.06 | S/S/S |
| | | <0.25 | <0.25 | 2 | S/S/S |
| 68 | | <0.03 | <0.03 | <0.03 | S/S/S |
| | | 8 | 8 | 8 | S/S/S |

[symbol]

indicates data missing or illegible when filed

All the specimens were susceptible to nitrofurantoin (Table 12). QolorAST SVM probabilities shows a statistically contrast (P=0.013) between negative and nitrofurantoin susceptible specimens (FIG. 35C). The ROC curve (FIG. 35D) of the AST profile classification shows an AUC of 1.

The limit of detection measured for each bacteria is summarized in Table 13.

TABLE 13

| | Sensitivity | Limit of detection |
|---|---|---|
| Bacteria | (ml CFU⁻¹) | (ml CFU⁻¹) |
| A. baumannii | 0.035 | 6.2 |
| E. cloaca | 0.047 | 6.3 |
| K. pneumoniae | 0.007 | 15.9 |
| S. pneumoniae | 0.034 | 18.7 |
| E. Faecalis | 0.024 | 20.1 |
| E. Faecium | 0.030 | 2.3 |
| MRSA | 0.010 | 193.3 |
| P. aeruginosa | 0.024 | 7.6 |
| S. agalactiae | 0.037 | 13.9 |
| E. coli mm294 | 0.050 | 17.2 |
| E. coli MG1655 | 0.037 | 22.5 |
| E. Coli Tri resis | 0.060 | 69.9 |

Overall, QoloarAST had an average essential agreement (EA) of 90% and an average categorical agreement (CA) of 96%. Accordingly, QolorAST complies with the International Organization for Standardization (ISO 20776-2:2021) criteria for MIC AST devices of having EA ≥90%.

In conclusion, QolorAST is an automated point-of-need system coupled with a genotypic LAMP for bacterial identification (ID) and a phenotypic resazurin reduction assay for antibiotic susceptibility profiling. QolorAST uniquely utilizes nanoplasmonic colorimetric structures to enable rapid detection of the onset of color change and identify AST in less than 30 mins in comparison with 48 hours for the current conventional methods and on par with FDA approved device. The first key feature of QolorAST system is a microfluidic cartridge that serves as an automated, portable and multiplex testing platform substitute for the traditional 96-well format platform by incorporating the plasmonic nanostructures into a 3D printed microfluidic device with addressable compartments including sample collection, preparation and detection units. This allowed for direct testing of different concentrations of antibiotics per sample without processing or pre-culture.

The core principle of QolorAST signal generation is based on the reduction of the dark blue resazurin to light pink resorufin on top a plasmonic color printing platform where the plasmonic color is initially inhibited by the dark blue resazurin but is fully detectable at the early stages' reduction process. The resazurin reduction can be initiated through pH change (genotypic QolorAST assay) or due to the metabolic activity of viable bacterial cells (QolorAST phenotypic AST assay). The rapid plasmonic colorimetric detection was demonstrated to lead to rapid genotypic ID (<15 mins) and phenotypic AST profiling (<30 mins). Sensitivity in plasmonic color-printing based colorimetric sensing largely relies on the resolution of pigmented color that is captured, while the rapidity of the sensor depends on how fast the color change occurs according to the chemical reactions. The light interacting with resonances associated with the discrete harmonic energy states are structurally engineered, and could offer new opportunities to enhance the colorimetric sensing. The plasmonic enhanced color-generation strategy involves the patterning of various geometrical metallic nanostructures and investigates the hue and gamut of colors experimentally.

The second feature of QolorAST is an autonomous imaging box to allow integrated incubation, fluid actuation and imaging. The imaging box utilizes a unique cyclic filtration/actuation process to allow repeated and precise control over the temporal sample release. Third feature of QolorAST is an automated machine interfaced data collection and interpretation that employs a simple camera to capture the color output of the fluidic device and an image analysis software to easily analyze and interpret the data to automate the color interpretation. This improved the potential of remote applications.

Further, QolorAST was validated in a double-blinded clinical study and established its performance with 47 clinical specimens from patients with suspected UTI achieving 90% essential agreement and 96 category agreement %. It presently demonstrated a rapid test method that is versatile and provides a broad color change for detection of a wide range of metabolically active bacteria in a portable and automated fashion. QolorEX combines rapidity, clinically relevant sensitivity, specificity, and versatility for the detection of a variety of bacteria and minimum antibiotic inhibitory concentrations that is deployable at the point of care in low-resource, remote or congregate settings. Through combining automated genotypic ID and phenotypic AST, QolorAST provides a complete solution to reduce the time-to-result for AST at a low-cost has significant impact on the global health system.

### Example 3

This example provides the use of the suction membrane in a smartphone-operated and additively manufactured multiplexed electrochemical device (AMMED) for the portable detection of biomarkers in blood and saliva. AMMED was developed to employ a suction-based microfluidic system relying on a single-trigger mechanism alongside a filtered-based sample collection approach, a dimeric DNA aptamer-based gold nanostructured (GNS) electrochemical biosensor (GNS aptasensor), and a customized potentiostat. Indeed, the device mainly utilizes a smartphone-controlled portable potentiostat featuring the multiplexed option to run voltammetry and electrochemical impedance spectroscopy (EIS) measurements.

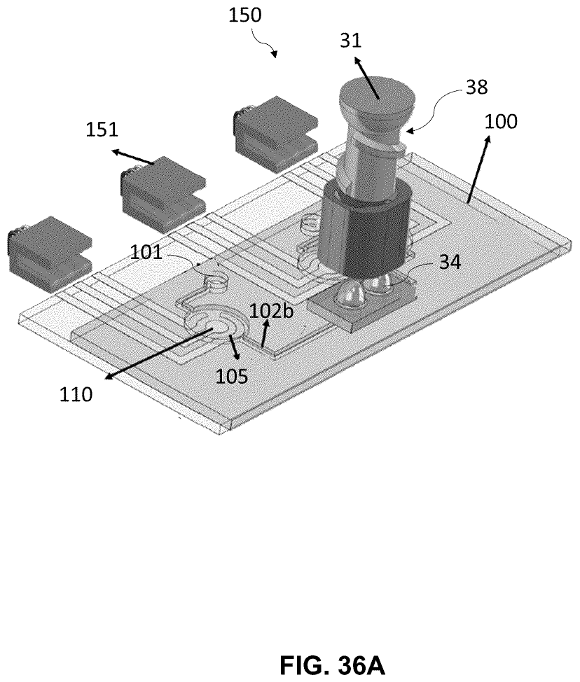

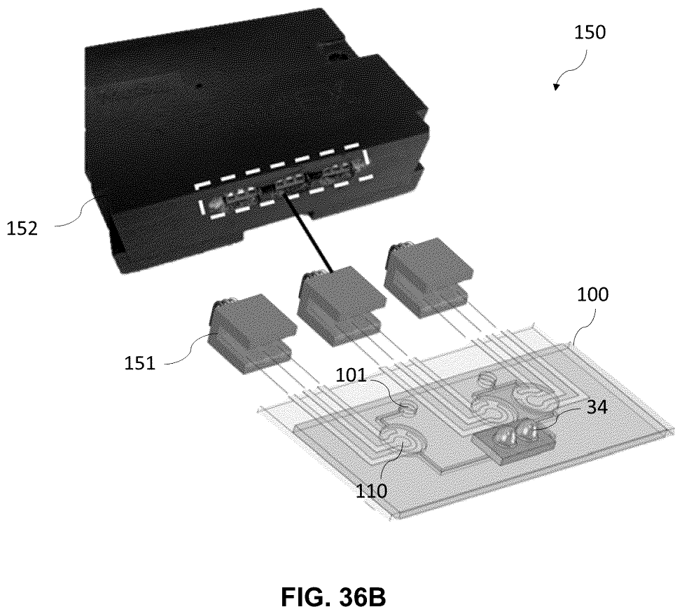

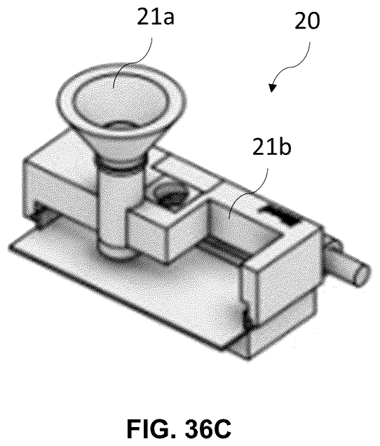

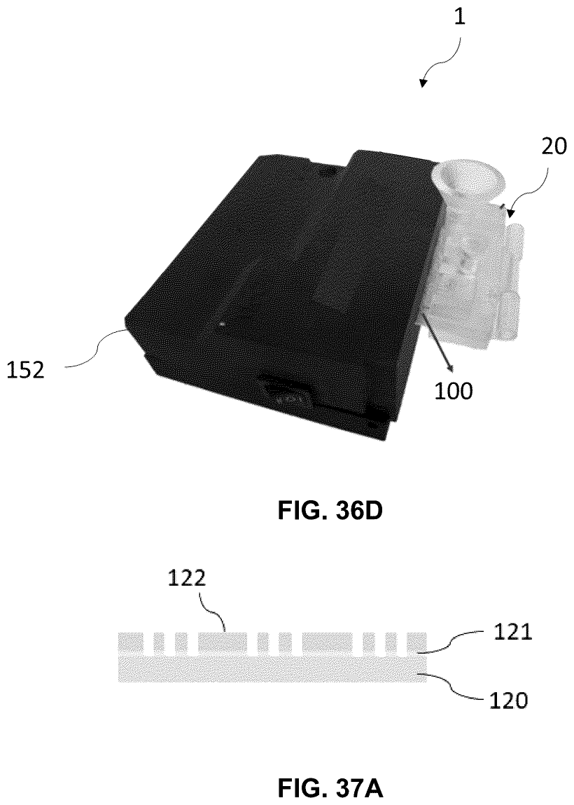

As illustrated in FIGS. 36A-36B, AMMED 150 utilizes a microfluidic chip 100 having a working electrode 110 at the sensing chamber 105. The electrode is electrically connected to adaptors 151 which connect to the potentiostat 152. Making reference to FIG. 36C, an inlet apparatus 20 connects to the microfluidic chip 100 and has a saliva inlet 21a or a blood inlet 21b. The potentiostat 152, the microfluidic chip 100 and the inlet apparatus 20 connect as illustrated in FIG. 36D to perform the assay.

The AMMED components were fabricated based on additive manufacturing (AM) (3D-printing) techniques, making the whole process almost cleanroom-free and scalable. In particular, the microfluidic chip containing the electrodes and microfluidic parts was fabricated by AM. This approach obviates the necessity for time-consuming, challengeable, and expensive traditional methods such as photoresist coating, photolithography, and solvent-based lift-off.

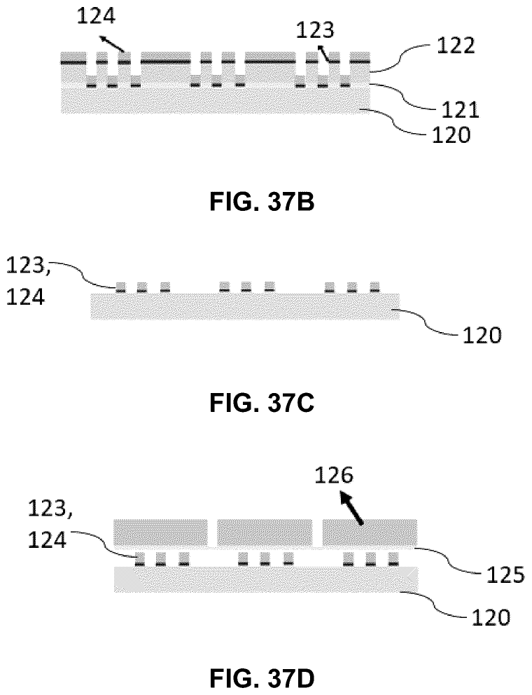

The biosensing performance of the proposed device was investigated by the detection of a diagnostic representative biomarker in the relevant biofluids, including saliva and diluted whole blood. Spike protein (S-protein) of the SARS-COV-2 omicron variant was selected as the representative biomarker since it has been proven to be a valuable antigen for noninvasive, accurate, and rapid diagnosis of COVID-19. The intermediates obtained during the additive manufacturing process are presented in FIGS. 37A-37D. A pressure sensitive adhesive (PSA) 121 covers a glass 120 and a mask 122 with the outline of the electrodes and electrical connections is placed atop the PSA. A layer of Cr 123 followed by a layer of Au 124 are deposited through the mask therefore taking the shape of the patter of the mask 122. Another layer of PSA 125 is then used to mount the 3D printed microfluidic chip channels 126 onto the glass substrate 120.

In greater details, first, ethanol and dionized water were used for cleaning the glass substrate prior to mask attachment and gold deposition. Then, a 700 μm thick 3D-printed mask (fabricated using stereolithography (SLA) 3D-printer Form 3, Formlabs) featuring the patterns for the three-multiplexed electrodes was attached to the glass substrate using a pressure sensitive adhesive (PSA) film. This 3D-printed mask allowed for the fabless patterning of gold electrodes in a single step. Subsequently, a 20 nm film of Chromium, as the adhesion layer, was deposited onto the masked substrate followed by a 150 nm layer of gold using electron beam evaporator Temescal BJD 1800. The 3D-printed mask was removed after the deposition and the glass slide substrate was diced into individual chips using a Disco DAD 3240 dicing saw. The microfluidic channels and detection chambers of the test chip were fabricated based on SLA 3D printing (at 50 μm resolution on the z-axis). Finally, the 3D-printed microfluidic part was mounted onto the glass chip using PSA to control sample delivery, encapsulate the device, and confine the sensing area of electrodes. The suction membrane was prepared with PDMS as described in Example 1 and then bonded to the microfluidic chip. This was followed by depositing dimeric DNA aptamer-based gold nanostructured (GNS) electrochemical biosensor (GNS aptasensor) on the gold surface.

In this example, the microfluidic chip 100 does not have a filter barrier as the filter embedded within the inlet apparatus is sufficient for providing a sample that can be analyzed by electrical detection.

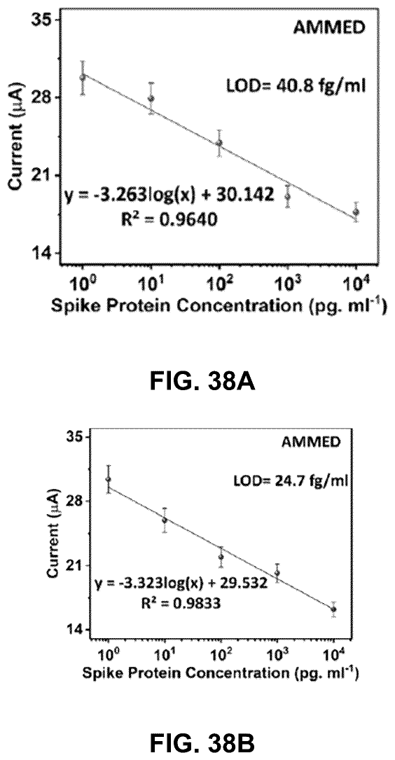

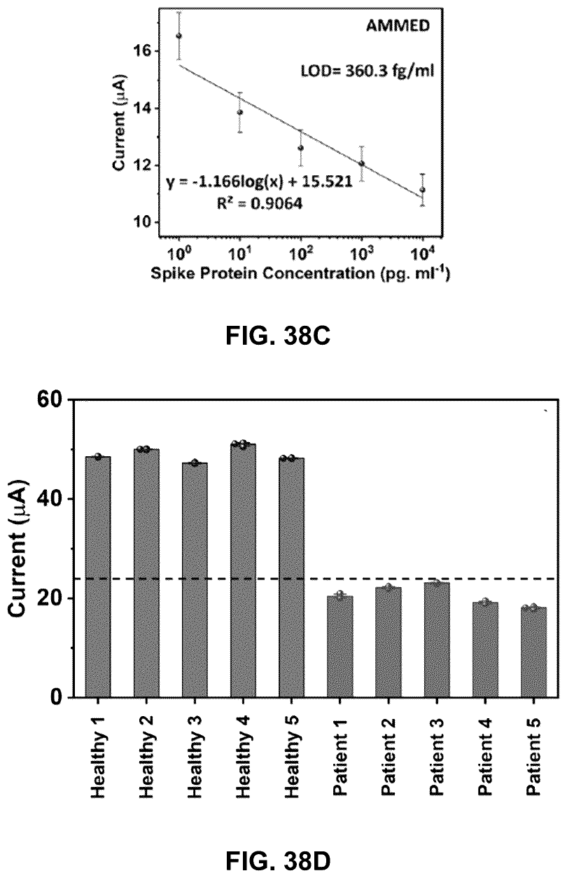

A multiplexed detection performance of AMMED through biosensing the SARS-COV-2 S-protein in media was performed. The AMMED device was tested for the detection of SARS-CoV-2 S-protein ranging from 1-10 000 pg ml⁻¹ in buffer (FIG. 38A), saliva (FIG. 38B) and blood (FIG. 38C). The decrease in the current signals was positively correlated to the increase in the concentration of the target analyte. The linear detection range of the aptasensor recorded by the AMMED potentiostat was determined to be 1 pg mL⁻¹ to 10 000 pg mL⁻¹ for detecting SARS-COV-2 S-protein in buffer, saliva, and blood media with the limits of detection below 400 fg mL⁻¹, confirming the reliable response of AMMED device in complex media.

10 human saliva samples (5 samples from adult patients with COVID-19 symptoms, such as fever, fatigue, and dry cough, and tested with RT-qPCR) and 5 samples from healthy controls were supplied by the University Health Network's PRESERVE-Pandemic Response Biobank for testing on the assay (REB #20-5364). Free authorization and consent forms were signed by patients, and their clinical samples were collected according to the laboratory regulation. Accordingly, the AMMED device was further challenged with real saliva samples belonging to patients who had previously tested positive (n=5) or negative (n=5) on the standard polymerase chain reaction (PCR) diagnostic tests and successfully achieving the same diagnostic as that of PCR (FIG. 38D).

What is claimed is:

1. A detection system for detecting an analyte in a sample, comprising:
a microfluidic chip comprising:
an inlet adapted to receive the sample,
an incubation chamber having an incubation chamber inlet fluidly connected to the inlet downstream thereof, to incubate the analyte in the sample,
a sensing chamber fluidly connected to the incubation chamber, downstream of the filter barrier, and
an outlet fluidly connected to the sensing chamber downstream thereof;
a suction membrane in fluid communication with the outlet of the microfluidic chip;
an actuator for applying or relieving pressure from the suction membrane which modifies the air pressure in the microfluidic chip and drives a flow of the sample in the microfluidic chip; and
a detection apparatus for measuring a signal of the analyte in the sensing chamber.

2. The detection system of claim 1, wherein the detection apparatus is a spectroscopy detection apparatus or an electrical detection apparatus.

3. The detection system of claim 1, wherein the microfluidic chip further comprises a filter barrier fluidly connected to the incubation chamber, downstream of the incubation chamber inlet.

4. The detection system of claim 3, wherein the detection apparatus is a light detection apparatus and comprises
a light source for providing an epi illumination on the sensing chamber of the microfluidic chip,
a condensing lens for condensing light from the sensing chamber of the microfluidic chip, and
an image sensor receiving the light condensed by the condensing lens, the image sensor adapted to register the light as an electronic signal and to send said electronic signal to a processing device.

5. The detection system of claim 4, wherein the microfluidic chip is part of a microfluidic cartridge comprising
an inlet apparatus connected to the microfluidic chip, and covering the inlet, the incubation chamber and the filter barrier of the microfluidic chip, the inlet apparatus comprising:
a receptacle in fluid communication with the inlet of the microfluidic chip, the receptacle being adapted to receive the sample,
a storage chamber having a rupturable membrane and housing a colorimetric sensor, the storage chamber is in fluid communication with the microfluidic chip upstream of the sensing chamber and the filter barrier of the microfluidic chip,
an outlet apparatus connected to the microfluidic chip and covering the outlet, the outlet apparatus is in fluid communication with the outlet of the microfluidic chip, the outlet apparatus comprising:
the actuator, wherein the actuator is a screw adapted to be released in order to drive the flow of the sample to the incubation chamber,
a second suction membrane adapted to be released in order to flow the sample past the filter barrier and to drive a flow of the colorimetric sensor released from the storage chamber.

6. The detection system of claim 5, wherein the outlet apparatus comprises a second crew, and wherein the screw is adapted to be released in order to drive the flow of the sample to the incubation chamber, and the second screw is adapted to be released in order to flow the sample past the filter barrier and to drive the flow of the colorimetric sensor released from the storage chamber.

7. The detection system of claim 5, further comprising a closing lid for closing the receptacle of the inlet apparatus.

8. The detection system of claim 5, further comprising a second storage chamber in the inlet apparatus, the second storage chamber housing lysis reagents and having a rupturable membrane.

9. The detection system of claim 8, further comprising a second piercing actuator in the inlet apparatus to pierce the rupturable membrane of the second storage chamber, and the second piercing actuator is connected to the actuating motor.

10. The detection system of claim 8, further comprising a heating actuator in the inlet apparatus comprising a heating element for a lysis of the sample, and the heating actuator is connected to the actuating motor.

11. The detection system of claim 1, further comprising an imaging box, wherein the imaging box comprises the suction membrane, the detection apparatus and the actuator, and wherein the suction membrane is positioned below a support which is adapted to releasably bind to the microfluidic chip, and wherein the detection apparatus is a light detection apparatus.

12. The detection system of claim 1, wherein the flow of the sample is bidirectional.

13. The detection system of claim 1, wherein the detection apparatus is a light detection apparatus and wherein the sensing chamber comprises a plasmonic nanosurface, the plasmonic nanosurface including nanostructures protruding from the plasmonic nanosurface, the nanostructures having a size that is smaller than that of the diffraction limit of light, the nanostructures having a metallic layer that is plasmon-supported on top of a back reflector layer.

14. The detection system of claim 1, wherein the detection apparatus is an electrical detection apparatus and wherein the sensing chamber comprises a dimeric DNA aptamer gold nanostructure.

15. The detection system of claim 1, wherein the microfluidic chip comprises a plurality of the sensing chamber and multiple parallel channels each leading to one of the sensing chambers.

16. The detection system of claim 15, further comprising a motorized platform connected to the detection apparatus for moving the detection apparatus between the plurality of the sensing chamber.

17. The detection system of claim 1, wherein the analyte is selected from nucleic acid, microorganism, a cell of a multicellular organism, or a protein.

18. The detection system of claim 1, further comprises a heating plate.

19. The detection system of claim 1, wherein the actuating motor is connected to a controller and the controller is coupled to the processing device.

20. The detection system of claim 1, wherein the processing device is selected from a smart phone, a tablet, or a computer.


SEQUENCE LISTING (43 sequences)

SEQ ID NO: 1 - DNA, 20 bp, synthetic construct
  source 1..20: mol_type = other DNA
ccactagaggagctactgta

SEQ ID NO: 2 - DNA, 18 bp, synthetic construct
  source 1..18: mol_type = other DNA
tgacaagctacaacacgt

SEQ ID NO: 3 - DNA, 47 bp, synthetic construct
  source 1..47: mol_type = other DNA
aggtgagggttttctacatcactatattggaacaagcaaatctatgg

SEQ ID NO: 4 - DNA, 44 bp, synthetic construct
  source 1..44: mol_type = other DNA
atgggttgggattaatcctaaatgtgtgcgagcaagaacaagtg

SEQ ID NO: 5 - DNA, 25 bp, synthetic construct
  source 1..25: mol_type = other DNA
cagtttttaacatgttgtgccaacc

SEQ ID NO: 6 - DNA, 21 bp, synthetic construct
  source 1..21: mol_type = other DNA
tagagccatgcctaacatgct

SEQ ID NO: 7 - DNA, 19 bp, synthetic construct
  source 1..19: mol_type = other DNA
acttgtcaaacacccaagg

SEQ ID NO: 8 - DNA, 20 bp, synthetic construct
  source 1..20: mol_type = other DNA
gtgataaccgtaccatccat

SEQ ID NO: 9 - DNA, 42 bp, synthetic construct
  source 1..42: mol_type = other DNA
ggccagtctcaattttgtgcttttcagcctcccatttcagaa

SEQ ID NO: 10 - DNA, 44 bp, synthetic construct
  source 1..44: mol_type = other DNA
tatcccgtctattcaatctagaggcctaccatcccctgtccacc

SEQ ID NO: 11 - DNA, 24 bp, synthetic construct
  source 1..24: mol_type = other DNA
ggacattttccaattgtgatcgga

SEQ ID NO: 12 - DNA, 19 bp, synthetic construct
  source 1..19: mol_type = other DNA
gccattgccggtttcattg

SEQ ID NO: 13 - DNA, 114 bp, synthetic construct
  source 1..114: mol_type = other DNA
gagaattagtctgagtctgataactaactaccggtcaacttcaagctcctaagccttgacgaaccgctttgcctgactgaatgcagcgtaggtatcgactacgtgcccgccgat

SEQ ID NO: 14 - DNA, 116 bp, synthetic construct
  source 1..116: mol_type = other DNA
ggtaattataattaccaccaacccccggtcaacttcaagctcctaagcctgacgaaccgctttgcctgactgaatgccagcgtaggtatcgacagacttcctaaacaatctatacc

SEQ ID NO: 15 - DNA, 109 bp, synthetic construct
  source 1..109: mol_type = other DNA
gataatcccaacccataagcccggtcaacttcaagctcctaagccttgacgaaccgctttgcctgactgaatgcagcgtaggtatcgaccatggctctatcacatttag

SEQ ID NO: 16 - DNA, 21 bp, synthetic construct
  source 1..21: mol_type = other DNA
gcttaggagcttgaagttgac

SEQ ID NO: 17 - DNA, 21 bp, synthetic construct
  source 1..21: mol_type = other DNA
gctttgcctgactgaatgcag

SEQ ID NO: 18 - DNA, 39 bp, synthetic construct
  source 1..39: mol_type = other DNA
cttatgggttgggattatcctaaatgtgatagagccatg

SEQ ID NO: 19 - DNA, 40 bp, synthetic construct
  source 1..40: mol_type = other DNA
tagttatcagactcagactaattctcatcggcgggcagta

SEQ ID NO: 20 - DNA, 41 bp, synthetic construct
  source 1..41: mol_type = other DNA
tagttatcagactcagactaattctcctcggcgggcacgta

SEQ ID NO: 21 - DNA, 46 bp, synthetic construct
  source 1..46: mol_type = other DNA
ggttggtggtaattataattaccggtatagattgtttaggaagtct

SEQ ID NO: 22 - DNA, 46 bp, synthetic construct
  source 1..46: mol_type = other DNA
ggttggtggtaattataattacctgtatagattgtttaggaagtct

SEQ ID NO: 23 - DNA, 19 bp, synthetic construct
  source 1..19: mol_type = other DNA
gccatctcctgaatgacgc

SEQ ID NO: 24 - DNA, 18 bp, synthetic construct
  source 1..18: mol_type = other DNA
atttaccgcagccagacg

SEQ ID NO: 25 - DNA, 42 bp, synthetic construct
  source 1..42: mol_type = other DNA
cattttgcagctgtacgctcgcagcccatcatgaatgttgct

SEQ ID NO: 26 - DNA, 40 bp, synthetic construct
  source 1..40: mol_type = other DNA
ctggggcgaggtcgtggtattccgacaaacaccacgaatt

SEQ ID NO: 27 - DNA, 24 bp, synthetic construct
  source 1..24: mol_type = other DNA
ctttgtaacaacctgtcatcgaca

SEQ ID NO: 28 - DNA, 25 bp, synthetic construct
  source 1..25: mol_type = other DNA
atcaatctcgatatccatgaaggtg

SEQ ID NO: 29 - DNA, 18 bp, synthetic construct
  source 1..18: mol_type = other DNA
ggctcaggtactgctatc

SEQ ID NO: 30 - DNA, 23 bp, synthetic construct
  source 1..23: mol_type = other DNA
ttgttatttaacccaatcattgc

SEQ ID NO: 31 - DNA, 49 bp, synthetic construct
  source 1..49: mol_type = other DNA
atgccatacataaatggatagacgtcaaacaggtgaattattagcactt

SEQ ID NO: 32 - DNA, 44 bp, synthetic construct
  source 1..44: mol_type = other DNA
ccgaagataaaaaagaaccttgcttttttgagttgaacctggtg

SEQ ID NO: 33 - DNA, 19 bp, synthetic construct
  source 1..19: mol_type = other DNA
catatgaaggtgtgcttac

SEQ ID NO: 34 - DNA, 20 bp, synthetic construct
  source 1..20: mol_type = other DNA
caagttccagattacaactt

SEQ ID NO: 35 - DNA, 18 bp, synthetic construct
  source 1..18: mol_type = other DNA
atgagcttagtcctgttg

SEQ ID NO: 36 - DNA, 18 bp, synthetic construct
  source 1..18: mol_type = other DNA
ctccctttgttgtgttgt

SEQ ID NO: 37 - DNA, 21 bp, synthetic construct
  source 1..21: mol_type = other DNA
agatgtcttgtgctgccggta

SEQ ID NO: 38 - DNA, 18 bp, synthetic construct
  source 1..18: mol_type = other DNA
gccatctcctgatgacgc

SEQ ID NO: 39 - DNA, 18 bp, synthetic construct
  source 1..18: mol_type = other DNA
atttaccgcagccagacg

SEQ ID NO: 40 - DNA, 42 bp, synthetic construct; identical to SEQ ID NO: 25
  source 1..42: mol_type = other DNA

SEQ ID NO: 41 - DNA, 40 bp, synthetic construct; identical to SEQ ID NO: 26
  source 1..40: mol_type = other DNA

SEQ ID NO: 42 - DNA, 24 bp, synthetic construct
  source 1..24: mol_type = other DNA
ctttgtaacaacctgtcatcgaca

SEQ ID NO: 43 - DNA, 25 bp, synthetic construct
  source 1..25: mol_type = other DNA
atcaatctcgatatccatgaaggtg